(19) United States
(12) Patent Application Publication
(10) Pub. No.: US 2025/0317995 A1
(43) Pub. Date: Oct. 9, 2025

(54) Connection Management of Direct Access

(71) Applicant: Ofinno, LLC, Reston, VA (US)

(72) Inventors: SungDuck Chun, Fairfax, VA (US); Kyungmin Park, Vienna, VA (US); Esmael Hejazi Dinan, McLean, VA (US); Taehun Kim, Fairfax, VA (US); Jian Xu, McLean, VA (US); Stanislav Filin, Chantilly, VA (US)

(21) Appl. No.: 19/098,415

(22) Filed: Apr. 2, 2025

Related U.S. Application Data
(60) Provisional application No. 63/574,112, filed on Apr. 3, 2024.

(51) Int. Cl. H04W 76/10; H04W 48/02; H04W 60/04

(52) U.S. Cl. CPC H04W 76/10; H04W 48/02; H04W 60/04

(57) ABSTRACT

A wireless device receives a second non-access stratum (NAS) messages indicating an establishment of a protocol data unit (PDU) session and a rejection of a multi-access (MA)-PDU session type for the PDU session.

### CROSS-REFERENCE TO RELATED APPLICATIONS

This application claims the benefit of U.S. Provisional Application No. 63/574,112, filed Apr. 3, 2024, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 is a diagram of an aspect of an example embodiment of the present disclosure.

FIGS. 16A and 16B are diagrams of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

FIG. 31 is a diagram of an aspect of an example embodiment of the present disclosure.

FIG. 32 is a diagram of an aspect of an example embodiment of the present disclosure.

FIG. 33 is a diagram of an aspect of an example embodiment of the present disclosure.

FIG. 34 is a diagram of an aspect of an example embodiment of the present disclosure.

FIG. 35 is a diagram of an aspect of an example embodiment of the present disclosure.

FIG. 36 is a diagram of an aspect of an example embodiment of the present disclosure.

FIG. 37 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

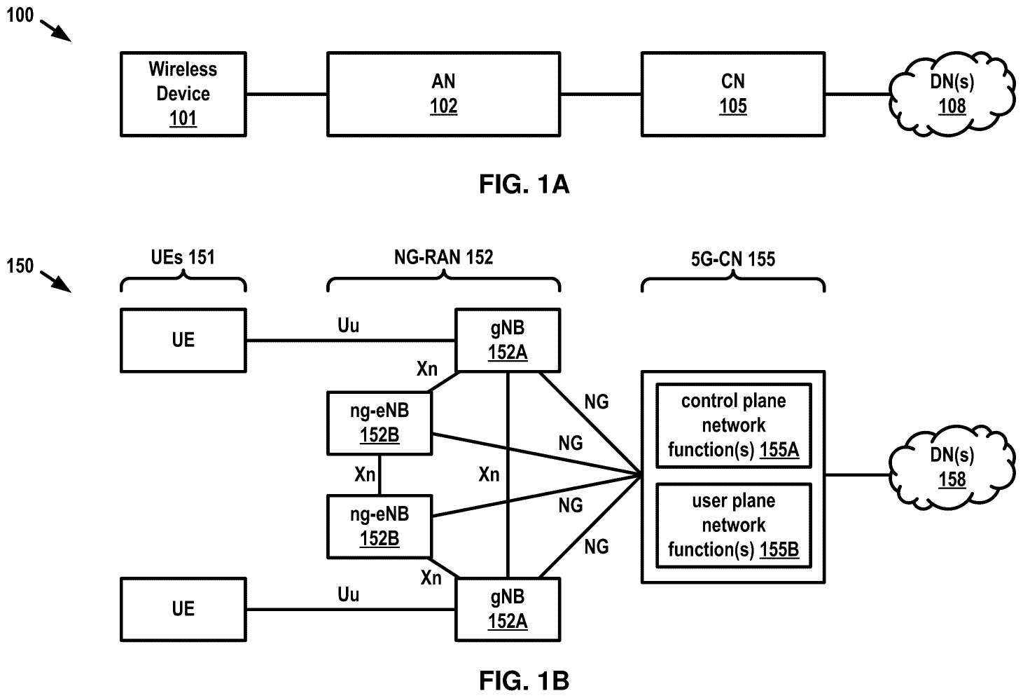

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNS (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

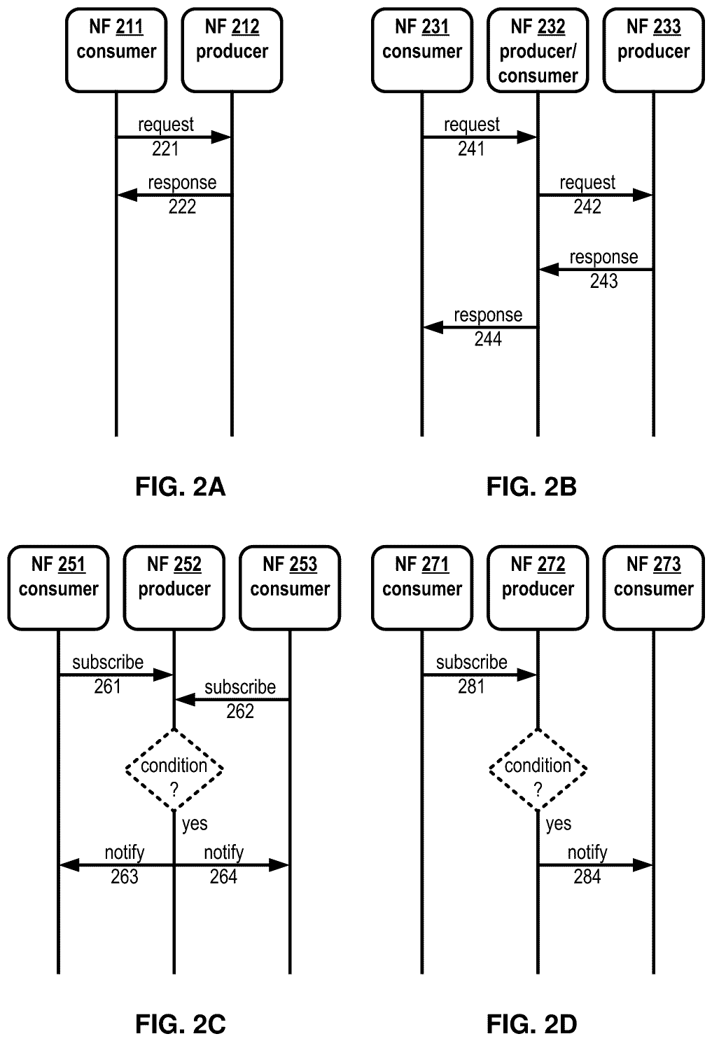

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

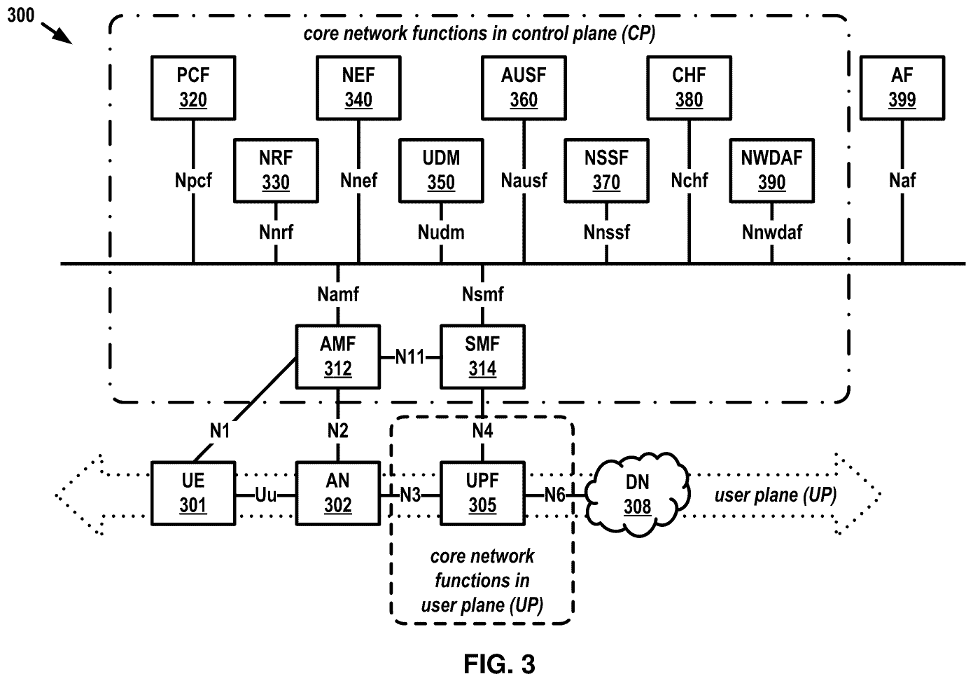

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QOS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

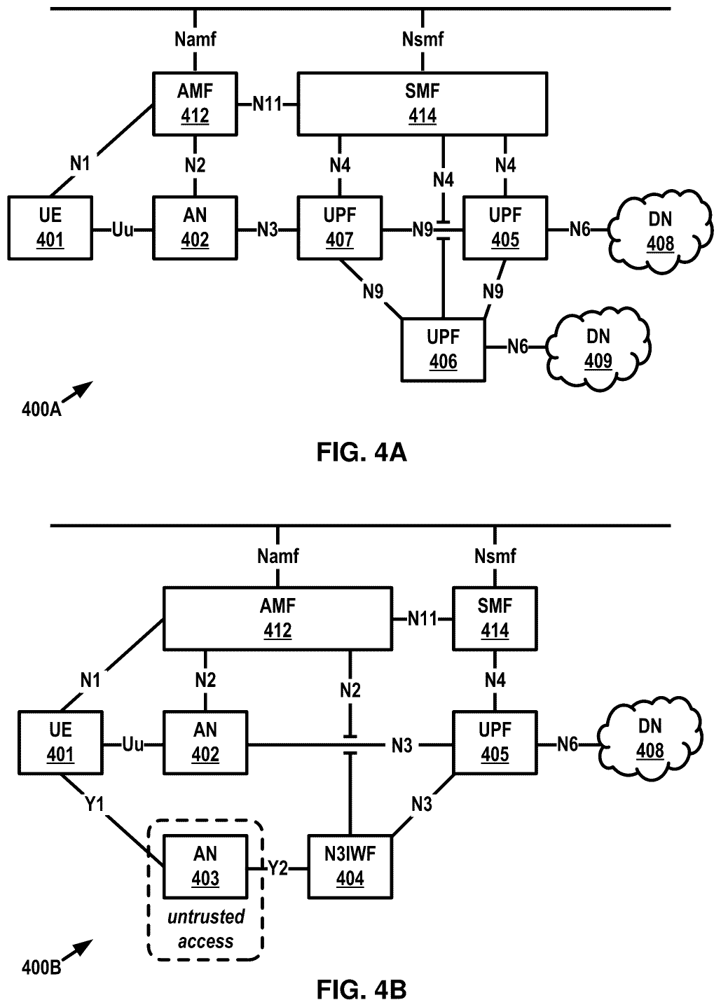

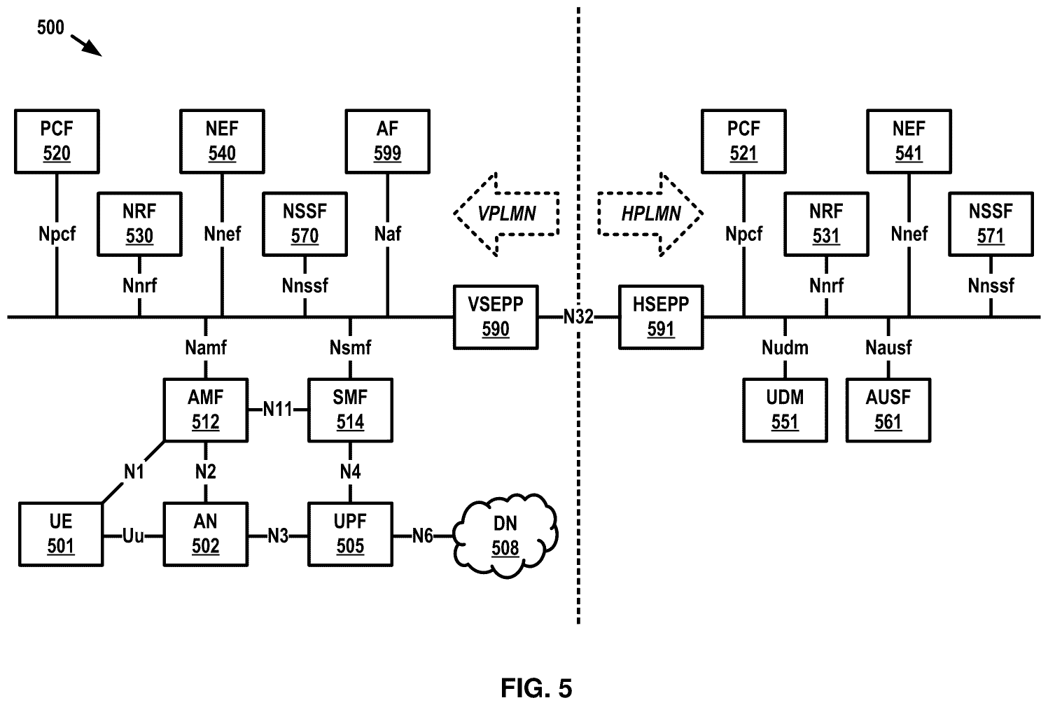

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNS (e.g., the Internet), private DNs (e.g., private, internal corporate-owned DNs), and/or intra-operator DNs. Each DN may provide an operator service and/or a third-party service. The service provided by a DN may be the Internet, an IP multimedia sub system (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

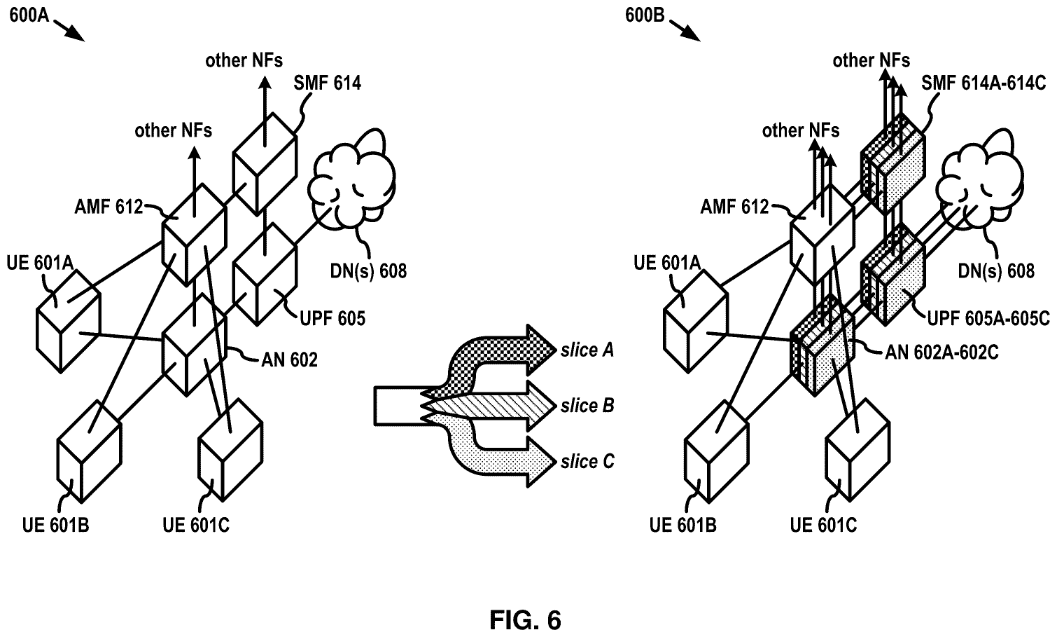

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

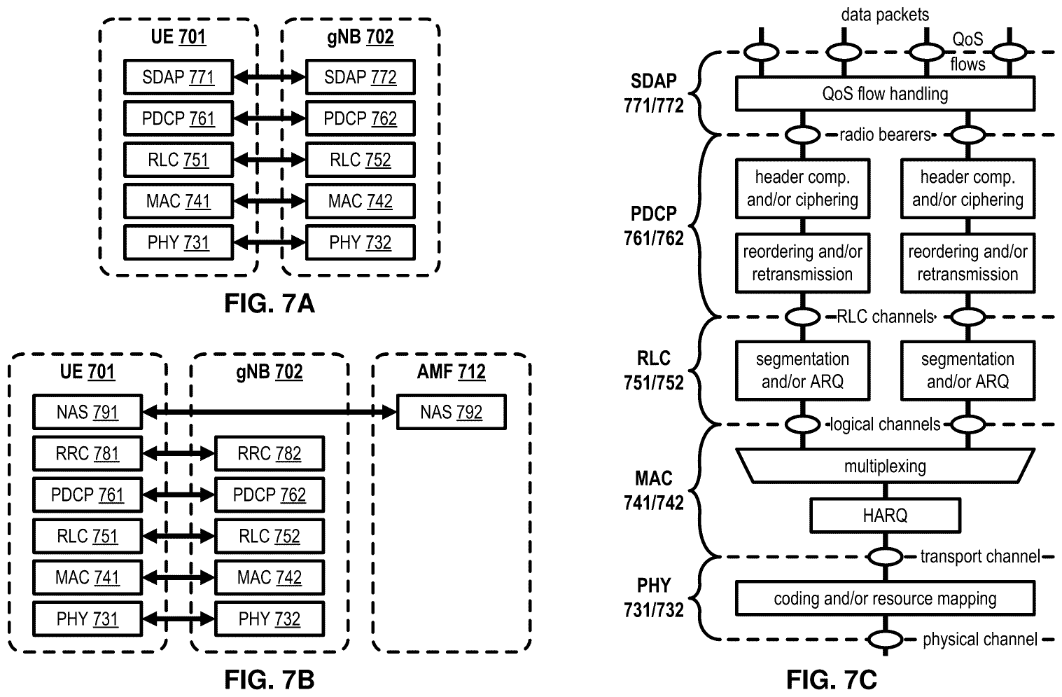

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

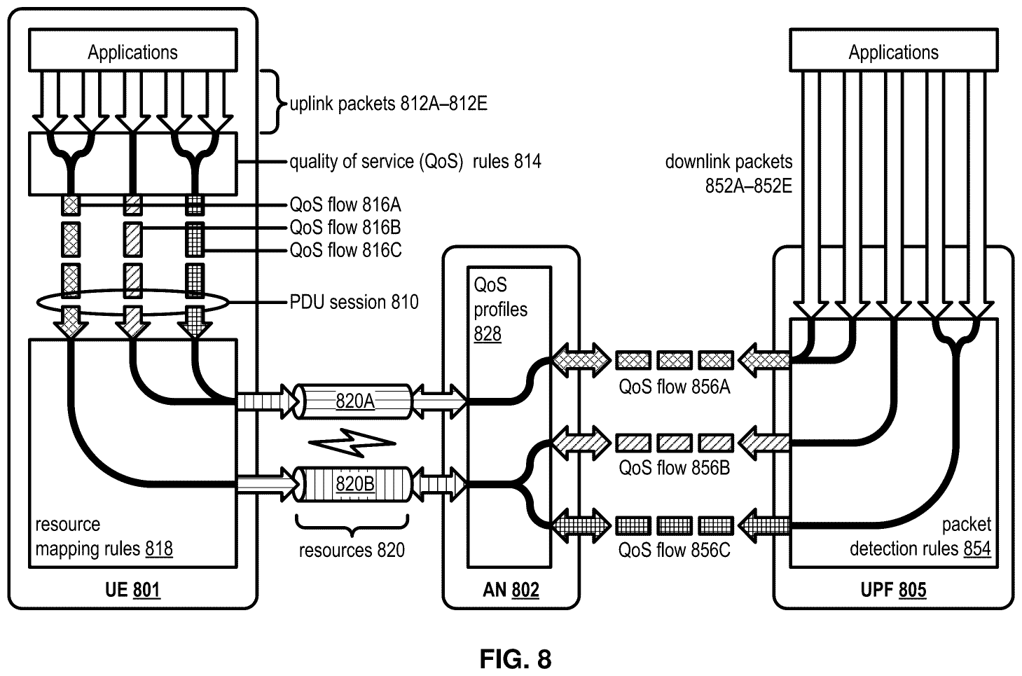

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

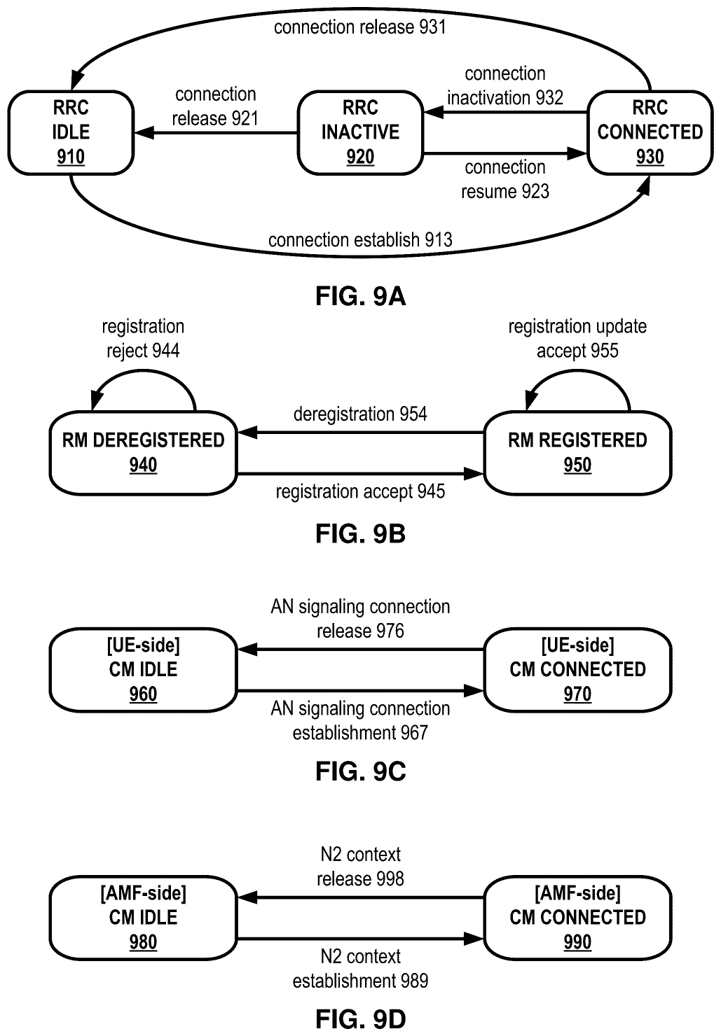

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

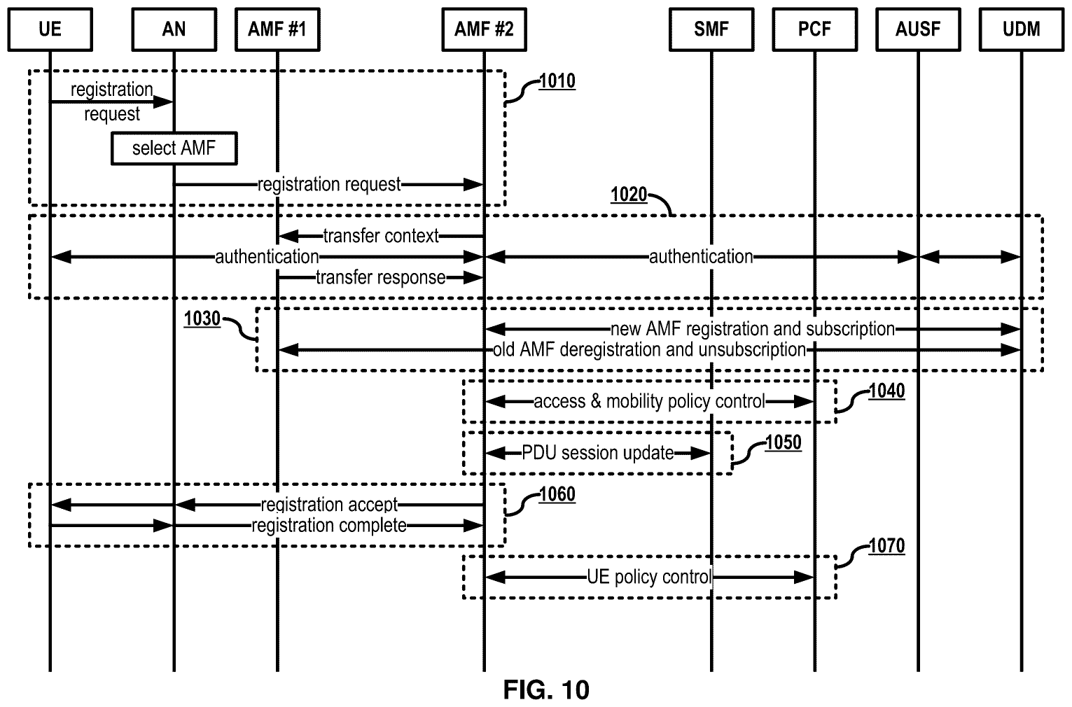

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF#1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF#2) performs a context transfer. The context may be a UE context, for example, an RRC context for the UE. As an example, AMF#2 may send AMF#1 a message requesting a context of the UE. The message may include the UE identifier. The message may be a Namf_Communication_UEContextTransfer message. AMF#1 may send to AMF#2 a message that includes the requested UE context. This message may be a Namf_Communication_UEContextTransfer message. After the UE context is received, the AMF#2 may coordinate authentication of the UE. After authentication is complete, AMF#2 may send to AMF#1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF#2, registers and/or subscribes with the UDM. AMF#2 may perform registration using a UE context management service of the UDM (Nudm_UECM). AMF#2 may obtain subscription information of the UE using a subscriber data management service of the UDM (Nudm_SDM). AMF#2 may further request that the UDM notify AMF#2 if the subscription information of the UE changes. As the new AMF registers and subscribes, the old AMF, AMF#1, may deregister and unsubscribe. After deregistration, AMF#1 is free of responsibility for mobility management of the UE.

At 1040, AMF#2 retrieves access and mobility (AM) policies from the PCF. As an example, the AMF#2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF#2 may update a context of a PDU session. For example, if the UE has an existing PDU session, the AMF#2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF#2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF#2. The registration complete message may acknowledge receipt of the new UE identifier and/or new configured slice identifier.

At 1070, AMF#2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

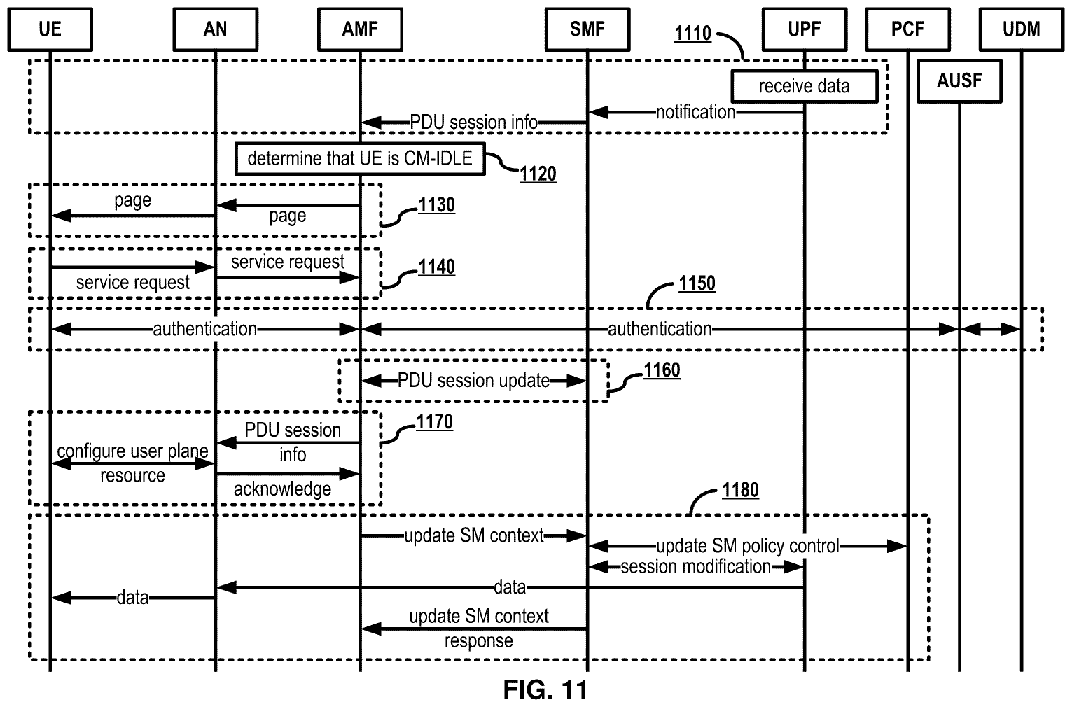

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

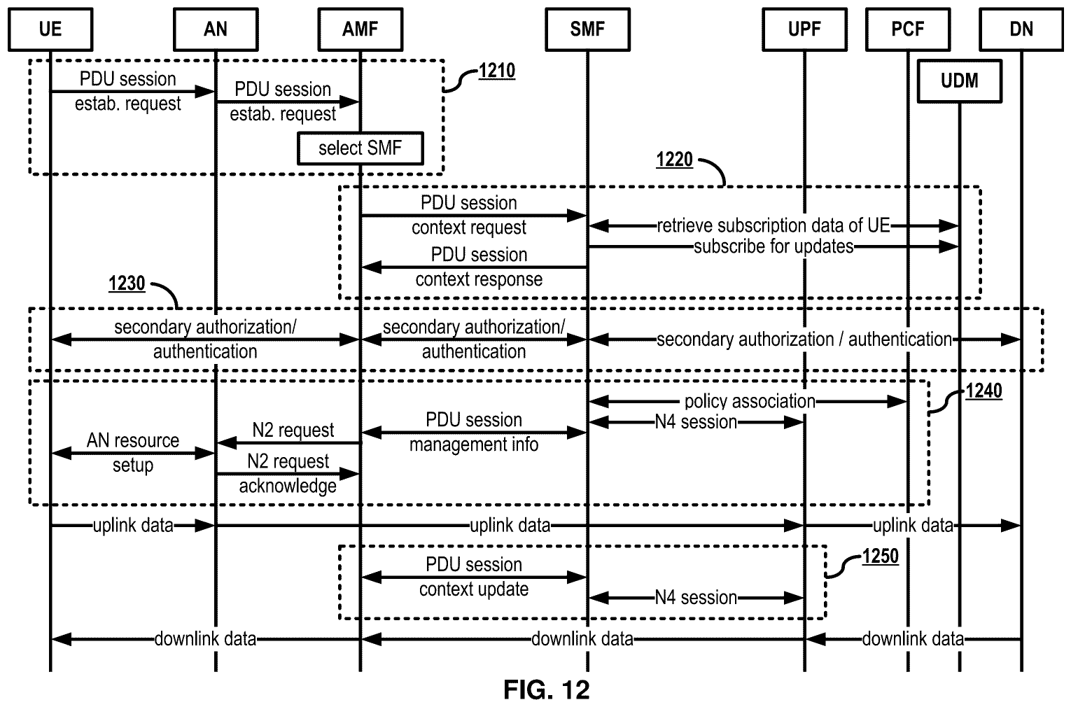

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QOS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

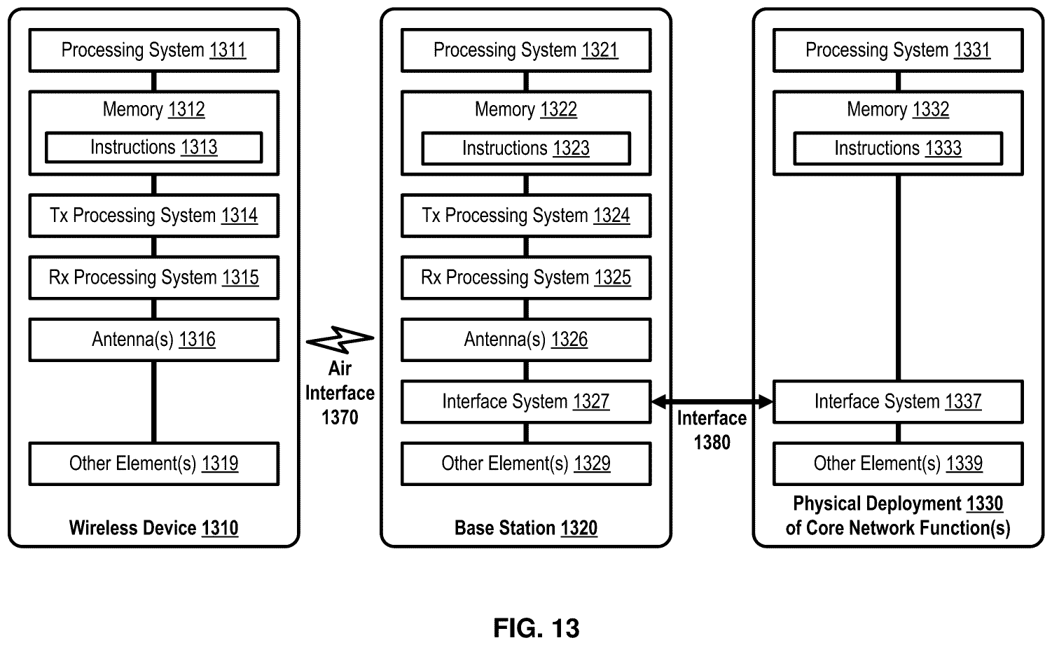

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICS, FPGAs, and complex programmable logic devices (CPLDs). Computers, microcontrollers and microprocessors may be programmed using languages such as assembly, C, C++ and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

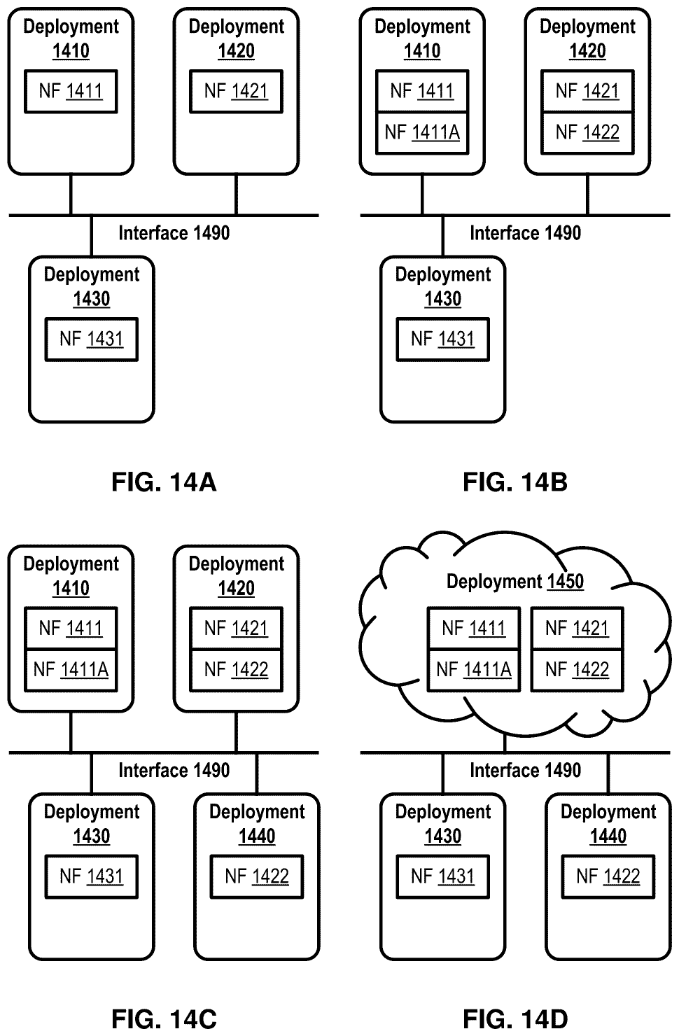

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNS), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

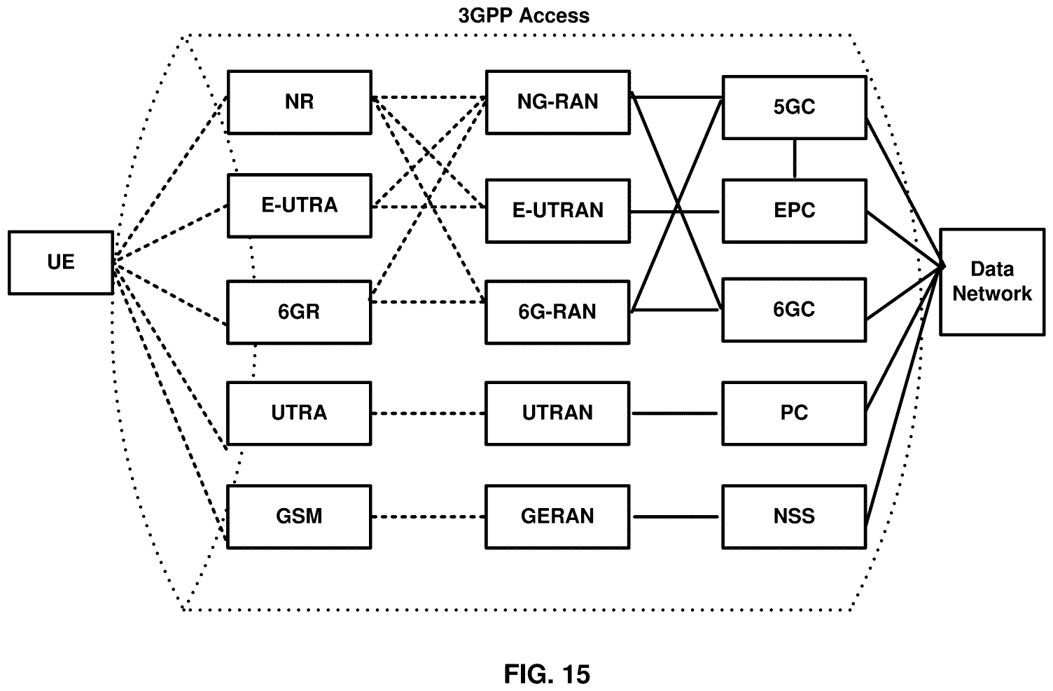

FIG. 15 illustrates an example as per an aspect of an embodiment of the present disclosure.

In an example embodiment as depicted in FIG. 15, the UE may exchange one or more data with a data network (DN), via a 3GPP access (type). The 3GPP access (type) may use one or more 3GPP RATs. The one or more 3GPP RATs may comprise at least one of 6GR (6G Radio, 6^{th} generation radio and/or the like), NR, E-UTRA, UTRA, GSM, the like and/or a combination thereof. The 3GPP access may use one or more 3GPP RANs. The one or more 3GPP RANs may comprise at least one of a 6G-RAN (6G RAN, and/or the like), a NG-RAN, a E-UTRAN, a UTRAN, a GERAN, the like and/or a combination thereof. The 3GPP RANs may use the one or more 3GPP RATs. The one or more 3GPP RANs may interface with one or more core networks. The one or more core networks may comprise at least one of a 6G Core (6GC, 6^{th} Generation Core and/or the like), a 5G core (5GC), an evolved packet core (EPC), a packet core (PC), a network switching system (NSS), and/or a combination thereof.

In an example embodiment, a UE may exchange one or more data with a data network, via a N3GPP access (type). The N3GPP access may use one or more N3GPP RATs. The one or more N3GPP RATs may comprise at least one of a trusted WiFi, an untrusted WiFi, a wireline broadband, the like and/or a combination thereof. The N3GPP access may use one or more N3GPP access network nodes. The one or more N3GPP access network nodes may comprise at least one of a N3IWF, an evolved packet data gateway (ePDG), a trusted non-3GPP gateway function (TNGF), a wireline access gateway function (W-AGF), the like and/or a combination thereof. The one or more N3GPP access nodes may interface with the one or more core networks (e.g., EPC and/or 5GC and/or 6GC). The N3IWF may provide similar functionalities as the 3GPP RAN. For example, the N3IWF may establish a signalling connection with the UE and/or may exchange signalling with the one or more core networks. In some embodiments in this disclosure, the N3IWF may be interpreted as a N3IWF, a TGNF, an ePDG, the likes and/or a combination thereof.

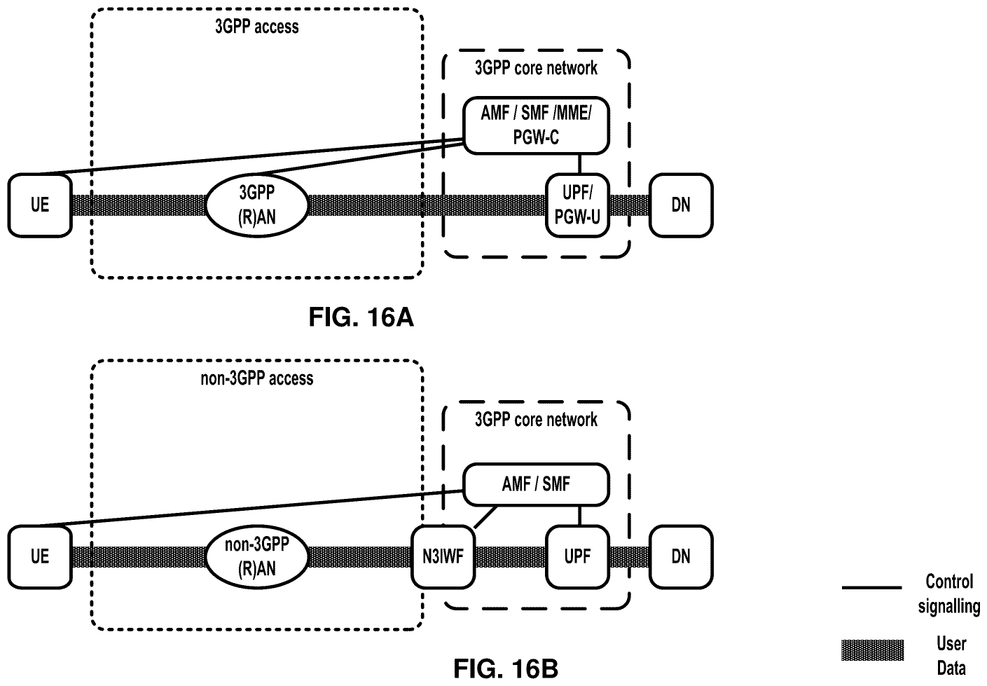

FIG. 16A and FIG. 16B illustrates an example as per an aspect of an embodiment of the present disclosure.

In an example embodiment as depicted in FIG. 16A and FIG. 16B, a UE may access a 3GPP system (network) via (using) one or more access types. For example, the one or more access types may comprise at least one of a 3GPP access type, a non-3GPP (N3GPP) access type, and/or a combination thereof.

For example, as shown in FIG. 16A, the UE may access a network via the 3GPP access type (e.g., 3GPP access). For example, the access to the network via the 3GPP access type may be an access to the network via one or more 3GPP RANs. For example, the one or more 3GPP RANs may comprise at least one of a global system for mobile communication (GSM) enhanced data-rates for global evolution (EDGE) radio access network (GERAN), a universal terrestrial radio access network (UTRAN), an evolved UTRAN (E-UTRAN), a next generation radio access network (NG-RAN), a 6th generation radio access network (6G-RAN) and/or a combination thereof. An operator of the network may trust the UE's access to the network via the 3GPP access type, because the one or more 3GPP RANs are securely managed and/or deployed by the operator.

For example, as shown in FIG. 16B, the UE may access the network via the N3GPP access (e.g., N3GPP access type). For example, the access to the network via the N3GPP access type may be an access to the network via one or more N3GPP RATs. One or more of the one or more N3GPP RATs may be associated with one or more N3GPP RAN. For example, the one or more N3GPP RANs may comprise at least one of a trusted WiFi, an untrusted WiFi, a wireline broadband, a WiMAX, and/or a combination thereof. The operator of the network may not trust the access to the network via the N3GPP access type, because the one or more N3GPP RANs may not be managed and/or deployed by the operator. For example, a WiFi equipment (e.g., router, access point) may not be managed or deployed by the operator. To prevent unauthorized access of the UE via the one or more N3GPP RANs (or RATs) and/or to securely protect data/signaling, a non-3GPP interworking function (N3IWF) may be employed for the N3GPP access type. For example, the N3IWF may be employed for interworking between the one or more non-3GPP RANs and a 5G core network. In some implementations, the N3GPP RANs may comprise the N3IWF. In other implementation, the N3GPP RANs may not comprise the N3IWF.

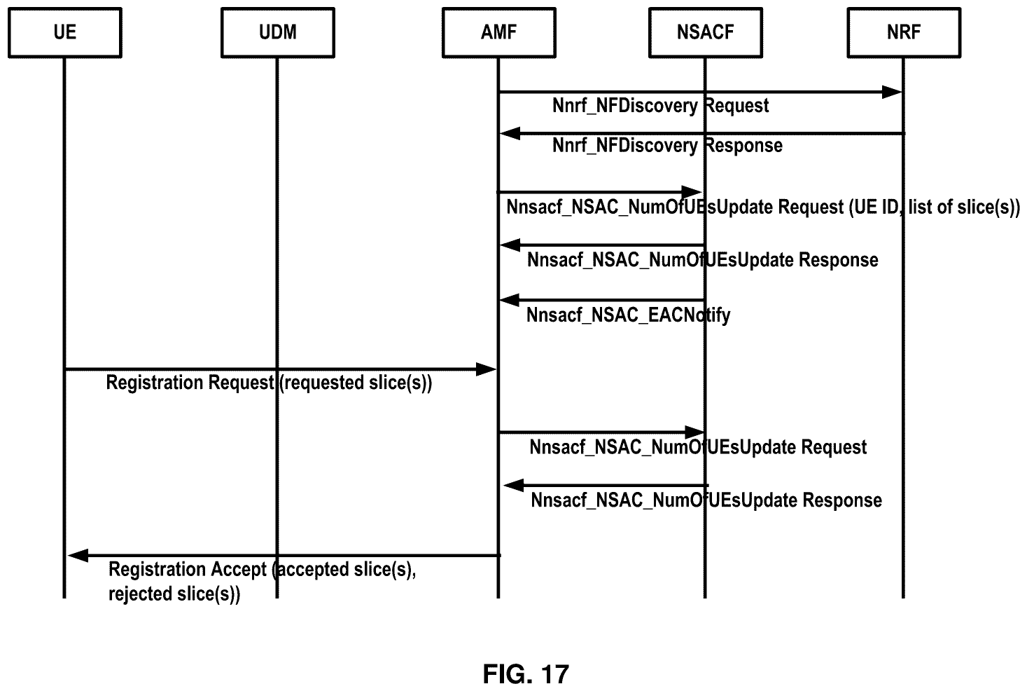

FIG. 17 illustrates an example as per an aspect of an embodiment of the present disclosure. In one implementation, controlling admission to a network slice may be supported by limiting the number of UEs registered for a network slice.

In an implementation, for a network slice, an AMF may be configured with the information indicating whether the network slice is subject to network slice admission control (NSAC). For the network slice subject to NSAC, to find a NSACF for the network slice, the AMF may perform NSACF discovery procedure. For example, the AMF may send Nnrf_NFDiscovery Request message to a NRF, requesting information of the NSACF which is in charge of the network slice. Based on the Nnrf_NFDiscovery Request, the AMF may receive Nnrf_NFDiscovery Response message from the NRF. The Nnrf_NFDiscovery Response message may comprise information of the NSACF. Based on the information of the NSACF received from the NRF, the AMF may send Nnsacf_NSAC_NumOfUEsUpdate Request message to the NSACF. The Nnsacf_NSAC_NumOfUEsUpdate Request may comprise at least one of identity of the network slice (e.g., S-NSSAI(s), identity of UE(s) (e.g., SUPI), NF ID, access type, update flag. The NF ID may indicate the identity of the network node which sends the Nnsacf_NSAC_NumOfUEsUpdate Request. The access type may indicate an access type over which the UE(s) requests registration. The update flag may indicate whether the number of UEs registered with the network slice needs to be increased or decreased. In response to the Nnsacf_NSAC_NumOfUEsUpdate Request, the AMF may receive Nnsacf_NSAC_NumOfUEsUpdate Response message from the NSACF. The Nnsacf_NSAC_NumOfUEsUpdate Response message may comprise a result indication. The result indication may comprise an outcome of update and/or check operation in the NSACF, may comprise indication of whether ‘maximum number of UEs for the S-NSSAI not reached’ or ‘maximum number of UEs for the S-NSSAI reached’.

In an example of FIG. 17, the NSACF may send Nnsacf_NSAC_EACNotify message to the AMF. The NSACF may send the Nnsacf_NSAC_EACNotify message to one or more network nodes (e.g., AMFs) to indicate activation or deactivation of Early Availability Check (EAC) mode for the network slice. The EAC mode may indicate whether the AMF needs to check with the NSACF before it determines to allow the UE to register with the network slice. For example, for the network slice subject to NSAC, when the number of the UEs registered with the network slice is above certain threshold (e.g., 100 UEs, 500 UEs, 20%, 50%), the NSACF may activate the EAC mode. The NSACF may send the Nnsacf_NSAC_EACNotify message to one or more network nodes (e.g., AMFs) to indicate deactivation of Early Availability Check (EAC) mode for the network slice. For example, for the network slice subject to NSAC, when the number of the UEs registered with the network slice is below certain threshold (e.g., 90 UEs, 400 UEs, 10%, 40%), the NSACF may deactivate the EAC mode. The Nnsacf_NSAC_EACNotify message may comprise at least one of the identity of the network slice and/or EAC flag. The EAC flag may indicate whether the EAC mode is deactivated or activated for the network slice. When the number of registered UE for the network slice is low, the EAC mode may be deactivated to reduce signaling between the AMF and the NSACF. In the example of FIG. 17, the NSACF may indicate to the AMF that the EAC mode is activated.

In an implementation, the AMF may receive a registration request message from a UE. The registration message may comprise at least one of the identity of the UE and/or the list of one or more identities of one or more requested network slices. One or more network slices requested by the UE may be subject to NSAC. For one or more network slices subject to NSAC, the AMF may determine for which one or more network slices NSAC is required. For one or more requested network slices which requires NSAC, the AMF may determine whether the EAC mode is activated.

In an implementation, for a requested network slice for which the EAC mode is activated, the AMF may send Nnsacf_NSAC_NumOfUEsUpdate Request message to the NSACF. The Nnsacf_NSAC_NumOfUEsUpdate Request may comprise the update flag indicating that the number of UEs registered for the network slice is to be increased. Based on the received Nnsacf_NSAC_NumOfUEsUpdate Request, the NSACF may determine whether the number of UEs registered for the network slice reaches the maximum number of UEs registered for the network slice. If the maximum number of UEs registered for the network slice is not reached, the NSACF may send to the AMF the Nnsacf_NSAC_NumOfUEsUpdate Response comprising indication of the maximum number of UEs registered with the network slice not reached. If the maximum number of UEs registered for the network slice is reached, the NSACF may send to the AMF the Nnsacf_NSAC_NumOfUEsUpdate Response comprising indication of the maximum number of UEs registered with the network slice reached.

In an implementation, based on the received Nnsacf_NSAC_NumOfUEsUpdate Response, the AMF may send a registration response message to the UE. For example, the registration response message may comprise at least one of a registration accept message or registration reject message to the UE. For example, the registration response message may comprise at least one of a list of one or more accepted network slices and/or a list of at least one or more rejected network slices. Based on the response from the NSACF indicating the maximum number of UEs registered with the network slice reached, the AMF may include the network slice in the list of one or more rejected network slices. Based on the response from the NSACF indicating the maximum number of UEs registered with the network slice not reached, the AMF may include the network slice in the list of one or more accepted network slices.

In an implementation, the AMF and/or the NSCAF may manage the number of the UEs registered with the network slice, per access type. For example, a first UE may perform a first registration via a 3GPP access path and/or a second registration via a N3GPP access path. Because the first UE is using a resource of the network slice of both the 3GPP access and the N3GPP access, the AMF and/or the NSCAF may increase the number of UEs registered with the network slice by 2. For example, because the first UE is using the 3GPP access, the AMF and/or the NSCAF may increase the number of UEs registered with the network slice by 1. For example, because the first UE is using the N3GPP access, the AMF and/or the NSCAF may increase the number of UEs registered with the network slice by 1. For example, a second UE may perform a third registration via the 3GPP access path and/or may not perform a fourth registration via the N3GPP access path. For example, because the second UE is using the 3GPP access, for the 3GPP access, the AMF and/or the NSCAF may increase the number of UEs registered with the network slice by 1. For example, for the N3GPP access, because the second UE is not using the N3GPP access, the AMF and/or the NSCAF may not increase the number of UEs registered with the network slice by 1.

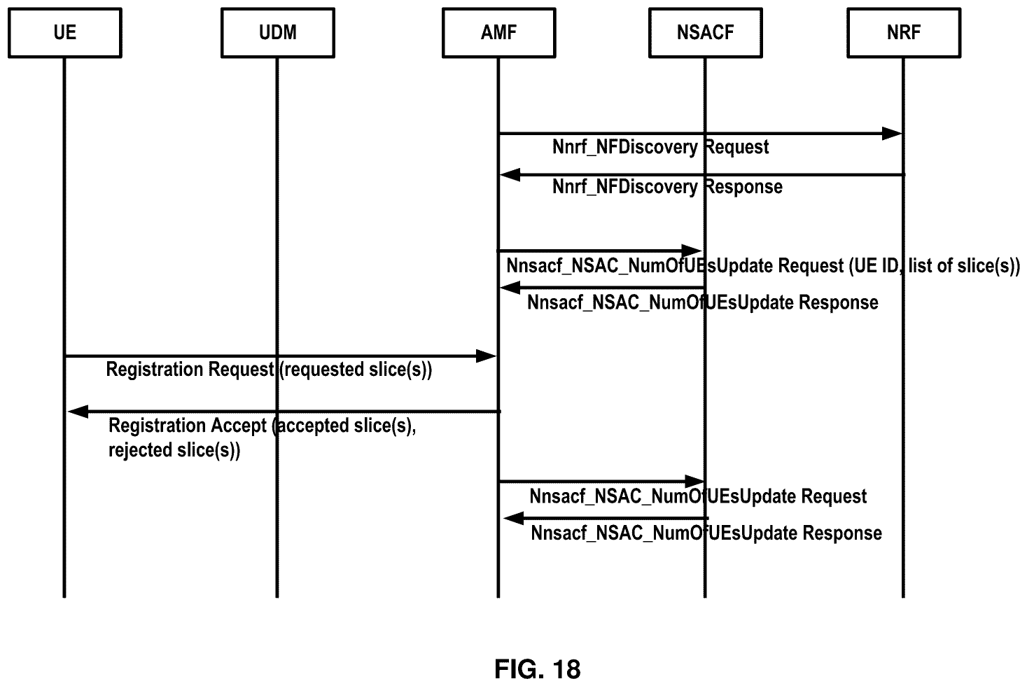

FIG. 18 illustrates an example as per an aspect of an embodiment of the present disclosure.

In the example of FIG. 18, a NSACF may determine not to activate an EAC mode for a network slice for which NSAC applies. For example, an AMF may determine that the EAC mode is deactivated for the network slice, based on that a NSACF does not send any Nnsacf_NSAC_EACNotify message to the AMF for the network slice. For example, the AMF may determine that the EAC mode is deactivated for the network slice, based on that the NSACF sends Nnsacf_NSAC_EACNotify message indicating deactivation of the EAC mode for the network slice.

In an implementation, the AMF may receive a registration request from a UE. The registration request may comprise one or more identities of one or more requested network slices. The one or more identities of one or more requested network slices may comprise at least the network slice for which NSAC applies. Based on that the EAC mode is deactivated for the network slice, the AMF may determine to allow the network slice for the UE. For example, the AMF may send to the UE, a registration accept message comprising a list of one or more accepted network slices including the network slice. Based on sending the registration accept message to the UE, the AMF may send to the NSACF, Nnsacf_NSAC_NumOfUEsUpdate Request message. The Nnsacf_NSAC_NumOfUEsUpdate Request may comprise at least of the update flag indicating that the number of UEs registered for the network slice is to be increased and/or the identity of the UE. Based on the received Nnsacf_NSAC_NumOfUEsUpdate Request, the NSACF may determine whether the UE is already included in the list of UEs registered for the network slice. Based on the received Nnsacf_NSAC_NumOfUEsUpdate Request, the NSACF may determine whether the number of UEs registered for the network slice reaches the maximum number of UEs registered for the network slice. If the maximum number of UEs registered for the network slice is not reached, the NSACF may send to the AMF the Nnsacf_NSAC_NumOfUEsUpdate Response comprising indication of the maximum number of UEs registered with the network slice not reached. If the maximum number of UEs registered for the network slice is reached, the NSACF may send to the AMF the Nnsacf_NSAC_NumOfUEsUpdate Response comprising indication of the maximum number of UEs registered with the network slice reached.

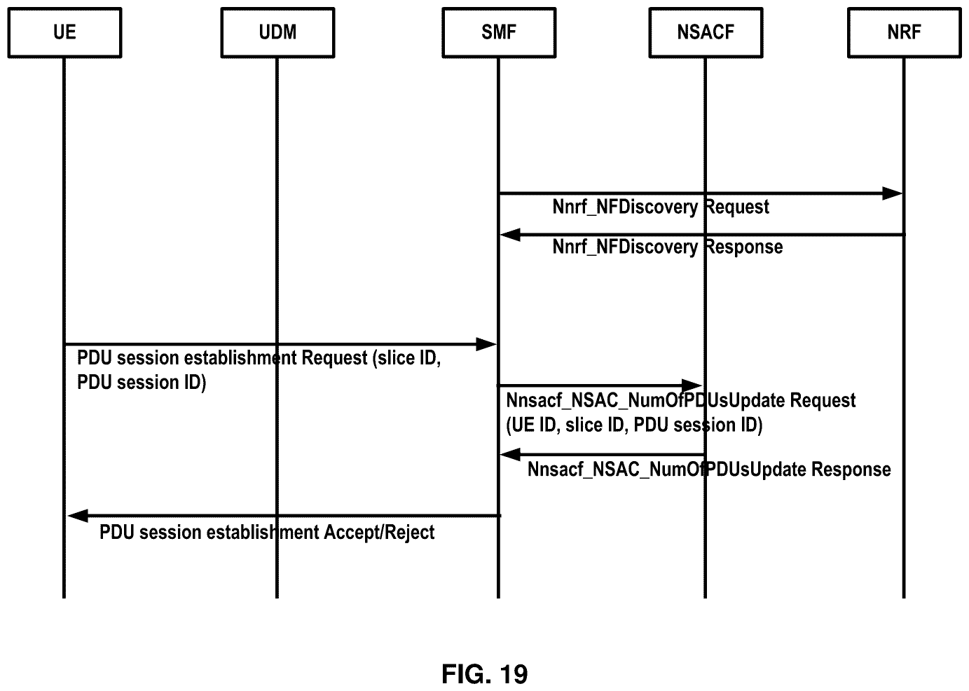

FIG. 19 illustrates an example as per an aspect of an embodiment of the present disclosure. In the example, controlling admission to a network slice may be supported by limiting the number of PDU sessions established for a network slice.

In an implementation, for a network slice, an SMF may be configured with an information indicating whether the network slice is subject to NSAC (Network slice admission control). For the network slice subject to NSAC, the SMF may perform NSACF discovery procedure. For example, the SMF may send Nnrf_NFDiscovery Request message to a NRF, requesting information of the NSACF which is in charge of the network slice. Based on the Nnrf_NFDiscovery Request, the SMF may receive Nnrf_NFDiscovery Response message from the NRF. The Nnrf_NFDiscovery Response message may comprise information of the NSACF.

In an implementation, the SMF may receive a PDU session establishment request message from a UE. The PDU session establishment request may comprise at least one of a PDU session ID for a PDU session, identity of a network slice over which the PDU session is to be established, QoS parameter for the PDU session. Based on the identity of the network slice of the PDU session establishment request, the SMF may send

Nnsacf_NSAC_NumOfPDUsUpdate Request message to the NSACF. The Nnsacf_NSAC_NumOfPDUsUpdate Request may comprise at least one of identity of the network slice (e.g., S-NSSAI(s)), identity of UE(s) (e.g., SUPI), PDU session ID, NF ID, access type, update flag. The NF ID may indicate the identity of the network node which sends the Nnsacf_NSAC_NumOfPDUsUpdate Request. The PDU session ID may indicate an identity of PDU session requested to be established by the UE. The access type may indicate an access type over which the UE(s) requests establishment of the PDU session. The update flag may indicate whether the number of PDU sessions established for the network slice needs to be increased or decreased. In response to the Nnsacf_NSAC_NumOfPDUsUpdate Request, the SMF may receive Nnsacf_NSAC_NumOfPDUsUpdate Response message from the NSACF. The Nnsacf_NSAC_NumOfPDUsUpdate Response message may comprise a result indication. The result indication may comprise an outcome of update and/or check operation in the NSACF for the network slice, may comprise indication of whether maximum number of PDU sessions for the S-NSSAI not reached or maximum number of PDU sessions for the S-NSSAI reached. Based on the received Nnsacf_NSAC_NumOfPDUsUpdate Response message, the SMF may send a response message to the UE. The response message may comprise at least one of PDU session establishment accept message and/or PDU session establishment reject message. For example, if the response from the NSACF comprises indication of maximum number of PDU sessions for the S-NSSAI not reached, the SMF may send to the UE the PDU session establishment accept message. For example, if the response from the NSACF comprises indication of maximum number of PDU sessions for the S-NSSAI reached, the SMF may send to the UE the PDU session establishment reject message.

In an implementation, the SMF and/or the NSCAF may manage the number of the PDU Sessions for the network slice, per access type. For example, a first UE may establish a first PDU session for multi-access, and the first PDU session is established using a 3GPP access path and/or a N3GPP access path. Because the first PDU session is using a resource of the network slice of both the 3GPP access and the N3GPP access, the SMF and/or the NSCAF may increase the number of PDU sessions for the network slice by 2. For example, because the first PDU session is using the 3GPP access, the SMF and/or the NSCAF may increase the number of PDU sessions for the network slice by 1. For example, because the first PDU session is using the N3GPP access, the SMF and/or the NSCAF may increase the number of PDU sessions for the network slice by 1. For example, a second UE may establish a second PDU session using the 3GPP access path and/or the second PDU session may not use a resource of the N3GPP access path. For example, because the second PDU session is using the 3GPP access, for the 3GPP access, the SMF and/or the NSCAF may increase the number of PDU sessions for the network slice by 1. For example, for the N3GPP access, because the second PDU session is not using the N3GPP access, the SMF and/or the NSCAF may not increase the number of PDU sessions for the network slice by 1.

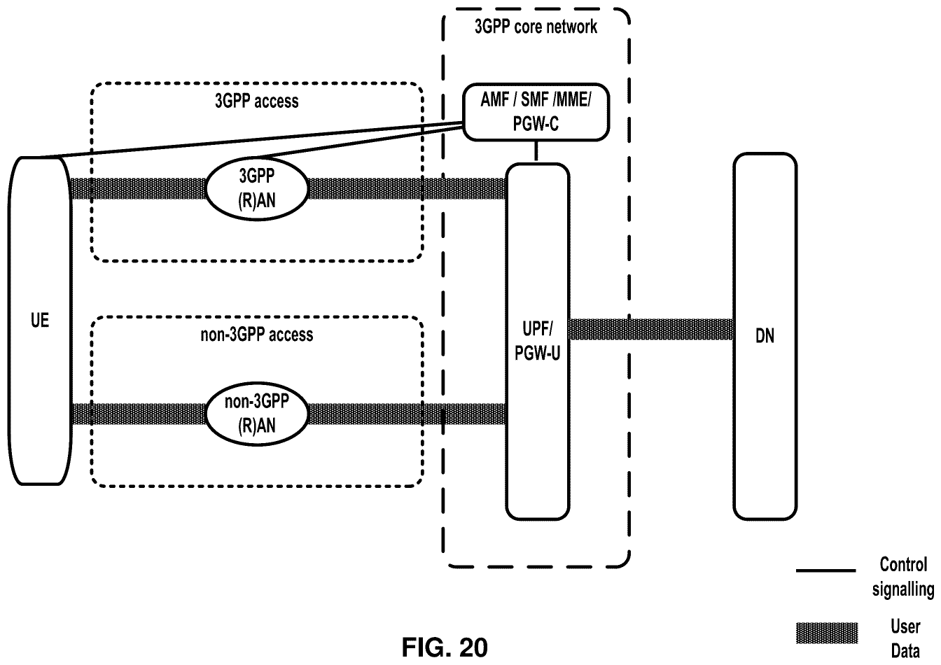

FIG. 20 illustrates an example as per an aspect of an embodiment of the present disclosure.

In one implementation, a N3GPP access may employ a N3IWF. For a UE to access a network via the N3GPP access, the UE may perform establishment of connection toward the N3IWF.

For example, the establishment of connection toward the N3IWF may requires one or more steps. The one or more steps may comprise at least of selection of selection of an access point (e.g., of a WiFi), identification of one or more candidate N3IWFs, selection of a the N3IWF among the one or more candidate N3IWFs, sending connection establishment request toward the N3IWF, receiving connection establishment confirm from the N3IWF, exchange security material for data protection, and/or the like.

After the establishment of the connection toward the N3IWF, the UE may send a registration request to an AMF via the N3IWF. For example, the UE may send the registration request to the N3IWF and/or the N3IWF may forward the registration request to the AMF.

In one implementation, many steps required for the UE to use the N3GPP access (e.g., the connection toward N3IWF, the registration to AMF, and/or the like) may incur delays until the UE can actually start data exchanges over the N3GPP access. In addition, existing implementations supporting the N3GPP access may require deployment of the N3IWF and available route from the UE to the N3IWF. If the access point where the UE access cannot be routed toward the N3IWF, the UE cannot use the N3GPP access.

One potential enhanced embodiment to address issues of existing implementation may be at least one of to support the UE's direct access to a core network (e.g., a user plane node, e.g., UPF) via the access point (e.g., a N3GPP RAN, a N3GPP RAT), to support the N3GPP access not comprising the N3IWF, to support the N3GPP access without registration via the N3IWF, to support the N3GPP access without registration via the N3GPP access, to control the use of N3GPP access via the 3GPP access, and/or the like.

The example embodiment shown in FIG. 20 may help to alleviate the issues of the existing implementation. The UE may perform registration toward the network (e.g., to a core network node, AMF, SMF) via the 3GPP access. After the UE finishes the registration via the 3GPP access, and/or while the UE is registered via the 3GPP access, the network may provide information for the N3GPP access without (e.g., not using) the N3IWF. For example, the information for the N3GPP access without the N3IWF may provide one or more IP addresses and/or one or more port information of one or more UPFs. The information for the N3GPP access without the N3IWF may comprise a NIN3GPP resource information, a resource information for NIN3GPP access, and/or the like.

The UE may utilize the information for the N3GPP access without the N3IWF, for the N3GPP access. For example, after selecting one or more WiFi networks (e.g., access points), without establishing a connection toward the N3IWF, without contacting the AMF via the N3GPP access, without performing registration for the N3GPP access, and/or the like, the UE may start establishment of connection of (or via, through) the N3GPP access toward the one or more UPFs, using the one or more IP addresses and/or the one or more port information of the one or more UPFs.

The embodiment shown in FIG. 20 may help operation to support efficiently UE's access to the network via the non-3GPP RAN. However, the embodiment of FIG. 20 to address a problem of the existing technologies may cause another issue with a network slice, explained below.

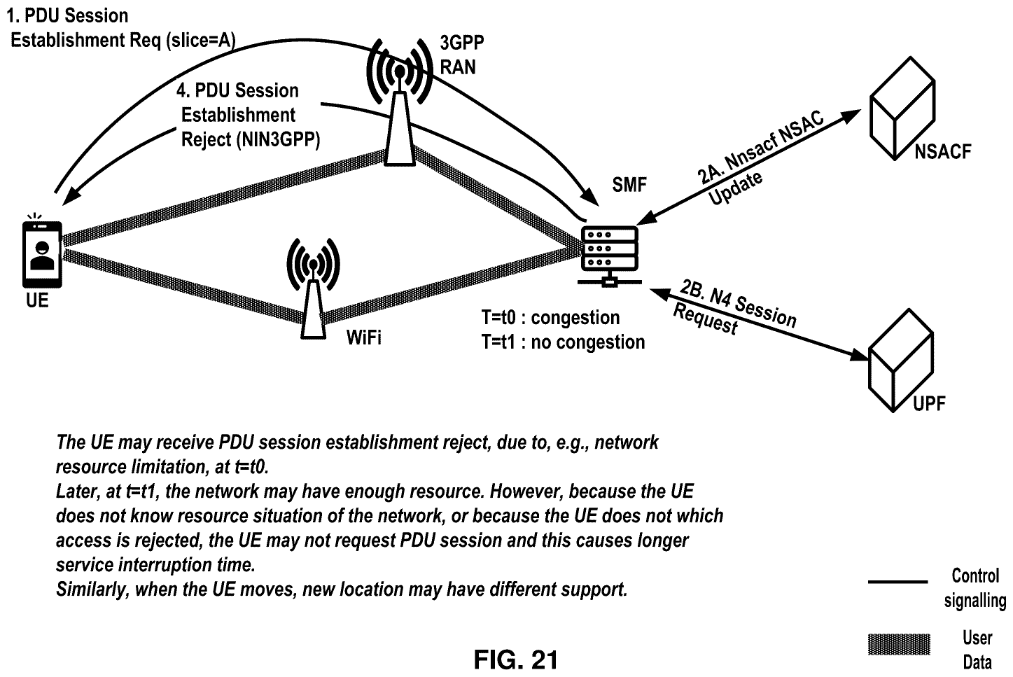

FIG. 21 illustrates an example as per an aspect of an embodiment of the present disclosure.

In one potential implementation of existing technologies, as shown in FIG. 21, a UE may send a first message, requesting establishment of a PDU session, for a requested network slice (e.g., slice A, S-NSSAI A), via a 3GPP RAN. The first message may request the PDU session being the first MA PDU session type, the first ATSSS type, and/or the like. The first message may request use of the NIN3GPP access, the direct access, the first MA PDU session type, the first ATSSS type, and/or the like, for the PDU session.

In an example, a SMF may receive the first message from the UE. In response to receiving the first message from the UE, the SMF may request a UPF to provide a NIN3GPP resource information, and/or may receive from the UPF the NIN3GPP resource information. If there is not enough resource for the NIN3GPP access and/or if the requested network slice is congested, the UPF may not be able to allocate the resource for the NIN3GPP access. The UPF may send to the SMF, a report message indicating that allocation of the resources for the NIN3GPP access fails.

In another example, in response to receiving the first message from the UE, the SMF may request a NSACF to update a number of UEs (or PDU sessions) for the requested network slice. If the number of UEs (or PDU sessions) for the requested network slice reaches a maximum number for the requested network slice, the NSACF may send a second report message to the SMF. The second report message may indicate that the maximum number is reached for the requested network slice.

In an example, in response to receiving the report message and/or the second response, the SMF may send a second message to the UE, at time t=t0. The second message may indicate at least one of that the PDU session is rejected. Because the PDU session is rejected, the UE may not exchange one or more data packets associated with the requested network slice. In an example, after the time t=t0, and/or at the time t=t1, a quota for the network slice may be available at the NSACF and/or a resource for the NIN3GPP access may be available at the UPF.

In the existing technologies, this may cause a first issue, because the UE may not know whether the resource is available or not, the UE may not request a service. This may cause a second issue, because the UE is out of network service for a network slice, even though there is an available resource for the network slice in the network. This may cause a third issue, because the UE may not know which accesses in the network is congested. This may cause a fourth issue, because the UE may not know whether a network service is available after the UE moves into a new area (e.g., cell, TA).

Embodiments of the present disclosure are related to an approach for solving the issues described above. These and other features of the present disclosure are described further below.

In an example embodiment, a UE may receive from a network node, an information indicating which resource is not available, which access paths are not allowed, and/or the like. In another embodiment, the UE may receive from the network node via a first access, an indication indicating whether a network slice of a PDU session is partially available or not. This may assist the UE in determining whether the PDU session is partially allowed, or completely allowed, and/or the like. In another embodiments, the UE may receive from the core network node, a message allowing a PDU session and/or a network slice, indicating whether an access path for the PDU session is rejected or not. This may prevent the UE from sending unsupported requests for the PDU session to the network. In another embodiment, the UE may receive from the network node, information of time when the UE is allowed to send another request. This may help in reducing service interruption time of the UE while reducing congestion in the network. In another embodiment, the UE may determine whether to release an access path based on unavailability of the access path. This may help in reducing service interruption time of the UE. This may further help the network reduce congestion.

In the specification, the term “network system” may be interpreted as, or may refer to, a communication system, and/or a generation of the communication system. For example, one or more network systems may comprise an EPS, a 5GS. For example, the first network system may be the EPS. The EPS may comprise of one or more UEs, one or more eNB, one or more en-gNBs, one or more EPCs. The one or more EPCs may comprise a MME, a SGW, a PGW, and/or the like. For example, the second network system may be the 5GS. The 5GS may comprise of one or more UEs, one or more gNB, one or more ng-eNBs, one or more 5G core networks. The one or more 5G core networks may comprise an AMF, a SMF, a PCF, and/or the like. For example, a 6^{th} generation (6G) system may be the 6GS. The 6GS may comprise of one or more UEs, one or more 6G-RAN, one or more gNBs, one or more 6G core networks.

In the specification, the term “5G System” may be interpreted as, or may refer to, a 3GPP system consisting of at least one of 5G access network (or NG-RAN), 5G core network and/or a UE.

In the specification, the term “EPS” may be interpreted as, or may refer to, a 3GPP system consisting of at least one of EPC, E-UTRAN and/or a UE.

In the specification, the term “network node” may be interpreted as, or may refer to, at least one of a core network node, an access node, a UE, the like, and/or a combination thereof. A network may comprise one or more network nodes.

In the specification, the term “core network node” may be interpreted as, or may refer to, a core network device, which may comprise at least one of an AMF, a SMF, a NSSF, a UPF, a NRF a UDM, a PCF, a SoR-AF, an AF, an DDNMF, an MB-SMF, an MB-UPF, a MME, a SGW, a PGW, a SMF+PGW-C, a SMF+PGW-U, a UDM+HSS and/or the like. The core network node may be a 5G core network node, a 6G core network node, a 4G core network node, the likes, and/or a combination thereof.

In the specification, the term “5G core network” may be interpreted as, or may refer to, a core network connecting to a 5G access network. This may be 5G core (5GC).

In the specification, the term “RAT type” may be interpreted as, or may refer to, identifying the transmission technology used in the access network for 3GPP accesses and/or for non-3GPP accesses. For example, RAT type for 3GPP access may comprise at least one of NR, NB-IOT, E-UTRA, and/or the like. For example, RAT type for non-3GPP access may comprise at least one of untrusted non-3GPP, trusted non-3GPP, trusted IEEE 802.11 non-3GPP access, Wireline, Wireline-Cable, Wireline-BBF, WiFi, etc.

In the specification, the term “3GPP RAT” may be interpreted as, or may refer to, a radio access technology based on 3rd generation partnership (3GPP) project. For example, this may comprise at least one of a NR, a E-UTRA, UTRA, GSM, 6GR (6G radio), the like, and/or a combination thereof.

In the specification, the term “N3GPP RAT” may be interpreted as, or may refer to, a radio access technology not based on 3rd generation partnership project. This may be an access technology not developed by 3GPP. For example, this may comprise a WiFi, trusted WiFi, non-trusted WiFi, fixed access, wireline broadband, the like, and/or a combination thereof.

In the specification, the term “5G access network” may be interpreted as, or may refer to, an access network comprising at least one of a NG-RAN and/or non-3GPP RAN, and connecting to a 5G core network.

In the specification, the term “3GPP RAN” may be interpreted as, or may refer to, a radio access network using 3GPP RAT. For example, this may comprise at least one of a gNB, an eNB, a ng-eNB, an en-gNB, the like, and/or a combination thereof. For example, this may be at least one of an E-UTRAN, NG-RAN, 6G-RAN (6th generation RAN), the like, and/or a combination thereof. The 3GPP RAN may be 3GPP access node.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “N3GPP RAN” may be interpreted as, or may refer to, an access network using non-3GPP (N3GPP) RAT. For example, the N3GPP RAT may comprise e.g., a WiFi, and/or one or more radio access technologies not defined (developed) by 3GPP and/or other radio access technologies than 3GPP RAT. This may be a N3GPP access network (AN). For example, in a first implementation, a first N3GPP RAN (e.g., a first type of N3GPP RAN) may comprise at least one of N3IWF, ePDG, TNGF, W-GAN, the like, and/or a combination thereof. In the first implementation, a first N3GPP access and/or a first N3GPP RAN may be associated with a signalling, the UE may send/receive one or more signalling message to/from a core network node via the N3GPP access, and/or the UE may send/receive one or more user data via the N3GPP RAT. In a second implementation, a second N3GPP RAN (e.g., a second type of N3GPP RAN) may not comprise N3IWF, ePDG, TNGF, W-GAN, the like, and/or a combination thereof. The second implementation may be a Non-Integrated Non-3GPP (NIN3GPP) access and/or a NIN3GPP RAN. For example, the NIN3GPP access may not be associated with a signalling, the UE may not send/receive one or more signalling messages to/from a core network node via the N3GPP access, and/or the UE may send/receive a user data via the N3GPP RAT.

In the specification, the term “access type” may be interpreted as, or may refer to, indicating a type of access used for communicating with a network. For example, this may comprise a 3GPP access type (or 3GPP access) and/or a N3GPP access type (or N3GPP access). For example, if the access type is the 3GPP access type, this may indicate that a UE is communicating with the network by using one or more 3GPP RATs, and/or via one or more 3GPP RANs. For example, if the access type is the N3GPP access type, this may indicate that a UE is communicating with the network by using one or more N3GPP RATs, and/or via one or more N3GPP RANs. In an example, access may comprise at least one of sending a data, receiving a data, sending a signalling message, receiving a signalling message, performing registration, and/or the like.

In the specification, the term “3GPP access type” may be interpreted as, or may refer to, an access using one or more 3GPP RATs, and/or via one or more 3GPP RANs.

In the specification, the term “N3GPP access type” may be interpreted as, or may refer to, an access using one or more N3GPP RATs, and/or via one or more N3GPP RANs.

In the specification, the term “Non-Integrated Non-3GPP Access” may be interpreted as a type of non-3GPP access network that provides direct IP connectivity between the UE and the UPF without any intermediate network function (NF) such as Non-3GPP interworking function (N3IWF) and trusted Non-3GPP gateway function (TNGF). When a UE is connected using Non-Integrated Non-3GPP Access, the UE data flows can be routed via this access to operator services. When a UE is connected using Non-Integrated Non-3GPP Access, the UE may not exchange signalling messages with a network via a N3GPP access.

In the specification, the term “access path” may be interpreted as, or may refer to, a path between a UE and a network for exchange of data and/or signalling. The access path may be an access leg, a path, an access route (route), an access track (track), an access channel (channel), an access corridor (corridor), an access link (link) and/or the like. The access path may indicate (be associated with) at least one of a path from a UE to a RAN, a path from a UE to a core network, a path from a RAN to a core network, the like, and/or a combination thereof. For example, the access path may be defined per a pair of a core network and/or an access network.

For example, for an access type, there may be one or more different types. For example, a first type of the access type (e.g., NIN3GPP) may support transporting of signalling message for the access type. For example, the signalling message may be one or more messages exchanged between a UE and one or more core network nodes. For example, the signalling message may not comprise one or more second messages of one or more applications outside of a core network. For example, the signalling message may be targeted to the UE and/or the one or more core network nodes. For example, a second type (e.g., non-NIN3GPP) of the access type may support transporting of signalling message for the access type.

For example, in one implementation, the access path may comprise at least a control plane. For example, in another implementation, the access path may not comprise the control plane. For example, the access path may or may not have a user plane. Before establishing a bearer transporting user data (e.g., voice data, IP packets), the access path may not have the user plane. After establishing the bearer, the access path may have the user plane.

For example, one or more N3GPP access paths may comprise a first type N3GPP access path and/or a second-type N3GPP access path. The first type N3GPP access path (e.g., Non-Integrated Non-3GPP Access) may not comprise a N3IWF. The second type N3GPP access path may comprise the N3IWF.

In the specification, the term “MA PDU Session” may be interpreted as, or may refer to, a PDU Session that provides a PDU connectivity service, which can use/establish one access type at a time, or simultaneously one 3GPP access and one N3GPP access, simultaneously more than one paths of 3GPP access type or simultaneously more than one paths of N3GPP access type.

In the specification, the term Access Traffic Steering, Switching, Splitting (ATSSS) may be a feature. The feature may enable a multi-access PDU connectivity service, which can exchange PDUs between the UE and a data network by simultaneously using one 3GPP access and one non-3GPP access and/or two independent N3/N9 tunnels between the PSA and RAN/AN (e.g., wifi access point). The multi-access PDU Connectivity Service may be realized by establishing a Multi-Access PDU (MA PDU) Session, i.e., a PDU Session that may have user-plane resources on two accesses (e.g., the 3GPP access and/or the non-3GPP access). For ATSSS, one or more ATSSS functionalities may be used. For example, the one or more ATSSS functionalities may comprise a first ATSSS functionality, a second ATSSS functionality, and/or the like. For example, the first ATSSS functionality may be an ATSSS-LL, the second ATSSS functionality may be a MPTCP functionality. For example, the ATSSS functionality may indicate which layer (e.g., entity, protocol, functionality of a UE and/or a UPF) is used for handling a traffic of a PDU session. For ATSSS, one or more steering modes may be used. For example, the one or more steering mode of the ATSSS may be Active-Standby, Smallest Delay, and/or the like. For example, the steering mode of the ATSSS may indicate which method may be used to distribute/steer a traffic of the PDU session.

In the specification, the term ATSSS type may be interpreted as an architecture, characteristics, and/or the like, used for supporting the ATSSS. The ATSSS type may be associated with a type of a PDU session, a feature of a PDU session, a characteristic of a MA PDU session, and/or the like. In one embodiments, a PDU session can be categorized non-MA PDU session (e.g., single PDU session), a MA PDU session of a first ATSSS type (e.g., NIN3GPP), a MA PDU session of a second ATSSS type (e.g., non-NIN3GPP), and/or the like. In one embodiments, a non-3GPP access of a PDU session can be categorized a NIN3GPP access, a non-NIN3GPP access, and/or the like.

For example, in supporting the feature of the ATSSS, a first ATSSS type (e.g., Non-Integrated Non-3GPP Access) may not comprise an N3IWF in a N3GPP access, the first ATSSS type may not use a signalling connection between a UE and a core network node (e.g., AMF, SMF) via the N3GPP access, the first ATSSS type may comprise (be, associated with) a first type PDU session established over at least the N3GPP access not using the N3IWF. For example, not using N3IWF may be that the UE and a UPF may exchange one or more PDUs, via the N3GPP access, and the one or more PDUs may not traverse the N3IWF. For example, not using N3IWF may be that the UE and an AMF (and/or SMF, and/or one or more core network node) may not exchange one or more signalling messages via the N3IWF (and/or via N3GPP access). The first ATSSS type may be an ATSSS-lite, a simplified ATSSS, a direct access, NIN3GPP, and/or the like. In some embodiments, the first ATSSS type may be Non-Integrated Non-3GPP Access (NIN3GPP).

In the specification, the term “NIN3GPP”, “NIN3GPP access”, “N3GPP access without N3IWF”, “first ATSSS type”, “simplified ATSSS”, “ATSSS-lite”, “first MA PDU session type” and/or the like may be used interchangeably.

For example, in supporting the feature of the ATSSS, a second ATSSS type (e.g., Integrated Non-3GPP Access) may comprise an N3IWF in a N3GPP access, the second ATSSS type may use a signalling connection between a UE and a core network node (e.g., AMF, SMF) via the N3GPP access, the second ATSSS type may comprise a second type PDU session using at least the N3GPP access using the N3IWF. For example, using the N3IWF may be that the UE and a UPF may exchange one or more PDUs, and the one or more PDUs may traverse the N3IWF. For example, using the N3IWF may be that the UE and an AMF (and/or SMF, and/or one or more core network node) may exchange one or more signalling messages via the N3IWF.

In the specification, the term “support of a ATSSS type” may be interpreted as, or may refer to, support of the ATSSS type. For example, the support of the ATSSS type may indicate a support of a first ATSSS type, a second ATSSS type, a plurality of ATSSS type, and/or the like. The indication of the support of the ATSSS type may be separate from an indication of support of ATSSS, from support of one or more ATSSS functionality, from support one or more steering modes. A UE supporting the ATSSS may further indicate which one or more ATSSS types (e.g., the first ATSSS type, the second ATSSS type, and/or the like) are supported by the UE. In another example, the support of the ATSSS may be interpreted as supporting the second ATSSS type. In another example, not supporting of the ATSSS may be interpreted as supporting the third ATSSS type.

For example, a feature of an ATSSS type (the first ATSSS type) may comprise at least one of sending/receiving a NAS message via a 3GPP access, not sending/receiving the NAS message via a N3GPP access, establishing a PDU which uses a first resource of the 3GPP access and a second resource of the N3GPP access, receiving configuration of the N3GPP access via the 3GPP access, and/or the like.

The ATSSS type may be interpreted as a type of MA PDU sessions, or a type of a PDU session.

In one embodiment, a third PDU session may be a single access (SA) PDU session. The SA PDU session may use (or be established using, use a resource of) a 3GPP access and/or may not use a N3GPP access. The third PDU session may be a PDU session of a third PDU session type. The third PDU session may be a PDU session of a third ATSSS type. The third PDU session may be a PDU session of a third MA PDU session type.

In one embodiment, a second PDU session may be a multi-access (MA) PDU session. The second PDU session may use (or be established using, use a resource of, be allowed to use) a 3GPP access and may use a N3GPP access. The N3GPP access may comprise (or use, use resource, communicate via) a N3IWF. The second PDU session may be a PDU session of a second PDU session type. The second PDU session may be a MA PDU session of a second MA PDU session type. The second PDU session may be a PDU session of a second ATSSS type.

In one embodiment, a first PDU session may be a multi-access (MA) PDU session. The first PDU session may use (or be established using, use a resource of, be allowed to use) a 3GPP access and may use a N3GPP access. The N3GPP access may not comprise (or use, use resource, communicate via) a N3IWF. The first PDU session may be a PDU session of a first PDU session type. The third PDU session may be a MA PDU session of a first MA PDU session type. The first PDU session may be a PDU session of a first ATSSS type.

One or more PDU session types (e.g., the first PDU session type, the second PDU session type, the third PDU session type) may corresponds to one or more ATSSS types. One or more MA PDU session types (e.g., the second MA PDU session type, the third MA PDU session type) may corresponds to one or more ATSSS types.

In one embodiment, support of ATSSS may be interpreted as supporting a MA PDU session. A node supporting the ATSSS may support one or more ATSSS types. A node not supporting the ATSSS may not support one or more ATSSS types. A first node of one or more nodes supporting the ATSSS may support a first ATSSS type and/or a second node of the one or more nodes supporting the ATSSS may not support the first ATSSS type.

In the specification, the term “mobility management node” may be interpreted as, or may refer to, a function and/or a node performing mobility management for a UE. For example, mobility management may be at least one of management of registration status, management of context, management of authorization, management of registration area, management of paging, and/or the like. For example, the mobility management node may comprise at least one of a MME, AMF, and/or the like.

In the specification, the term “network slice quota” for a network slice may be interpreted as a maximum number of UEs allowed to be registered for the network slice, a maximum number of PDU sessions allowed to be established for the network slice, a maximum number of PDU sessions allowed to be activated for the network slice, a maximum number of PDU sessions allowed to be deactivated for the network slice, and/or maximum number of countable resources for the network slice, and/or the like. In the specification, the term “quota” for a network slice may be interpreted as a network slice quota. In an example, the network slice quota may be counted considering an access type.

In the specification, the term “network slice admission control (NSAC)” may be interpreted as network slice quota management. In the specification, the network slice quota management for a network slice may comprise controlling access to the network slice. The network slice quota management for a network slice may comprise controlling admission to the network slice for a UE and/or for a PDU session and so on. For example, the network slice quota management may or may not allow establishment of a PDU session for the network slice. For example, the network slice quota management may or may not determine to allow a registration for the network slice.

In the specification, the UE may not perform registration procedure via the NIN3GPP access (e.g., N3GPP access). For example, in the example embodiments in this disclosure, the UE may not send the registration request via the N3GPP access, the UE may not receive the registration response via the N3GPP access and/or the UE may not communicate with a N3IWF.

In the specification, a procedure may be interpreted as comprising sending by a first node to a second node a first message, receiving by the second node from the first node the first message, sending by the second node to the first node a second message, and/or receiving by the first node from the second node the second message. The first node may be one or more first network nodes, and the second node may be a one or more second network nodes. The procedure may comprise a registration procedure, a deregistration procedure, a service request procedure, a notification procedure, a PDU session establishment procedure, a PDU session modification procedure, a UE configuration update procedure, and/or the like.

In the specification, a NAS message may be a message exchanged between a UE and a core network node. The NAS message may be exchanged via a 3GPP access and/or via a N3GPP access. The NAS message may comprise a MM (mobility management) message, a SM (session management) message, and/or the like. The MM message may comprise a registration request message, a registration accept message, a registration reject message, a UE configuration update message, a UL NAS transport message, a DL NAS transport message, a deregistration message, a service request message, a service accept message, a service reject message, a PDU session establishment request message, a PDU session establishment accept message, a PDU session establishment reject message, a PDU session modification request message, a PDU session modification accept message, a PDU session modification reject message, a PDU session modification command message, a PDU session release request message, a PDU session release command message, and/or the like.

In an example, a timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to change of the value). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a network slice inactivity window timer (e.g., a NS UE monitoring timer, a NS PDU monitoring timer) may be used for measuring a window of time for measuring the network slice inactivity. In an example, instead of starting and expiry of a network slice inactivity window timer, the time difference between two time stamps may be used. When a timer is restarted, a process for measurement of time window may be restarted. Other example implementations may be provided to restart a measurement of a time window.

In an example, indication (e.g., indicate, indicating) may be achieved in various ways. For example, a first indication may be done by including a first field in a first signalling (e.g., a message). Alternatively and/or additional, a second indication may be done by not including the first field in the first signalling. For example, if a first message comprises the first field (e.g., used/assigned for the first indication, e.g., field A), the first indication (e.g., a timer is used) may be done (e.g., achieved, delivered from a sender to a receiver). For example, if the first field in the first message is set to a value A, a third indication (e.g., timer value is value A) may be done. For example, if the first message does not comprise the first field, the second indication (e.g., timer is not used) may be done. In another example, a fourth indication (e.g., a UE is allowed for action C) may be done by sending a second signalling (e.g., a message whose name comprises ‘C’ and/or ‘accept’). Alternatively and/or additionally, a fifth indication (e.g., a UE is not allowed for action C) may be done by not sending the second signalling (e.g., a message, a field (e.g., allowed bit). For example, the sender can indicate A, by sending a message A1 comprising an indicator (e.g., an information element) indicating A and/or by sending a message A2. For example, the message A2 may be used only to indicate A and/or the message A2 itself may indicate the A. For example, when a first entity indicates to a second entity about first something, the first entity may send to the second entity, an indicator (e.g., an information element) indicating the first something, and/or may send to the second entity, a message comprising the indicator and/or may send a first dedicated message for the first something. In other example, when a first entity does not indicate to a second entity about second something, the first entity may not send to the second entity, a first indicator (e.g., an information element) indicating the second something, may not send to the second entity, a message comprising the first indicator, and/or may send to the second entity, a second indicator indicating that the second something does not apply, and/or may send a message not comprising the first indicator, and/or may send to the second entity, a second dedicated message for indicating the second something. In another example, not sending any message may be interpreted as an indication.

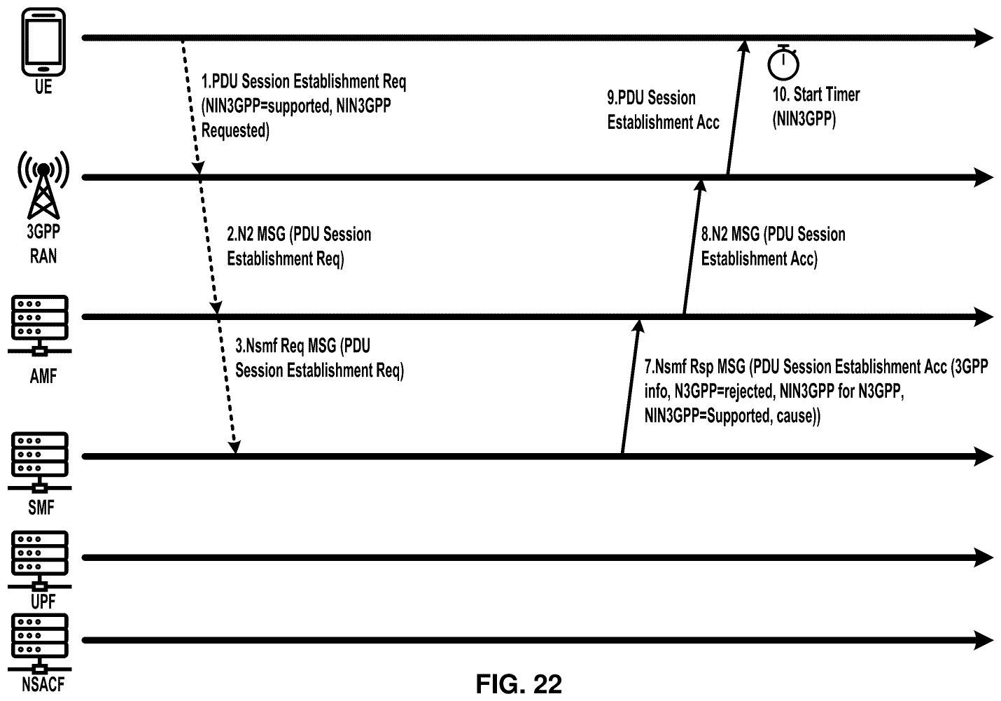

FIG. 22 illustrates an example as per an aspect of an embodiment of the present disclosure.

In an example, a UE may send a first message (e.g., 1^{st} message, message 1, NAS message 1) to a core network node. The first message may indicate at least one of a UE capability information and/or a UE request information. The UE capability information may indicate one or more capabilities supported by the UE and/or one or more features supported by the UE. The UE request information may indicate one or more requests of one or more features. The first message may comprise an identifier of the UE. The first message may comprise one or more identifiers of one or more requested network slices.

The first message may be a registration request message, a PDU session establishment request message, and/or the like.

In an example, the UE may send the first message when the UE is registered for the 3GPP access and/or is not registered for the N3GPP access. For example, the UE may send the first message when the UE is registered for the 3GPP access and/or is not registered for the N3GPP access. For example, the UE may send the first message, without sending/receiving a registration (request/accept) message via the N3GPP access before sending the first message.

The one or more capabilities may indicate that the UE supports an ATSSS, that the UE supports one or more ATSSS types, that the UE supports a first ATSSS type, and/or the like. The one or more ATSSS type may comprise the first ATSSS type, a second ATSSS type and/or a third ATSSS type. The first ATSSS type may be associated with a first PDU session type using a first N3GPP access type and/or the first N3GPP access type may not employ (comprise) a N3IWF. The second ATSSS type may be associated with a second PDU session type using a second N3GPP access type and/or the second N3GPP access type may employ at least one N3IWF. That the UE supports the ATSSS may be that the UE supports at least one of the one or more ATSSS type (e.g., the first ATSSS type, the second ATSSS type). If the UE indicates support of the ATSSS and/or if the UE does not indicate support of at least one of the one or more ATSSS types, the AMF may determine that the UE does not supports the first ATSSS type (e.g., using the N3GPP access without N3IWF). If the UE indicates support of the ATSSS and/or if the UE does indicate support the first ATSSS type, the AMF may determine that the UE supports the first ATSSS type (e.g., using the N3GPP access without N3IWF) and/or the second ATSSS type. Separating an indication of the support of ATSSS type from an indication of the support of the ATSSS, may help the network to determine a N3GPP resources for a PDU session, based on capabilities of the UE.

The one or more requests may comprise a first indication that the UE request a PDU session of the first PDU session type (the first MA PDU session, a PDU session type using the NIN3GPP access, a PDU session using the direct access, a PDU session of the first ATSSS type) and/or the like.

In an example, the core network node may receive the first message from the UE. The core network node may be an AMF, a SMF, a PCF, and/or the like. The core network node may receive the first message via a 3GPP RAN and/or via a 3GPP access.

In an example, the core network node may determine to send a second message (e.g., a message 2, a second NAS message, NAS message 2, and/or the like) to the UE. The second message may comprise at least one of a first indication indicating whether the PDU session is established (or allowed), a second indication indicating a type of the PDU session, a third indication indicating whether the 3GPP access is used (allocated, configured) for the PDU session, a fourth indication indicating whether the N3GPP access is used (allocated, configured) for the PDU session, a fifth indication indicating whether the N3GPP access is the NIN3GPP access, a sixth indication indicating whether the first PDU session type (e.g., the first MA PDU session type, the first ATSSS type) is rejected, a seventh indication indicating a NIN3GPP time period value (e.g., a value of the NIN3GPP time period), and/or the like. For example, the second message may indicate that the SMF (and/or the PDU session) supports the NIN3GPP access and/or that the SMF (and/or the PDU session) does not use the NIN3GPP access, and/or the like. This may help the UE to determine whether the SMF does not use the NIN3GPP access, though the SMF supports a feature of the NIN3GPP access. For example, a cause value of the second message may be at least one of one or more indications (e.g., first indication, second indication, and so on) of the second message.

A NIN3GPP time period associated with the NIN3GPP time period value may be a time (or timer value, a period) controlling UE's an access/request for the NIN3GPP access. For example, the NIN3GPP time period may be at least one of: a first time period during which the UE is not allowed to request establishment of a (new) PDU session A using (comprising) the NIN3GPP access for a network slice; a second time period during which the UE is not allowed to request modification of an (existing) PDU session B (which does not comprise the N3GPP access) to a PDU session using (comprising) the NIN3GPP access; a fourth time period during which the UE is not allowed to request of adding the NIN3GPP access to the PDU session B; a fifth time period during which the UE is allowed to request modification of the 3GPP access of the PDU session B; a sixth time period during which the UE is allowed to request change of one or more parameters of the PDU session B, and/or the like. For example, the one or more parameters of the PDU session B may be one or more QoS parameters, one or more QoS rule, a PS Data Off indication, and/or the like. For example, the one or more parameters of the PDU session B may not comprise information associated with the NIN3GPP access, and/or the like.

In an example, the UE may receive the second message from the SMF via the AMF and/or via the 3GPP RAN. For example, the second message may be at least one of a PDU session establishment accept message, a PDU session modification accept message, a PDU session modification command message, a PDU session release request message, a PDU session release command message, a DL NAS transfer message, and/or the like. In an example, the UE may receive the second message when the UE is registered for the 3GPP access and/or is not registered for the N3GPP access. For example, the UE may receive the second message, without sending/receiving a registration (request/accept) message via the N3GPP access before receiving the second message.

In response to receiving the second message, based on the information indicated by the second message, the UE may determine at least one of that the PDU session is established (allowed, accepted); that the PDU session is not the first ATSSS type (e.g., the first MA PDU session type, using the direct access, using the NIN3GPP access, and/or the like); that the PDU session is established using the 3GPP access; that the PDU session is not using the N3GPP access; that the NIN3GPP access is rejected (not configured, not established) for the PDU session; and/or the like. For example, if the second message indicates at least one of that the NIN3GPP access is rejected, and/or that the PDU session is the third PDU session type (e.g., the third MA PDU session type), the UE may determine that the PDU session is not the first PDU session type and/or that the NIN3GPP access is not allowed for the PDU session.

In an example, in response to receiving the second message comprising the value for the NIN3GPP time period, the UE may start the NIN3GPP time period. For example, to start the NIN3GPP time period may be that the UE starts a NIN3GPP timer (e.g., NIN3GPP backoff timer, backoff timer for NIN3GPP access, and/or the like) for the PDU session (or for a network slice associated with the PDU session).

In an example, in response to receiving the second message indicating establishment of the PDU session, the UE may start communicating (e.g., receiving/sending) one or more data of the PDU session, via the 3GPP access. In an example, in response to receiving the second message indicating that the NIN3GPP access (e.g., the first ATSSS type) is rejected, and/or in response to the NIN3GPP timer is running, the UE may not communicate one or more second data of the PDU session, via the N3GPP access. In an example, in response to receiving the second message indicating that the NIN3GPP access (e.g., the first ATSSS type) is rejected, and/or in response to the NIN3GPP timer is running, the UE may not send to the SMF, a second request requesting an establishment of a PDU session D of the first ATSSS type and/or a third request requesting modification of the PDU session to the first ATSSS type. In an embodiment, the NIN3GPP timer may be associated with the requested network slice. The requested network slice may be identified using a S-NSSAI of the requested network slice.

In an example, the UE may receive from the SMF (or the AMF), a NAS message. For example, the NAS message may be a PDU session message, the UE configuration update message, a paging message, and/or the like. For example, the PDU session message may indicate that the PDU session is modified to the first ATSSS type, and/or that the first ATSSS type is allowed for the PDU session. For example, the UE configuration update message may indicate that the requested network slice is allowed for the first ATSSS type. In response to receiving the NAS message, the UE may stop the NIN3GPP time period and/or the NIN3GPP timer. Based on the NIN3GPP timer not running and/or based on the NIN3GPP timer being stopped, the UE may send to the SMF, the second request requesting the establishment of the PDU session D of the first ATSSS type, the UE may send to the SMF, the third request requesting modification of the PDU session to the first ATSSS type, and/or the UE may send one or more fourth data packets of the PDU session via the NIN3GPP access.

The example embodiment of the FIG. 22 may help in reducing unnecessary request of a UE for a PDU session of a first ATSSS type. This may prevent reducing network congestion and/or unnecessary signalling.

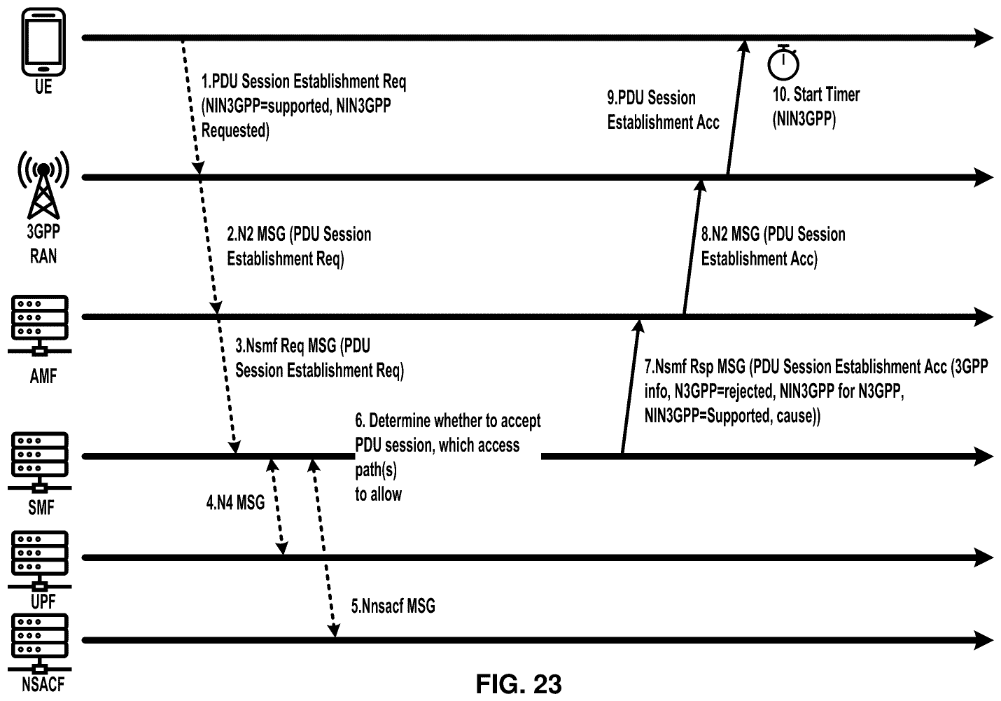

FIG. 23 illustrates an example as per an aspect of an embodiment of the present disclosure. For brevity, based on the other part of the present disclosure, redundant details will be omitted.

In an example, the core network node may receive the first message from the UE. For example, the example shown in the FIG. 22 may apply.

Reverting back to the FIG. 23, the core network node may be the SMF. In response to receiving the first message, because the first message is requesting the PDU session of the first ATSSS type, and/or because the requested network slice (e.g., a first network slice) associated with the PDU session is configured for a network slice admission control (NSAC), the SMF may determine to send a Nnsacf request message 5 to a NSACF.

In an example, the Nnsacf request message 5 may be at least one of Nnsacf_NSAC_NumOfUEsUpdate request message 5, Nnsacf_NSAC_NumOfPDUsUpdate request message 5, Nnsacf_NSAC_EACNotify request message 5, Nnsacf_NSAC_QuotaUpdate request message 5, Nnsacf_NSAC_LocalNumberUpdate request message 5, and/or the like.

The Nnsacf request message 5 may comprise at least one of an identifier of a network slice (e.g., identifier of the first network slice, a network slice 1, a slice 1, S-NSSAI 1, the requested network slice and/or the like), the identifier of the UE, an identifier of the PDU session (e.g., PDU session ID 1), an information of access type, update flag, and/or the like.

The information of access type may indicate at least one of one or more access types, an MA-PDU type (e.g., the first MA PDU type, the first MA PDU session type), a type of the PDU session, an ATSSS type (e.g., the first ATSSS type), an indication of NIN3GPP access, the direct access, an indication of MA PDU session, and/or the like. For example, the information of access type may indicate at least one of whether the UE (or the network slice) is associated with the first MA-PDU type (or, the first ATSSS type, the direct access, the NIN3GPP access), whether the PDU session is associated with the first MA-PDU type (or, the first ATSSS type, the direct access, the NIN3GPP access), whether the network slice (e.g., the S-NSSAI 1, the network slice 1) is associated with the first MA-PDU type (or, the first ATSSS type, the direct access, the NIN3GPP access), whether a 3GPP access is associated, whether a N3GPP access is associated, whether a N3GPP access of the PDU session does not comprise the N3IWF, whether a N3GPP access of the UE does not comprise the N3IWF, and/or the like. The information of access type may not only indicate whether the N3GPP access is used or not, but also may indicate the type of N3GPP access.

The update flag may indicate whether the number of UEs registered with the network slice needs to be increased or decreased and/or whether the number of PDU sessions for the network slice needs to be increased or decreased and/or.

In response to receiving the Nnsacf request message 5, the NSACF may determine to send a Nnsacf response message 5. The Nnsacf response message 5 may comprise at least one of a first result indication for the network slice, the identifier of the UE, an identifier of the PDU session (e.g., PDU session ID 1), and/or the like.

The Nnsacf response message 5 may be at least one of Nnsacf_NSAC_NumOfUEsUpdate response message 5, Nnsacf_NSAC_NumOfPDUsUpdate response message 5, Nnsacf_NSAC_EACNotify response message 5, Nnsacf_NSAC_QuotaUpdate response message 5, Nnsacf_NSAC_LocalNumberUpdate response message 5, and/or the like.

The first result indication may indicate at least one of whether maximum number of the UEs for the network slice is reached, whether maximum number of the UEs for the 3GPP access for the network slice is reached, whether maximum number of the UEs for the N3GPP access for the network slice is reached, whether maximum number of the UEs for the NIN3GPP access for the network slice is reached, whether maximum number of the PDU sessions for the 3GPP access for the network slice is reached, whether maximum number of the PDU sessions for the N3GPP access for the network slice is reached, whether maximum number of the PDU sessions for the NIN3GPP access for the network slice is reached, whether maximum number of the PDU sessions for the network slice is reached for (at least) one access of a plurality of accesses, whether maximum number of the PDU sessions for the network slice is reached for both accesses, whether maximum number of the PDU sessions for the network slice is reached for one access of a plurality of accesses, whether maximum number of the UEs for the network slice is reached for both accesses, and/or whether maximum number of the UEs for the network slice is reached for at least one access of a plurality of accesses. The first result indication may indicate whether the first ATSSS type is allowed for the UE (or for the PDU session) is allowed or not.

In an example, the SMF may receive from the NSACF, the Nnsacf response message 5.

In response to receiving the Nnsacf response message 5, because the Nnsacf response message 5 indicates that the maximum number of UEs for the network slice is not reached, because the Nnsacf response message 5 indicates that the maximum number of UEs for the network slice for the 3GPP access is not reached, because the Nnsacf response message 5 indicates that the maximum number of PDU sessions for the network slice is not reached, because the Nnsacf response message 5 indicates that the maximum number of PDU sessions for the network slice for the 3GPP access is not reached, the SMF may determine to allow the PDU session and/or the SMF may determine to establish the 3GPP access of the PDU session.

In response to receiving the Nnsacf response message 5, because the Nnsacf response message 5 indicates that the maximum number of UEs for the network slice for the N3GPP access (e.g., the NIN3GPP access) is reached, because the Nnsacf response message 5 indicates that the first ATSSS type is not allowed for the UE (or for the PDU session), because the Nnsacf response message 5 indicates that the maximum number of PDU sessions for the network slice is reached for the N3GPP access, the SMF may determine not to allow the N3GPP access for the PDU session and/or the SMF may determine not to establish (allow) the N3GPP access of the PDU session.

In response to receiving the message 1, the SMF may send to a UPF, a N4 request message 4. The N4 request message 4 may be at least one of a N4 session establishment request message 4 (e.g., PFCP session establishment request message), N4 session modification request message 4 (e.g., PFCP session modification request message), and/or the like. For example, the N4 request message 4 may comprise a resource (allocation) request for the NIN3GPP access for the PDU session and/or information of the network slice. The resource request for the NIN3GPP access may indicate that the UPF allocates a resource (e.g., IP address, port, of QUIC) of the NIN3GPP access (of the PDU session), and/or that the SMF requests the UPF to provide information of the resource for the NIN3GPP access.

In an example, the SMF may receive a N4 response message 4, from the UPF. The N4 response message 4 may be at least one of a N4 session establishment response message 4, N4 session modification response message 4, and/or the like. For example, the N4 response message 4 may comprise one or more N4 session parameters associated with the PDU session. If the resource for the network slice 1 is congested, if the UPF does not supports the NIN3GPP access, if the UPF cannot allocate resources for the NIN3GPP access, the N4 response message 4 may not comprise resource information of the NIN3GPP access and/or the N4 response may indicate that the resource for the NIN3GPP is not allocated. For example, the one or more N4 session parameters associated with the PDU session may indicate one or more resources allocated for the 3GPP access of the PDU session and/or may indicate that the N4 resources is successfully allocated for the 3GPP access of the PDU session, and/or the like. For example, the N4 response message 4 may indicate a time value. The time value may indicate a time period during which the NIN3GPP resource is not available and/or when the SMF can request the NIN3PP resource, and/or the like.

In an example, the SMF may receive the N4 response message 4. In response to receiving the N4 response message 4, because the N4 response message 4 indicates that the resource for the NIN3GPP resource is not allowed (allocated), the SMF may determine not to allow the N3GPP access (e.g., the NIN3GPP access) for the PDU session. For example, the SMF may determine the NIN3GPP time period value, based on the time value received from the UPF.

In an example, the core network node (e.g., SMF) may determine to send the second message to the UE. The second message may comprise at least one of the first indication indicating whether the PDU session is established (or allowed, configured), the second indication indicating a type of the PDU session, the third indication indicating whether the 3GPP access is used (established, allowed, configured), for the PDU session, the fourth indication indicating whether the N3GPP access is used for the PDU session, the fifth indication indicating whether the N3GPP access is the NIN3GPP access, the sixth indication indicating whether the first PDU session type (e.g., the first MA PDU session type, the first ATSSS type) is rejected, the seventh indication indicating the NIN3GPP time period value, and/or the like. For example, a cause value of the second message may be at least one of one or more indications (e.g., first indication, second indication, and so on) of the second message.

The example embodiment of the FIG. 23 may help a first core network node (e.g., SMF) to properly determine which network slice (or UE, or the PDU session) can use an ATSSS type of a plurality of ATSSS types, based on input from a second core network node (e.g., UPF, NSACF).

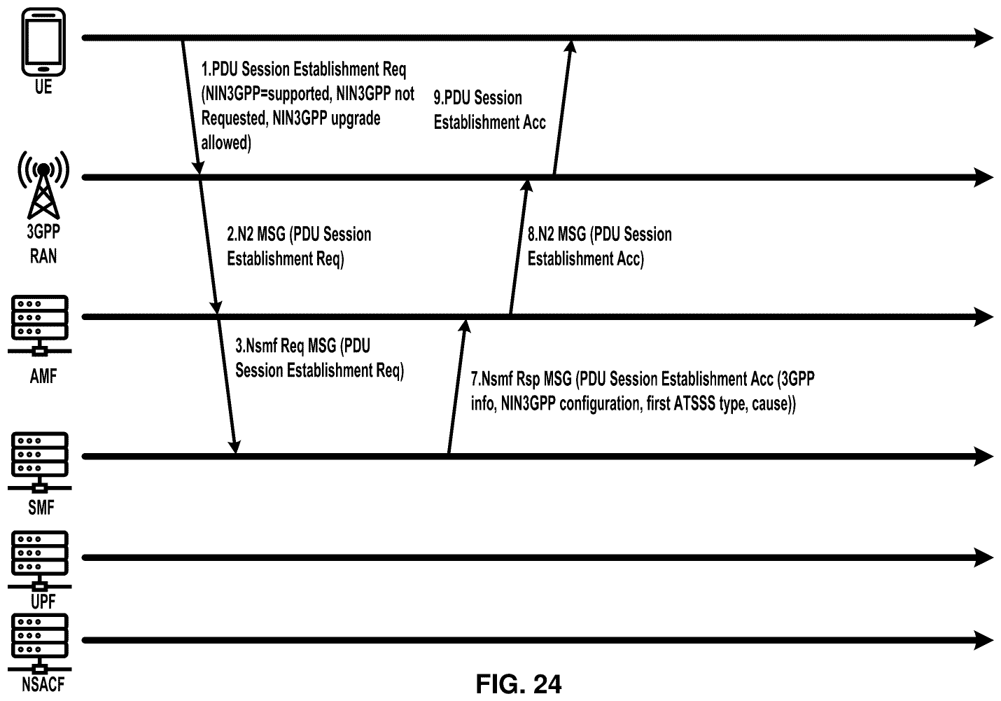

FIG. 24 illustrates an example as per an aspect of an embodiment of the present disclosure. For brevity, based on the other part of the present disclosure, redundant details will be omitted.

In an example, a UE may send a first message A (1st message A) to a core network node. The first message A may indicate at least one of the UE capability information and/or a UE request information A. The UE capability information may indicate one or more capabilities supported by the UE and/or one or more features supported by the UE. The UE request information A may indicate one or more requests A of one or more features. The first message A may comprise one or more information elements of the first message.

The one or more capabilities may indicate that the UE supports a feature of a ATSSS, that the UE supports one or more ATSSS types of a plurality of ATSSS types, that the UE supports a first ATSSS type of the one or more ATSSS types, and/or the like. The one or more ATSSS type may comprise the first ATSSS type and/or a second ATSSS type. The first ATSSS type may be associated with a first PDU session type using a first N3GPP access type and/or the first N3GPP access type may not employ (comprise, configure) a N3IWF. The second ATSSS type may be associated with a second PDU session type using a second N3GPP access type and/or the second N3GPP access type may employ at least one N3IWF. That the UE supports the ATSSS may be that the UE supports at least one of the one or more ATSSS type. If the UE indicates support of the ATSSS and/or if the UE does not indicate support of at least one of the one or more ATSSS type, the AMF may determine that the UE does not supports the first ATSSS type (e.g., using the N3GPP access without N3IWF). By separating an indication of the support of ATSSS type from an indication of the support of the ATSSS, may help the network to identify what is supported by the UE.

The one or more requests A may comprise a first indication A that the UE request a PDU session of the third PDU session type (the third MA PDU session, the third ATSSS type, a single PDU session, a PDU session not being a MA PDU session) and/or the like. The one or more requests A may comprise a first indication B that the UE requests a PDU session of the second PDU session type (the second MA PDU session, the second ATSSS type, a MA PDU session) and/or the like. The one or more requests A may comprise a first indication C that the UE does not request a PDU session of the first PDU session type (the first MA PDU session, the first ATSSS type, the direct access, the NIN3GPP access) and/or the like. The one or more requests A may comprise a first indication D that the UE allows the network (e.g., the AMF, the SMF) to upgrade (or update) the PDU session to the first PDU session type (the first MA PDU session, the first ATSSS type, the direct access, the NIN3GPP access), that the UE allows the network to establish (modify) the PDU session of the first PDU session type and/or the like. The one or more requests A may comprise a first indication E that the UE allows the network (e.g., the AMF, the SMF) to up grade (or update) the PDU session to the second PDU session type (the second MA PDU session, the second ATSSS type), that the UE allows the network to establish (modify) the PDU session of the second PDU session type and/or the like. For example, based on QoS requirement, the UE may not need the PDU session of the first ATSSS type and/or may not request the PDU session of MA PDU session. Based on the QoS requirement, based on location information of the UE (e.g., the UE is located in a 3GPP cell with low reliability), the network may determine that using the first ATSSS type meets a service requirement of the UE. In this case, the first indication D will assist for the network to be aware whether the first ATSSS type can be applied for the UE (or for the PDU session), instead of the third ATSSS type being applied. Similarly, the first indication E assist for the network to be aware whether the second ATSSS type can be applied, instead of the third ATSSS type. If the UE does not send the first indication D, and if the 3GPP access is not enough to support a required QoS, the network may not be able to modify the PDU session (e.g., from the third ATSSS type to the first ATSSS type).

The first message A may be a registration request message, a PDU session establishment request message, and/or the like. The first message may comprise an identifier of the UE. The first message may comprise one or more identifiers of one or more requested network slices.

In an example, the core network node may receive the first message A from the UE. The core network node may be an AMF, a SMF, a PCF, and/or the like. The core network node may receive the first message A via a 3GPP RAN and/or via a 3GPP access.

In an example, the core network node may determine to send a second message A to the UE. The second message A may comprise at least one of a first indication indicating whether the PDU session is established (or allowed), a second indication indicating a type of the PDU session, a third indication indicating whether the 3GPP access is used for the PDU session, a fourth indication indicating whether the N3GPP access is used for the PDU session, a fifth indication indicating whether the N3GPP access is the NIN3GPP access, a sixth indication indicating whether the first PDU session type (e.g., the first MA PDU session type, the first ATSSS type) is configured for the PDU session, a seventh indication indicating a NIN3GPP time period value, a eighth indication indicating that the PDU session is upgraded to the first ATSSS type, the resource information of the NIN3GPP access, and/or the like.

In an example, the UE may not perform registration procedure via the NIN3GPP access (e.g., N3GPP access). The UE may not send the registration request via the N3GPP access.

In response to receiving the second message A, based on the information indicated by the second message A, the UE may determine at least one of that the PDU session is established (allowed, accepted); that the PDU session is the first ATSSS type (e.g., the first MA PDU session type, using the direct access, using the NIN3GPP access, and/or the like); that the PDU session is established using the 3GPP access; that the PDU session is established using the N3GPP access; that the NIN3GPP access is established for the PDU session; and/or the like.

The example embodiment of FIG. 24 may help a home network to determine which type of ATSSS (or MA PDU session) to apply for a PDU session, based on indication from the UE.

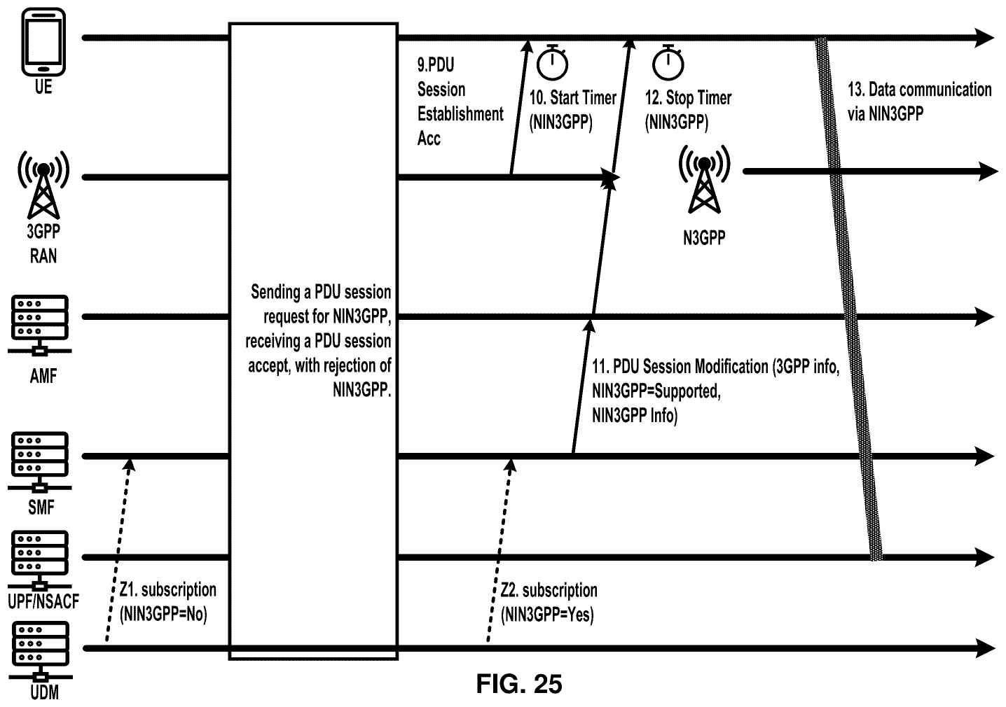

FIG. 25 illustrates an example as per an aspect of an embodiment of the present disclosure. For brevity, based on the other part of the present disclosure, redundant details will be omitted.

In an example, the UE may send the first message and/or receive the second message (e.g., as shown in the FIG. 22 or FIG. 23).

In an example, in response to (e.g., when, upon) receiving the second message comprising the value (e.g., 10 minutes, 1 hours) for the NIN3GPP time period, the UE may start the NIN3GPP time period. For example, to start the NIN3GPP time period, the UE may start a NIN3GPP timer (e.g., NIN3GPP backoff timer, backoff timer for NIN3GPP access, backoff timer and/or the like). The second message may be a PDU session establishment accept message, accepting the PDU session. The second message may indicate configuration of the 3GPP access for the PDU session. The second message may not indicate configuration of the NIN3GPP access for the PDU session and/or may indicate rejection of the NIN3GPP access for the PDU session.

In an example, in response to receiving the second message indicating establishment (e.g., accept, allow) of the PDU session, the UE may start communicating (e.g., receiving/sending) one or more data of the PDU session, via the 3GPP access. In an example, in response to receiving the second message indicating that the NIN3GPP access (e.g., the first ATSSS type) is rejected (not configured, not established), and/or in response to the NIN3GPP timer is running, the UE may not communicate one or more second data of the PDU session, via the N3GPP access. In an example, in response to receiving the second message indicating that the NIN3GPP access (e.g., the first ATSSS type) is rejected, because the NIN3GPP timer not being expired, and/or in response to (e.g., while, during) the NIN3GPP timer is running, the UE may not send to the SMF, a second request requesting an establishment of a PDU session D of the first ATSSS type and/or a third request requesting modification of the PDU session to the first ATSSS type, and/or the like. In an embodiment, the NIN3GPP timer may be associated with the requested network slice and/or with the PDU session.

In an example, the UE may receive from the SMF (or the AMF), a NAS message, via the 3GPP access. For example, the NAS message (e.g., a NAS message 11) may be a PDU session message, the UE configuration update message, a paging message, and/or the like. The PDU session message may be a PDU session modification command, a PDU session release request message, a PDU session release command message, and/or the like. For example, the NAS message may indicate that the PDU session is modified to (associated with) the first ATSSS type, may indicate that the requested network slice (the network slice, the first network slice, the requested network slice) is allowed for the first ATSSS type, may indicate that the PDU session is upgraded to the first ATSSS type, may comprise the resource information of the NIN3GPP access for the PDU session, may indicate that the NIN3GPP access is added to the PDU session, and/or the like. In response to receiving the NAS message, the UE may stop the NIN3GPP time period (e.g., the NIN3GPP timer). Based on the NIN3GPP timer not running and/or based on the NIN3GPP timer being stopped, the UE may send to the SMF the second request requesting the establishment of the PDU session D of the first ATSSS type, the UE may send to the SMF the third request requesting modification of the PDU session to the first ATSSS type, and/or the UE may communicate one or more data packets via the NIN3GPP access.

For example, the SMF may determine whether the PDU session can be modified to the first ATSSS type, based on notification from the NSACF and/or the UPF. For example, the notification may indicate that a quota is available (e.g., maximum number of the UEs/PDU session for the network slice is not reached) for the N3GPP (e.g., NIN3GPP) for the network slice and/or that a resource for the NIN3GPP is available at the UPF.

In another embodiment, the SMF (or the AMF) may receive a message Z1 from the UDM, before sending the second message to the UE. The message Z1 may be Nudm_SDM_Get message. The message Z1 may comprise a first subscription information indicating that the UE is not allowed for the NIN3GPP access, and/or that the network slice (associated with the PDU session) is not allowed for the NIN3GPP access. Because the message Z1 indicates that the UE is not allowed for the NIN3GPP access, the SMF may determine not to allow the NIN3GPP access for the PDU session.

In an embodiment, after sending the second message and/or after receiving the message Z1, and/or while the NIN3GPP timer is running in the UE, the SMF may receive a message Z2 from the UDM. The message Z2 may be Nudm_SDM_Get message and/or Nudm_SDU_Notify message. The message Z2 may comprise a second (updated) subscription information indicating that the UE is allowed for the NIN3GPP access, and/or that the network slice (associated with the PDU session) is allowed for the NIN3GPP access. Because the message Z2 indicates that the UE is allowed for the NIN3GPP access, the SMF may determine to allow the NIN3GPP access for the PDU session and/or the SMF may send the NAS message (e.g., a NAS message 11) to the UE, via the 3GPP access.

The example embodiment of FIG. 25 may help in reducing amount of time of not using the NIN3GPP access, and may help the UE to be aware that the NIN3GPP access is available.

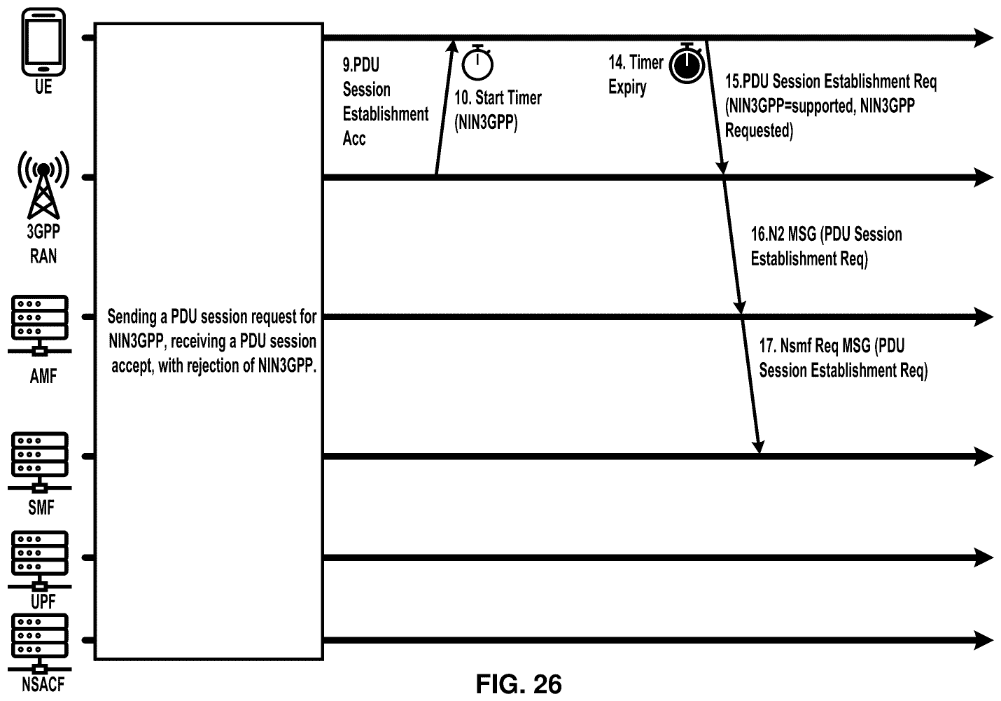

FIG. 26 illustrates an example as per an aspect of an embodiment of the present disclosure. For brevity, based on the other part of the present disclosure, redundant details will be omitted.

In an example, the UE may send the first message and/or receive the second message (e.g., as shown in the FIG. 22 or FIG. 23).

In an example, in response to (e.g., when, upon) receiving the second message comprising the value (e.g., 10 minutes, 1 hours) for the NIN3GPP time period, the UE may start the NIN3GPP time period. For example, to start the NIN3GPP time period, the UE may start a NIN3GPP timer (e.g., NIN3GPP backoff timer, backoff timer for NIN3GPP access, backoff timer and/or the like). The second message may be a PDU session establishment accept message, accepting the PDU session.

In an example, in response to receiving the second message indicating establishment (e.g., accept, allow) of the PDU session, the UE may start communicating (e.g., receiving/sending) one or more data of the PDU session, via the 3GPP access. In an example, in response to receiving the second message indicating that the NIN3GPP access (e.g., the first ATSSS type) is rejected, and/or in response to the NIN3GPP timer is running, the UE may not communicate one or more second data of the PDU session, via the N3GPP access. In an example, in response to receiving the second message indicating that the NIN3GPP access (e.g., the first ATSSS type) is rejected, because the NIN3GPP timer not being expired, and/or in response to (e.g., while, during) the NIN3GPP timer is running, the UE may not send to the SMF, a second request requesting an establishment of a PDU session D of the first ATSSS type and/or a third request requesting modification of the PDU session to the first ATSSS type, and/or the like. In an embodiment, the NIN3GPP timer may be associated with the requested network slice and/or with the PDU session.

In an example, the NIN3GPP time period (e.g., the NIN3GPP timer) may expire. Based on the NIN3GPP time period expiring, based on the NIN3GPP timer not running and/or based on the NIN3GPP timer being stopped, the UE may send to the SMF, the second request requesting the establishment of the PDU session D of the first ATSSS type for the network slice, and/or the third request requesting modification of the PDU session to the first ATSSS type for the network slice. For example, the second request message (or the third request message) may comprise an indication of PDU session, an indication of the network slice, an indication of the first ATSSS type, an indication of upgraded of a PDU session to the first ATSSS type allowed, and/or the like.

The example embodiment of FIG. 26 may allow the UE to reinitiate establishment of the PDU session of the PDU session type, while reducing unnecessary access to a congested network.

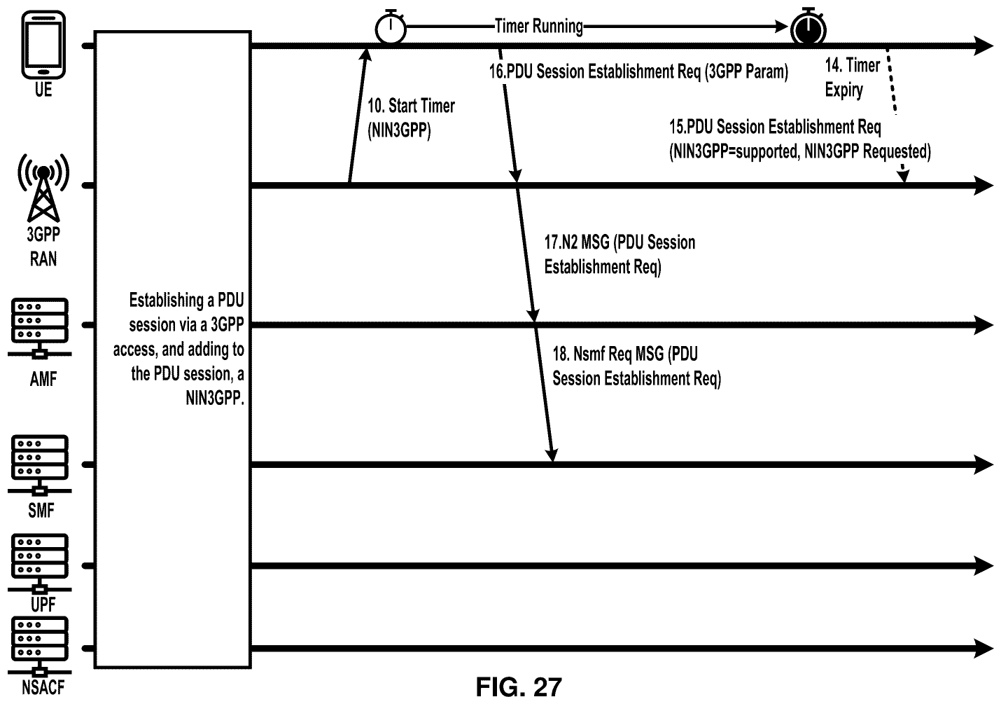

FIG. 27 illustrates an example as per an aspect of an embodiment of the present disclosure. For brevity, based on the other part of the present disclosure, redundant details will be omitted.

In an example, the UE may send the first message and/or receive the second message (e.g., as shown in the FIG. 22 or FIG. 23).

In an example, in response to (e.g., when, upon) receiving the second message comprising the value (e.g., 10 minutes, 1 hours) for the NIN3GPP time period, the UE may start the NIN3GPP time period. For example, to start the NIN3GPP time period, the UE may start a NIN3GPP timer (e.g., NIN3GPP backoff timer, backoff timer for NIN3GPP access, backoff timer and/or the like). The second message may be a PDU session establishment accept message, accepting the PDU session.

In an example, in response to receiving the second message indicating establishment (e.g., accept, allow) of the PDU session, the UE may start communicating (e.g., receiving/sending) one or more data of the PDU session, via the 3GPP access. In an example, in response to receiving the second message indicating that the NIN3GPP access (e.g., the first ATSSS type) is rejected, and/or in response to the NIN3GPP timer is running, the UE may not communicate one or more second data of the PDU session, via the N3GPP access. In an example, in response to receiving the second message indicating that the NIN3GPP access (e.g., the first ATSSS type) is rejected, because the NIN3GPP timer not being expired, and/or in response to (e.g., while, during) the NIN3GPP timer is running, the UE may not send to the SMF, a second request requesting an establishment of a PDU session D of the first ATSSS type and/or a third request requesting modification of the PDU session to the first ATSSS type, and/or the like. In an embodiment, the NIN3GPP timer may be associated with the requested network slice and/or with the PDU session.

In an example, the UE may determine to change one or more QoS parameters of the PDU session. For example, the UE may determine to change a PDB of the PDU session and/or may request addition of QoS flow to the PDU session. For example, the UE may determine to change a status of PS (packet switch) data off, e.g., when a user switches on/off an internet connection control button of the UE. In an example, the UE may construct a third request message. For example, the third request message may be at least one of UL NAS transport message, a PDU session modification request message, a PDU session release request message, a PDU session release command message, and/or the like. The UE may determine whether the NIN3GPP timer is running for the PDU session. If the NIN3GPP timer is running, the UE may determine whether the UE can transmit the third request message. In an example, if the third request message does not request a PDU session of the first ATSSS type, and/or if the third request message does not request modification of the PDU session to the first ATSSS type, and/or if the third request message does not comprise information associated with the NIN3GPP access, the UE may determine to send the third request message, during the NIN3GPP time period. In another example, if the third request message requests a PDU session of the first ATSSS type, and/or if the third request message requests modification of the PDU session to the first ATSSS type, and/or if the third request message comprises information associated with the NIN3GPP access, the UE may determine not to send the third request message, during the NIN3GPP time period (e.g., is running, before expiry). In another example, if a fourth request message indicates change of a capability of UE (e.g., change of support of the NIN3GPP access from not supporting to supporting, and/or vice versa), the UE may determine to send the fourth request message, during the NIN3GPP time period (e.g., is running, before expiry).

The example embodiment of FIG. 27 may allow the UE to modify the PDU session while the request of the NIN3GPP access is not allowed.

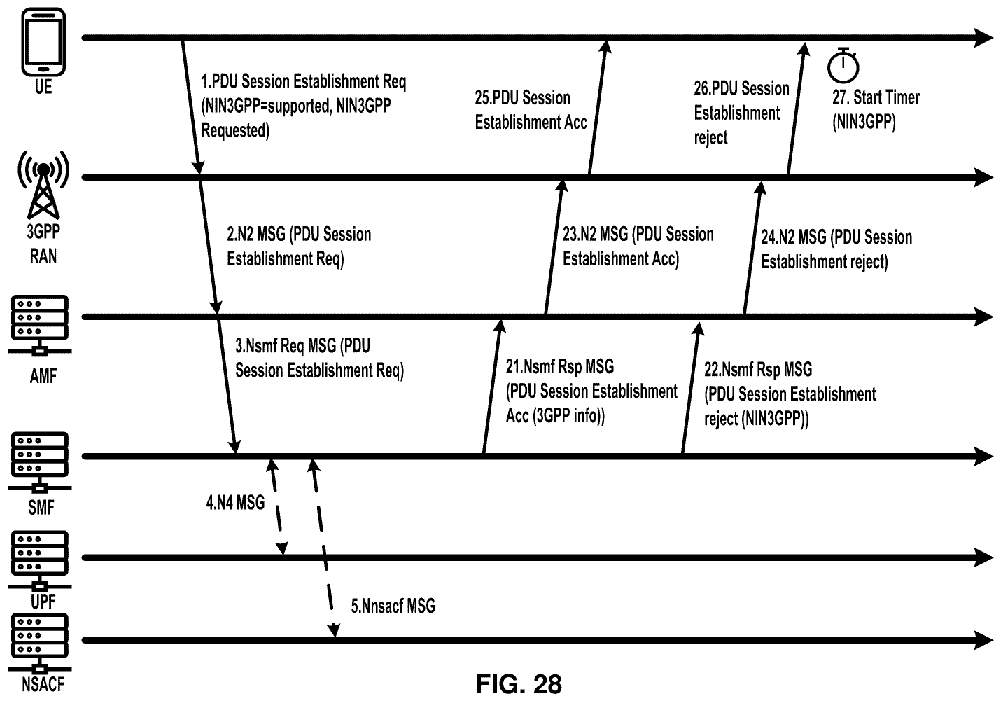

FIG. 28 illustrates an example as per an aspect of an embodiment of the present disclosure. For brevity, based on the other part of the present disclosure, redundant details will be omitted.

In an example, the UE may send the first message and/or the SMF may receive the first message (e.g., as shown in the FIG. 22 or FIG. 23).

In an example, the core network node (e.g., SMF) may determine to send a NAS message 25 to the UE, in response to receiving the first message. The NAS message 25 may comprise at least one of a first indication indicating whether the PDU session is established (or allowed), a second indication indicating a type of the PDU session, a third indication indicating whether the 3GPP access is used for the PDU session, and/or the like. The NAS message 25 may not comprise a fourth indication indicating whether the N3GPP access is used for the PDU session, a fifth indication indicating whether the N3GPP access is the NIN3GPP access, a sixth indication indicating whether the first PDU session type (e.g., the first MA PDU session type, the first ATSSS type) is rejected, a seventh indication indicating the NIN3GPP time period value, and/or the like. For example, the NAS message 25 may indicate whether the SMF (and/or the PDU session) supports the NIN3GPP access and/or whether the SMF (and/or the PDU session) does not use the NIN3GPP access. For example, in response to the first message requesting the PDU session of the first ATSSS type, the SMF may determine to send a plurality of NAS messages to the UE. For example, each of the plurality of NAS messages may indicate whether an access (e.g., the 3GPP access, the N3GPP access, the NIN3GPP access, and/or the like) is used (allocated, configured, established) for the PDU session. For example, the plurality of NAS message may comprise the NAS message 25. The NAS message 25 may indicate that the 3GPP access is configured for the PDU session and/or may not indicate whether the N3GPP access is configured for the PDU session. The NAS message 25 may be at least one of a PDU session establishment response (e.g., accept) message, a PDU session modification response (e.g., accept) message, a PDU session release request message, a PDU session release command message, and/or the like.

The SMF may send the NAS message 25 to the UE, via the AMF and/or via the 3GPP RAN.

In an example, the core network node (e.g., SMF) may determine to send a NAS message 26 to the UE, in response to receiving the first message. The NAS message 26 may not comprise at least one of the first indication indicating whether the PDU session is established (or allowed), the second indication indicating a type of the PDU session, the third indication indicating whether the 3GPP access is used for the PDU session, and/or the like. The NAS message 26 may comprise the fourth indication indicating whether the N3GPP access is used for the PDU session, the fifth indication indicating whether the N3GPP access is the NIN3GPP access, the sixth indication indicating whether the first PDU session type (e.g., the first MA PDU session type, the first ATSSS type, the NIN3GPP access) is rejected, the seventh indication indicating the NIN3GPP time period value (a value for the NIN3GPP time period), and/or the like. For example, in response to the first message requesting the PDU session of the first ATSSS type, the SMF may determine to send the plurality of NAS messages to the UE. For example, the plurality of NAS message may comprise the NAS message 26. The NAS message 26 may indicate whether the N3GPP access (NIN3GPP access) is configured for the PDU session and/or may indicate whether the N3GPP access is rejected for the PDU session. The NAS message 26 may be at least one of a PDU session establishment response (e.g., reject) message, a PDU session modification response (e.g., reject) message, a PDU session release request message, a PDU session release command message, and/or the like.

The SMF may send the NAS message 26 to the UE, via the AMF and/or via the 3GPP RAN.

In an example, in response to (e.g., when, upon) receiving the NAS message 26 comprising the value (e.g., 10 minutes, 1 hours) for the NIN3GPP time period and/or in response to receiving the NAS message 26 indicating rejection of the NIN3GPP access for the PDU session, the UE may start the NIN3GPP time period. For example, to start the NIN3GPP time period, the UE may start a NIN3GPP timer (e.g., NIN3GPP backoff timer, backoff timer for NIN3GPP access, backoff timer and/or the like).

In an example, in response to receiving the NAS message 25 indicating establishment (e.g., accept, allow) of the PDU session, the UE may start communicating (e.g., receiving/sending) one or more data of the PDU session, via the 3GPP access. In an example, in response to receiving the NAS message 26 indicating that the NIN3GPP access (e.g., the first ATSSS type) is rejected, and/or in response to the NIN3GPP timer is running, the UE may not communicate one or more second data of the PDU session, via the N3GPP access. In an example, in response to receiving the NAS message 26 indicating that the NIN3GPP access (e.g., the first ATSSS type) is rejected, because the NIN3GPP timer not being expired, and/or in response to (e.g., while, during) the NIN3GPP timer is running, the UE may not send to the SMF, a second request requesting an establishment of a PDU session D of the first ATSSS type and/or a third request requesting modification of the PDU session to the first ATSSS type, and/or the like. In an embodiment, the NIN3GPP timer may be associated with the requested network slice and/or with the PDU session. In an example, in response to receiving the NAS message 26, the UE may not release (deactivate) the PDU session established for the 3GPP access.

In an example, the SMF may send the NAS message 25 after receiving from a NSACF that the 3GPP access is allowed for the PDU session. In an example, the SMF may send the NAS message 26 after receiving from a NSACF that the N3GPP access is not allowed for the PDU session.

The example embodiment of FIG. 28 may help a network to efficiently indicate to the UE which access is allowed and which access is rejected.

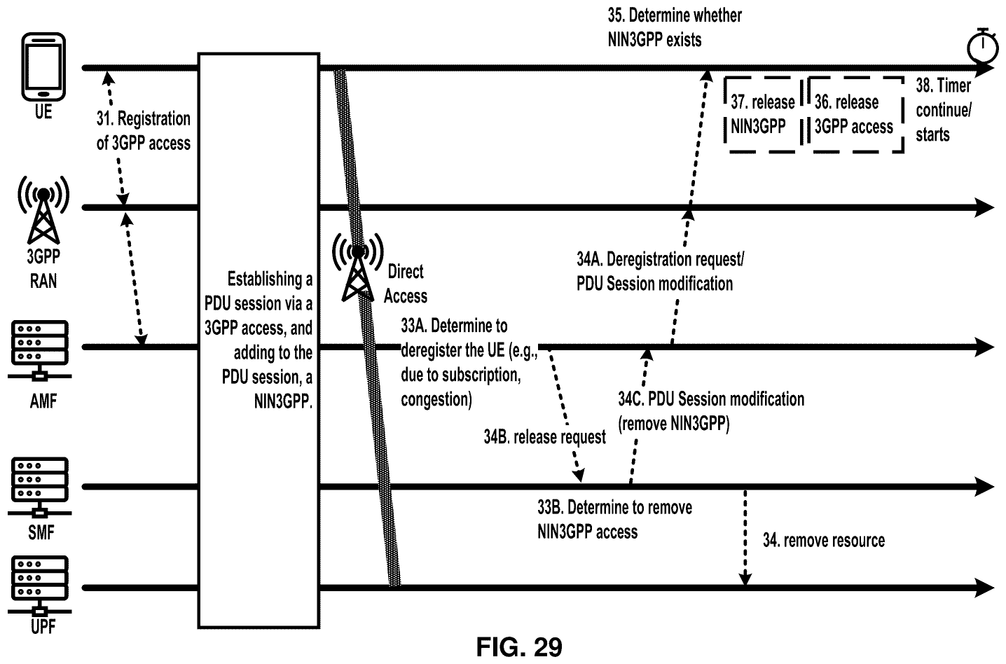

FIG. 29 illustrates an example as per an aspect of an embodiment of the present disclosure. For brevity, based on the other part of the present disclosure, redundant details will be omitted.

In an example, a UE may perform registration procedure via the 3GPP access. For example, the UE may send a first registration request message to an AMF via the 3GPP access and/or the UE may not send a second registration request message to an AMF via the N3GPP access. In response to sending the first registration request message, the UE may receive from the AMF, a first registration accept message via the 3GPP access. The first registration accept message may indicate that a first network slice is allowed for the UE for the 3GPP access.

In response to receiving the first registration accept message, the UE may establish a PDU session of the first ATSSS type.

In an example, a core network node (e.g., an AMF) may determine to de-register the UE and/or to de-register (e.g., remove) the first network slice from one or more allowed network slices. For example, when a subscription of the UE changes (e.g., a user of the UE decides to unsubscribe from the first network slice), the AMF may receive from a UDM, an indication indicating a change of the subscription.

In an example, the core network node may send a NAS message 34 to the UE. The NAS message 34 may be at least one of a UE configuration update message 34, a de-registration command (request) message 34, and/or the like. The NAS message 34 may comprise an indication indicating at least one of that the UE is deregistered, that the UE is requested to deregister, that the first network slice is deregistered, that the first network slice is removed from the one or more allowed network slices, and/or the like. In an example, the NAS message 34 may comprise a value of a NIN3GPP time period. In an example, the NAS message 34 may comprise an indication indicating that the NIN3GPP access is rejected (e.g., not allowed, removed) and/or the like.

In an example, the UE may receive the NAS message 34 via the 3GPP access (e.g., the 3GPP RAN). In response to receiving the NAS message 34, because the NAS message 34 indicates that the first network slice is rejected, because the NAS message 34 indicates that the NIN3GPP access is rejected, because the NAS message 34 indicates de-registration, and/or the like, the UE may transit from the RM-registered state to the RM-deregistered state for the N3GPP access (e.g., the NIN3GPP access), the UE may release the 3GPP access, the UE may release the resource for the NIN3GPP access, the UE may release a PDU session (e.g., of the first PDU session type, of the first ATSSS type) associated with the NIN3GPP access, and/or the like.

In an example, if the NAS message 34 comprises the value of the NIN3GPP time period, and or in response to receiving the NAS message 34, the UE may start the time period of the NIN3GPP access (e.g., the NIN3GPP timer). In another example, if the NIN3GPP time period is running when the UE receives the NAS message 34, the UE may continue to run the timer without stopping the timer.

In an example, the core network node may send a notification message 34 to a second core network node (e.g., SMF). For example, the SMF may be associated with the PDU session of the first ATSSS type. For example, the notification message 34 may be a Namf message and/or a Nsmf message. For example, the notification message may be an event notification message and/or a PDU session context message.

The notification message 34 may comprise an indication indicating at least one of that the UE is deregistered, that the UE is requested to deregister, that the first network slice (associated with the PDU session that the SMF manages) is deregistered, that the first network slice is removed from the one or more allowed network slices, that the PDU session needs to be released, that the N3GPP access is removed (deregistered) for the UE for the N3GPP access, that the PDU session needs to be released, that the resource for the NIN3GPP access of the PDU session of the first network slice needs to be released, and/or the like.

In response to receiving the notification message 34, the SMF may send a N4 session message 34 to a UPF of the PDU session. The N4 session message may indicate at least one of that the PDU session is released, that the resource for the NIN3GPP access of the PDU session needs to be released, and/or the like.

In another example, the second core network node (e.g., the SMF) may determine to remove the resource (e.g., the NIN3GPP access) from the PDU session and/or to keep a resource of the 3GPP access of the PDU session. For example, when the subscription of the UE (of the PDU session) changes, the SMF may receive from the UDM, an indication indicating the change of the subscription. For example, the change of the subscription may indicate that the NIN3GPP access is not allowed.

In an example, the second core network node may send the NAS message 34 to the UE. The NAS message 34 may be at least a PDU session modification command 34, a PDU session release request message 34, a PDU session release command message 34, and/or the like. The NAS message 34 may comprise an indication indicating at least one of that the NIN3GPP access is not allowed for the PDU session, that the NIN3GPP access is removed from the PDU session, that a type of the PDU session is changed to the third PDU session type, that the first ATSSS type is not used for the PDU session, that the PDU session is not released, and/or the like. For example, the NAS message 34 may not indicate the resource for the NIN3GPP access.

In an example, the UE may receive the NAS message 34 via the 3GPP access (e.g., the 3GPP RAN). In response to receiving the NAS message 34, because the NAS message 34 indicates that the NIN3GPP access is removed, and/or because the NAS message 34 does not comprise information of resource for the NIN3GPP access, the UE may transit from the RM-registered state to the RM-deregistered state for the N3GPP access (e.g., the NIN3GPP access), the UE may release the resource for the NIN3GPP access, the UE may not release the PDU session, the UE may communicate one or more data packets via the 3GPP access, the UE may not communicate one or more data packets via the N3GPP access, the UE may start the NIN3GPP time period, and/or the like.

The example embodiment of FIG. 29 may help a network node (e.g., a UE, a SMF, a UPF) to accurately manage one or more resources of the NIN3GPP access for a PDU session of the first ATSSS type. For example, based on whether a network slice is released and/or based on a type of PDU session, the network node may prevent the network node from keeping unnecessary a resource for the NIN3GPP access, when there is no signalling exchanged over the N3GPP access. For example, when a resource of NIN3GPP access is congested and when a resource of the 3GPP access is not congested, the SMF may selectively remove the resource of the NIN3GPP, while keeping the PDU session.

In an implementation, a network may determine to allow the 3GPP access for a PDU session, while not allowing the NIN3GPP access for the PDU session. To prevent unnecessary request of the UE for the NIN3GPP access, the NIN3GPP time period can be used. After expiry of the NIN3GPP time period, the UE may send a signalling message to the network. In other implementation, after establishing the PDU session with the NIN3GPP access, the UE may move from a first area supporting the NIN3GPP access into a second area where the NIN3GPP access is not available. This may cause an issue because the network may not be aware of the UE being in the second area and/or may send a data packet via the NIN3GPP access which is not available to the UE. In an example embodiment, the network may be able to determine and control accurately usage of the resources configured for the NIN3GPP access. Alternatively and/or additionally, for efficient use of network resources, and/or for reducing amount of signalling messages, the network may configure the UE with information of when the NIN3GPP access is allowed or not allowed.

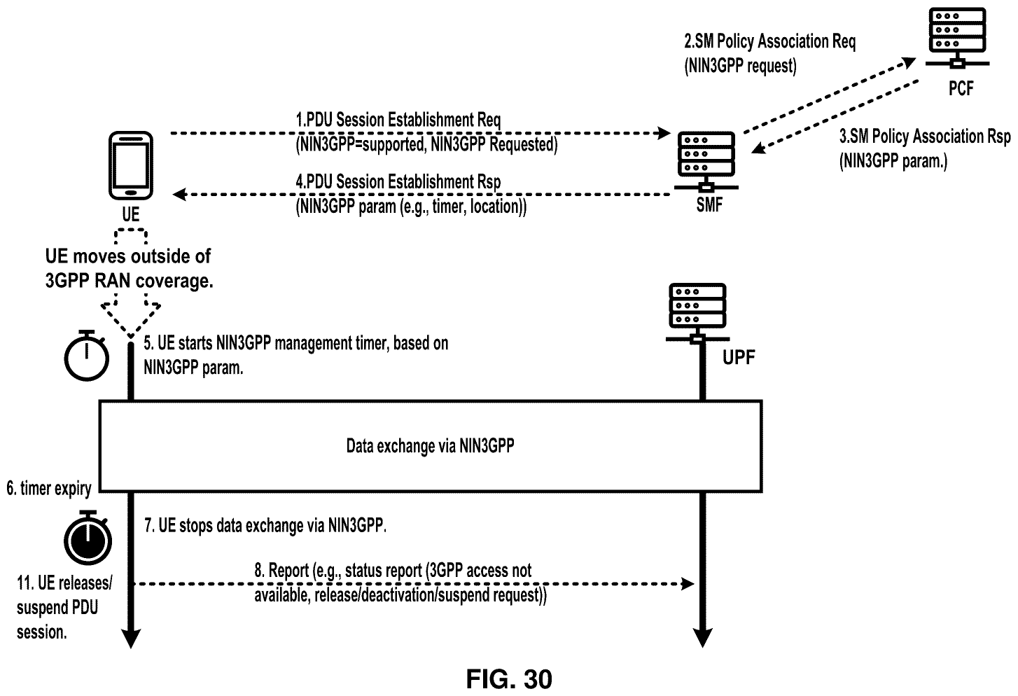

FIG. 30 illustrates an example as per an aspect of an embodiment of the present disclosure. For brevity, based on the other part of the present disclosure, redundant details will be omitted.

In an example, the UE and/or the SMF may establish the PDU session of the first ATSSS type. For example, the PDU session may be established using a resource (e.g., first resource, first TEID, first port number, first IP address, first QUIC resource, first QUIC management IP address, first QUIC local address, and/or the like) of the NIN3GPP access and/or a second resource (e.g., second TEID, second port number, second IP address, second QUIC resource, second QUIC management IP address, second QUIC local address, and/or the like) of the 3GPP access.

In an example, in response to receiving the first message from the UE, the SMF may send to a PCF, a request message (e.g., Npcf_SMPolicyControl_Create request) requesting a SM (session management) policy session. In response to sending the request, the SMF may receive from the PCF, an accept message (e.g.,

Npcf_SMPolicyControl_Create accept) indicating establishment of the SM policy session. The accept message may comprise one or more NIN3GPP parameters (parameters for the NIN3GPP access). The one or more NIN3GPP parameters may comprise one or more conditions for the NIN3GPP access of the PDU session. The one or more NIN3GPP parameters may comprise a time value for NIN3GPP availability time period (or timer). The one or more NIN3GPP parameters may be policy information for the PDU session, a configuration parameter set for the PDU session, and/or the like.

The NIN3GPP availability time period may be associated with controlling validity (allowance, allowed) of the one or more NIN3GPP parameters, the NIN3GPP resource of the PDU session, and/or the like. For example, the UE (or a UPF, a NG-RAN) may send one or more data packets during (while) the NIN3GPP availability time period. For example, the UE (or a UPF, a NG-RAN) may not send one or more data packets during (while) the NIN3GPP availability time period. For example, when the NIN3GPP availability time period ends (expires), the UE may release (discard, clear) the NIN3GPP access, the UE may release the resource of the NIN3GPP access, and/or the UE may suspend the NIN3GPP access.

The one or more conditions may comprise one or more location information. The one or more location information may indicate one or more areas in which the UE may send one or more first data packets for the PDU session via the NIN3GPP access. For example, when the UE is within a location (e.g., cell A, TA B, geo-coordinate C, VPLMN D, and/or the like) of the one or more areas, the UE may send the one or more first data packets via the NIN3GPP access. For example, when the UE is out of the one or more areas, the UE may not send the one or more first data packets via the NIN3GPP access and/or the UE may send the one or more first data packet via the 3GPP access. The NG-RAN and/or the UPF may similar actions based on the location of the UE. Alternatively and/or additionally, the one or more location information may indicate one or more third areas in which the UE may not send one or more first data packets for the PDU session via the NIN3GPP access. Based on the one or more third areas, the UE may determine the one or more areas.

The one or more conditions may comprise one or more time information. The one or more time information may indicate one or more time periods in which the UE may send one or more first data packets for the PDU session via the NIN3GPP access. For example, when the UE is within a time period (e.g., AM 10:00 to AM 11:00, Tuesday, and/or the like) of the one or more time periods, the UE may send the one or more first data packets via the NIN3GPP access. For example, when the UE is out of the one or more time periods, the UE may not send the one or more first data packets via the NIN3GPP access and/or the UE may send the one or more first data packet via the 3GPP access. The NG-RAN and/or the UPF may similar actions. Alternatively and/or additionally, the one or more time periods may indicate one or more third time periods when the UE may not send one or more first data packets for the PDU session via the NIN3GPP access. Based on the one or more third time periods, the UE may determine the one or more time periods.

In response to receiving the accept message from the PCF, the SMF may send a PDU session establishment response (e.g., accept) message 4 to the UE. For example, the PDU session establishment response message 4 may comprise the identifier of the PDU session, the one or more NIN3GPP parameters, one or more QoS rules associated with the one or more NIN3GPP parameters, and/or the like. The NIN3GPP parameters may comprise the one or more conditions, and/or the like. Alternatively, the UE may receive a UE configuration update message comprising the one or more NIN3GPP parameters. A QoS rule of the one or more QoS rules may be associated with at least one condition of the one or more conditions. The QoS rule may indicate a packet data flow. For one or more packets matching the packet data flow (e.g., specific IP address, specific application, etc), the at least one condition may apply. For example, a first packet (of a first QoS rule) may be allowed to be transmitted at a first location via the NIN3GPP access and/or may not be allowed to be transmitted at a second location via the NIN3GPP access. For example, a second packet (of a second QoS rule) may not be allowed to be transmitted at the first location via the NIN3GPP access and/or may be allowed to be transmitted at the second location via the NIN3GPP access.

In an example, the UE may communicate one or more data packets of the PDU session via the 3GPP access and/or the NIN3GPP access associated with the PDU session, if the one or more conditions are met. For example, the UE may use the NIN3GPP resource.

In an example, the UE may move into an area which does not belong to the one or more areas indicated by the one or more conditions. In an example, a current time may be not within one or more time periods indicated by the one or more conditions. In an example, the UE may move out of first coverage of the 3GPP access (e.g., there is no cell is available). In an example, the UE may move out of second coverage of the N3GPP access (e.g., there is no WiFi available).

In response to determining that the UE moves into an area which does not belong to the one or more areas indicated by the one or more conditions, that the current time is not within a time period indicated by the one or more conditions, that the UE moves out of the first coverage of the 3GPP access, that the UE moves out of second coverage of the N3GPP access, and/or the like, the UE may start the NIN3GPP availability time period.

In an example, while the NIN3GPP availability time period is running, after the NIN3GPP availability time periods start, and/or before the NIN3GPP availability time period expires, the UE may send the one or more data packets of the PDU session via the 3GPP access (if available) and/or the NIN3GPP access (if available).

In an example, after the NIN3GPP timer starts, in response to determining that the UE moves into an area which belongs to the one or more areas indicated by the one or more conditions, in response to determining that the current time is within a time period indicated by the one or more conditions, in response to determining that the UE moves into the first coverage of the 3GPP access, and/or in response to determining that the UE moves into second coverage of the N3GPP access, the UE may stop the NIN3GPP availability time period.

In an example, the NIN3GPP availability timer may expire. In response to determining that the NIN3GPP availability timer expires, the UE may release (e.g., discard) the one or more parameters for the NIN3GPP access, may suspend the NIN3GPP access, may release the NIN3GPP access, may not send data packets via the NIN3GPP access, may release the resources for the NIN3GPP access, may suspend data communication via the NIN3GPP access, may suspend the PDU session, may send a report and/or the like.

In an example, the report may indicate that the NIN3GPP access is released, that the NIN3GPP access suspended (e.g., deactivated), that NIN3GPP access is not available, that 3GPP access is not available, that the PDU session is suspended, that the PDU session is deactivated, and/or the like. The UE may send the report via the 3GPP access (if available, e.g., if the NIN3GPP availability timer is started because of NIN3GPP access) or via the N3GPP access (if available e.g., if the NIN3GPP availability timer is started because of NIN3GPP access). The report may be a request. The report may be at least one of a QUIC connection management message, a PDU session modification request message, a PDU session release message, a UL NAS transport message, a PMP (performance measurement protocol) message, a NIN3GPPP (NIN3GPP protocol) message, and/or the like. For example, the NIN3GPP protocol may be a protocol for exchanging message between the UE and the UPF for management of the NIN3GPP access. For example, an entity in the UE for management signalling of the NIN3GPP access may use the NIN3GPP protocol. For example, an entity in the UPF for management signalling of the NIN3GPP access may use the NIN3GPP protocol.

Alternatively and/or additionally, the UE may start a second NIN3GPP availability time period when the UE establishes the NIN3GPP access, when the UE receives from the SMF (or AMF) the value for the second NIN3GPP availability time period, and/or the like. When the UE receives a data packet via the NIN3GPP access and/or when the UE sends a data packet via the NIN3GPP access, the UE may restart the second NIN3GPP availability time period. When the second NIN3GPP availability time period expires, the UE may release (e.g., discard) the one or more parameters for the NIN3GPP access, may release the resources for the NIN3GPP access, may suspend data communication via the NIN3GPP access, may release the NIN3GPP access, may suspend the PDU session, may send the report and/or the like. This may help to resolve resource congestion based on activity, if the resource for the NIN3GPP access is not enough.

In an example, in response to expiry of the NIN3GPP availability time period, for a N3GPP access registration status, the UE may transit from a RM-registered state to a RM-deregistered. For example, in response to expiry of the NIN3GPP availability time period, the UE may consider being not registered via the N3GPP access, being not allowed to use the NIN3GPP access, and/or the like.

In another example, because there is no signalling connection between the SMF (or the AMF) and the UE via the N3, if the UE moves out of the first coverage, the UE and the SMF may not be able to exchange a MM message and/or a SM message. This may cause a charging issue, because the use of the NIN3GPP access is linked to 3GPP access. In an embodiment, the UE may start the NIN3GPP availability timer, when the UE loses (e.g., detect not unavailability of) the first coverage of the 3GPP access, after adding (establishing) the NIN3GPP resources to the PDU session. When the NIN3GPP availability timer expires, the UE may stop using the NIN3GPP access, and/or may release the resource of the NIN3GPP access, and/or may release the PDU session of the NIN3GPP access, and/or the like. When the NIN3GPP availability timer expires, the UE may report unavailability of the 3GPP access to the SMF (or to the UPF) via the NIN3GPP. For example, the UE may send the report.

The example embodiment of FIG. 30 may support controlling when a UE can send a data via the NIN3GPP access and/or when the resource for the NIN3GPP access is valid for the UE and/or for the PDU session.

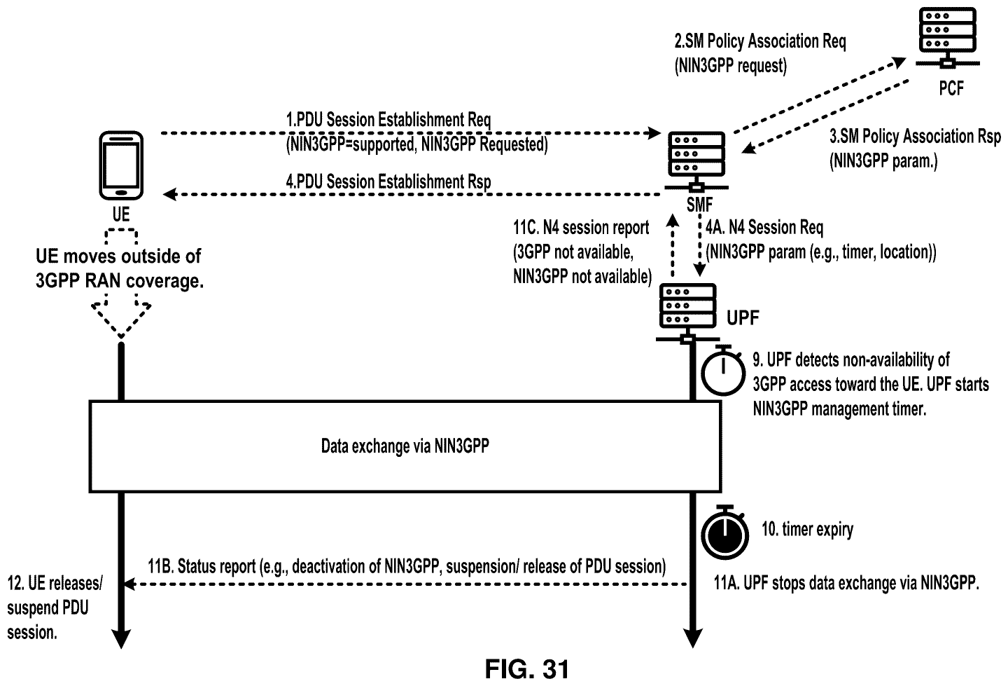

FIG. 31 illustrates an example as per an aspect of an embodiment of the present disclosure. For brevity, based on the other part of the present disclosure, redundant details will be omitted.

In an example, in response to receiving the first message from the UE, the SMF may send to the PCF the request requesting the SM (session management) policy session. In response to sending the request, the SMF may receive from the PCF, the accept message indicating establishment of the SM policy session (e.g., as shown in FIG. 30).

In an example, the SMF may send to the UPF, a N4 session request message. The N4 session request message may be a packet forwarding control protocol (PFCP) message. The PFCP message may be a PFCF session establishment request message and/or a PFCF session modification request message, and/or the like. The N4 session request message may comprise at least one of the one or more NIN3GPP parameters, a request to allocate a resource for the NIN3GPP access, and/or the like. The one or more NIN3GPP parameters may comprise a time value for NIN3GPP availability time period (or timer).

In response to receiving the N4 session request message, the UPF may allocate the resource for the NIN3GPP access and/or the UPF may send a N4 session response message to the SMF. The N4 session response message may comprise information of the resource for the NIN3GPP access.

In an example, the UPF may establish with the UE, a connection (e.g., the NIN3GPP access for the PDU session, a QUIC connection via the NIN3GPP access, and/or the like) via the NIN3GPP access. The UPF may communicate one or more data packets of the PDU session via the 3GPP access and/or the NIN3GPP access associated with the PDU session, with the UE. For example, the UPF may use the NIN3GPP resource allocated for the PDU session, to send one or more data packets to the UE.

In an example, the UPF may determine whether the connection to the UE is available or unavailable. For example, the UPF may determine whether the UE moves into the area which does not belong to the one or more areas indicated by the one or more conditions, the UPF may determine whether the current time is within the time period indicated by the one or more conditions, the UPF may determine whether the UE moves out of the first coverage of the 3GPP access, the UPF may determine whether the UE may move out of the second coverage of the N3GPP access, the UPF may determine whether the 3GPP access toward the UE is available, and/or the UPF may determine whether the NIN3GPP access toward the UE is available or not, and/or the like.

In an example, if the UPF may determine at least one of that the connection to the UE is unavailable, that the UE moves into the area which does not belong to the one or more areas indicated by the one or more conditions, that the current time is not within the time period indicated by the one or more conditions, that the UE moves out of the first coverage of the 3GPP access, that the UE may move out of the second coverage of the N3GPP access, that the 3GPP access toward the UE is not available (e.g., detects that transmission of a data packet via the 3GPP access fails), and/or that the NIN3GPP access is not available or not, the UPF may start the NIN3GPP availability time period, with the value indicated by the one or more NIN3GPP parameters.

In an example, while the NIN3GPP availability time period is running, after the NIN3GPP availability time period starts, and/or before the NIN3GPP availability time period expires, the UPF may determine at least one of that the connection to the UE is available, that the UE moves into the one or more areas indicated by the one or more conditions, that the current time is within the time period indicated by the one or more conditions, that the UE moves into the first coverage of the 3GPP access, that the UE may move into the second coverage of the N3GPP access, that the 3GPP access toward the UE is available, and/or that the NIN3GPP access is available, the UPF may stop the NIN3GPP availability time period.

In an example, the NIN3GPP availability time period may expire. In response to expiry of the NIN3GPP availability time period, the UE may send the one or more data packets of the PDU session via the 3GPP access (if available) and/or the UE may not send the one or more data packets via the NIN3GPP access. In response to determining that the NIN3GPP availability timer expires, the UPF may release (e.g., discard) the one or more parameters for the NIN3GPP access, may suspend the NIN3GPP access, may release the NIN3GPP access, may not send any data via the NIN3GPP access, may release the resources for the NIN3GPP access, may suspend data communication via the NIN3GPP access, may suspend the PDU session, may send a report. The UPF may send the report to the SMF and/or the UE.

In an example, the report may indicate that the NIN3GPP access is released, that the NIN3GPP access suspended (e.g., deactivated), that NIN3GPP access is not available, that 3GPP access is not available, that the PDU is suspended, that the PDU is deactivated, and/or the like, via the 3GPP access. The report may be at least one of a N4 session report message, the PMF message, the NIN3GPP protocol message, and/or the like.

Alternatively and/or additionally, the UPF may start a second NIN3GPP availability time period when the UPF establishes the NIN3GPP access with the UE for the PDU session, when the UPF receives from the SMF the value for the second NIN3GPP availability time period, and/or the like. When the UPF receives a data packet via the NIN3GPP access and/or when the UPF sends a data packet via the NIN3GPP access, the UPF may restart the second NIN3GPP availability time period. When the second NIN3GPP availability time period expires, the UPF may release (e.g., discard) the one or more parameters for the NIN3GPP access, may release the resources for the NIN3GPP access, may suspend data communication via the NIN3GPP access, may release the NIN3GPP access, may suspend the PDU session, may send the report to the UE, may send a N4 session report message (or to the SMF) and/or the like. The N4 session report message may deliver similar information as the report (as shown in FIG. 30).

In an example, the UE may receive the report from the UPF (or via SMF). For a N3GPP access registration status, the UE may transit from a RM-registered state to a RM-deregistered. For example, in response to receiving the report, the UE may consider being not registered via the N3GPP access.

The example embodiment of FIG. 31 may help the UPF to efficiently manage resource for the NIN3GPP access.

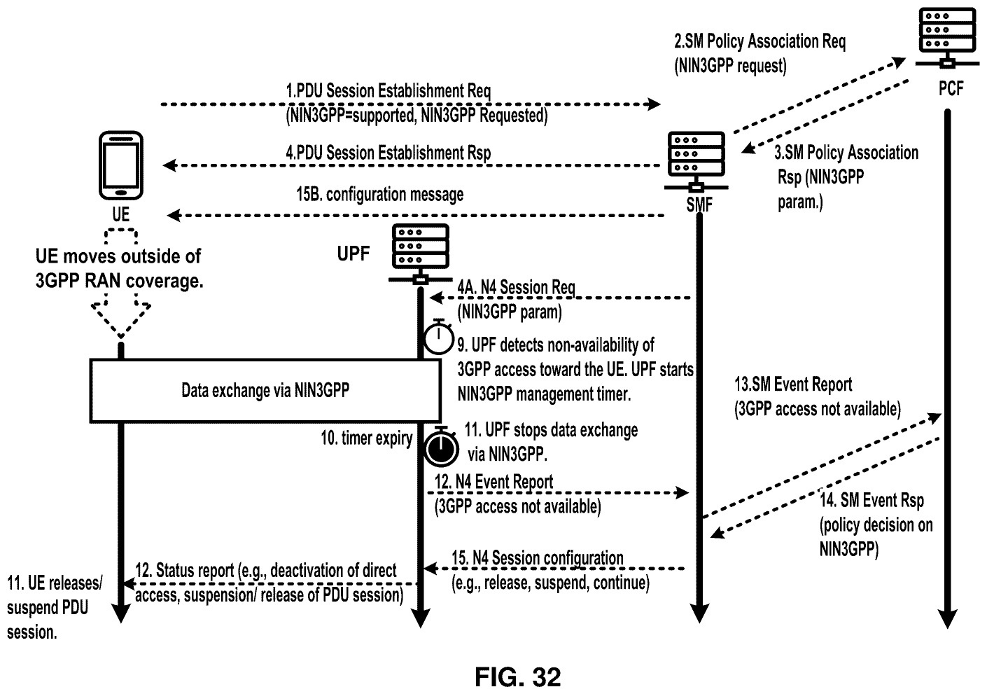

FIG. 32 illustrates an example as per an aspect of an embodiment of the present disclosure. For brevity, based on the other part of the present disclosure, redundant details will be omitted.

In an example, the SMF may receive from the UPF, the N4 session report message (e.g., as shown in FIG. 31, 30). For example, the N4 session report may indicate at least one of that the 3GPP access of the PDU session is not available and/or that the NIN3GPP access of the PDU session is not available.

In an example, in response to receiving the N4 session report message from the UPF, the SMF may send to the PCF an event notification message. The event notification message may be at least one of Npcf_SMPolicyControl_Update Notify message, Npcf_SMPolicyControl_Update message, Nsmf_EventExposure notify message, Npcf_SMPolicyControl_Delete and/or the like.

The event notification message may indicate at least one of that a policy control request trigger condition is met, that the 3GPP access of the PDU session of the first ATSSS type is not available, that the NIN3GPP access of the PDU session of the first ATSSS type is not available, that a current location of the UE is not within the one or more locations, that a current time is not within the one or more time periods, that NIN3GPP access is deactivated/released, that the PDU session is suspended, and/or the like. That the policy control request trigger condition is met may be that at least one of one or more conditions of the policy control request trigger is met. The one or more conditions may be at least one of that the 3GPP access of the PDU session of the first ATSSS type is not available, that the NIN3GPP access of the PDU session of the first ATSSS type is not available, that the 3GPP access of the PDU session of the first ATSSS type is released, that the NIN3GPP access of the PDU session of the first ATSSS type is released, that the PDU session of the first ATSSS type is released, and/or the like. The accept message indicating establishment of the SM policy session may comprise the policy control request trigger.

In response to sending the event notification message, the SMF may receive an event notification response message. The event notification message may be at least one of Npcf_SMPolicyControl_Update Notify response message, Npcf_SMPolicyControl_Update response message, Nsmf_EventExposure notify response message, Npcf_SMPolicyControl_Delete response message, and/or the like. The event notification response message may comprise at least one of a one or more updated conditions for the NIN3GPP access of the PDU session, one or more updated NIN3GPP parameters, an updated policy information of the PDU session, an indication of release of the NIN3GPP access of the PDU session, an indication of release of the 3GPP access of the PDU session, an indication of release of the PDU session, indication of suspend (resume) of the PDU session (or the NIN3GPP access) and/or the like.

In response to receiving the event notification response message, the SMF may send a configuration message to the UE and/or to the UPF. The configuration message may be a N4 session configuration (or modification) message to the UPF and/or a DL NAS message to the UE. The DL NAS message may be at least one of a DL NAS transport message, a PDU session modification command message, a PDU session deactivation message, a PDU session release message, a UE configuration update message, and/or the like. The configuration message may comprise at least one of the one or more updated conditions for the NIN3GPP access of the PDU session, the one or more updated NIN3GPP parameters, the updated policy information of the PDU session, the indication of release of the NIN3GPP access of the PDU session, the indication of release of the 3GPP access of the PDU session, the indication of release of the PDU session, the indication of suspend (resume) of the PDU session (or the NIN3GPP access) and/or the like.

In response to receiving the configuration message, the UPF may release the NIN3GPP access, release the 3GPP access, suspend the NIN3GPP access, suspend (e.g., deactivate) the 3GPP access, suspend (e.g., deactivate) the PDU session, release the PDU session, send a status report message to the UE, and/or the like. For example, the status report message may indicate at least one of the one or more updated conditions for the NIN3GPP access of the PDU session, the one or more updated NIN3GPP parameters, the updated policy information of the PDU session, the indication of release of the NIN3GPP access of the PDU session, the indication of release of the 3GPP access of the PDU session, the indication of release of the PDU session, the indication of suspension of the 3GPP access of the PDU session, the indication of suspension of the NIN3GPP access of the PDU session, the the indication of suspend (resume) of the PDU session (or the NIN3GPP access) and/or the like.

In an example, the UE may receive the configuration message from the SMF and/or may receive the status report message from the UPF. The UE may release the NIN3GPP access of the PDU session, release the 3GPP access of the PDU session, release of the PDU session, suspend the 3GPP access of the PDU session, suspend the NIN3GPP access of the PDU session, suspend (resume) of the PDU session (or the NIN3GPP access) and/or the like.

The example embodiment of FIG. 32 may help a PCF to accurately control QoS of a PDU session based on timely reporting from the UPF.

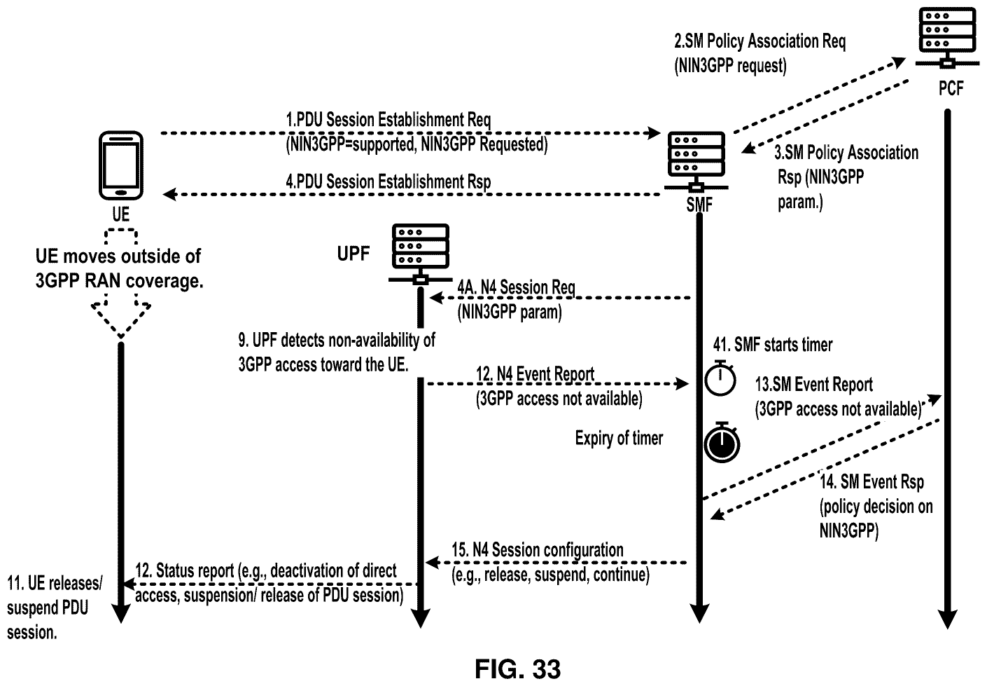

FIG. 33 illustrates an example as per an aspect of an embodiment of the present disclosure. For brevity, based on the other part of the present disclosure, redundant details will be omitted.

In an example, the UPF may determine at least one of that the NIN3GPP access is not available and/or that the 3GPP access is not available, and/or the like. (e.g., as shown in FIG. 31).

In an example, upon (in response to, after, based on, and/or the like) detecting that the NIN3GPP access and/or the 3GPP access is not available, the UPF may send the report (e.g., the N4 session report message) to the SMF and/or the UPF may not start the NIN3GPP availability time period. The report may indicate at least one of that the NIN3GPP access is not available and/or that the 3GPP access is not available, and/or the like.

Additionally and/or alternatively, upon (in response to, after, based on, and/or the like) detecting that the NIN3GPP access and/or the 3GPP access is available, the UPF may send the report to the SMF. The report may indicate at least one of that the NIN3GPP access is available and/or that the 3GPP access is available, and/or the like.

In an example, the SMF may receive the report from the UPF.

In an example, in response to the report indicating that at least one of the NIN3GPP access and/or the 3GPP access is not available, the SMF may start the NIN3GPP availability time period. In an example, in response to the report indicating that at least one of the NIN3GPP access and/or the 3GPP access is available, the SMF may stop the NIN3GPP availability time period.

In an example, the NIN3GPP availability timer may expire. In response to expiry of the NIN3GPP availability time period, the SMF may send the event notification message (as shown in FIG. 32).

The example embodiment of FIG. 33 may help a core network to accurately manage a usage status of a network slice, based on whether a N3GPP access without a N3IWF is used for a UE and/or for a PDU session.

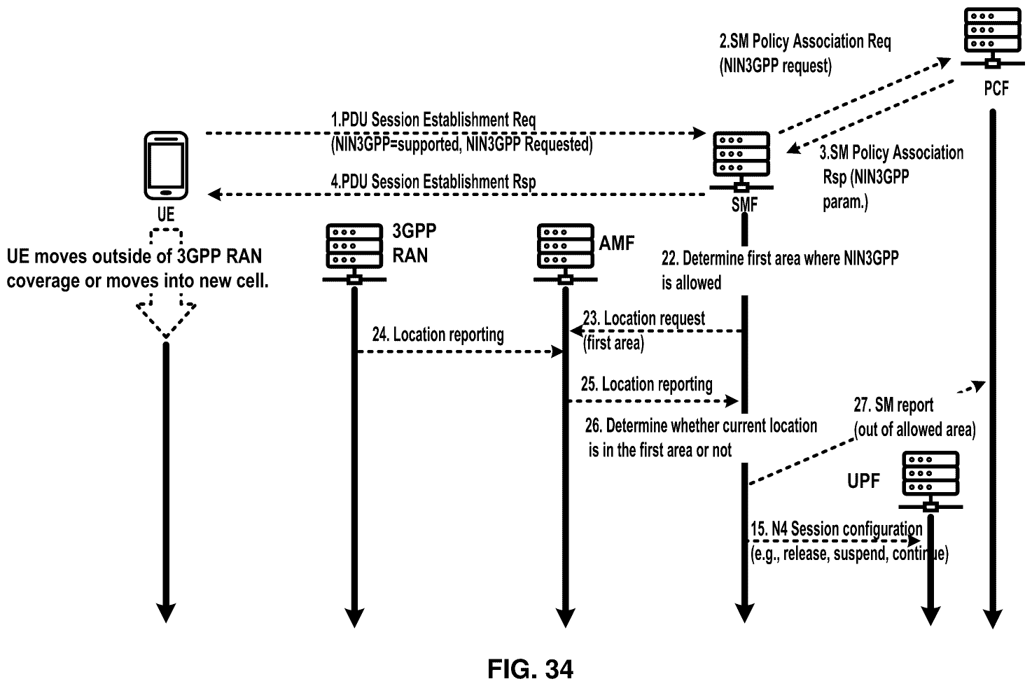

FIG. 34 illustrates an example as per an aspect of an embodiment of the present disclosure. For brevity, based on the other part of the present disclosure, redundant details will be omitted.

In an example, the SMF may receive from the PCF, the accept message indicating establishment of the SM policy session (e.g., as shown in FIG. 30).

In an example, because the accept message comprise the one or more conditions, the SMF may determine to monitor a current location of the UE. For example, the SMF may send to an AMF, a UE mobility event notification request message (e.g., UE location reporting request message, an event subscription request message for a UE location). For example, the UE mobility event notification request message may comprise at least one of the one or more locations. The one or more locations may be an area of interest (AOI) for the NIN3GPP access.

In response to receiving the UE mobility event notification request message, the AMF may request a 3GPP RAN to report a location of the UE, to the AMF.

In an example, the UE may move from a first cell (or, TA, RAN) to a second cell. The 3GPP RAN may monitor whether location of the UE changes and/or may determine to report the location of the UE to the AMF. The AMF may determine whether the location of the UE is within the at least one of the one or more locations. The AMF may send a UE mobility report (e.g., UE location report, event notification, notification of in/out area of interest) message to the SMF. The UE mobility report message may indicate whether the current location of the UE is within the at least one of the one or more locations (e.g., area of interest) or not.

In an example, if the current location of the UE is not within the at least one of the one or more locations, the SMF may determine to release the PDU session, to release the NIN3GPP access of the PDU session, to send the event notification message to the PCF, to send to the UPF a request to release the NIN3GPP access of the PDU session, and/or the like.

In an example, if the current location of the UE is within the at least one of the one or more locations, the SMF may determine to keep (or establish) the PDU session, to keep (or establish) the NIN3GPP access of the PDU session, to send the event notification message to the PCF that the UE is in the one or more location, and/or the like.

In an example, based on whether the UE is within the one or more locations, based on the location reporting from the AMF, the SMF may manage the NIN3GPP availability timer (as shown in FIG. 33).

The example embodiment of FIG. 34 may help the SMF to determine whether the UE is located in an area where the use of NIN3GPP access is allowed.

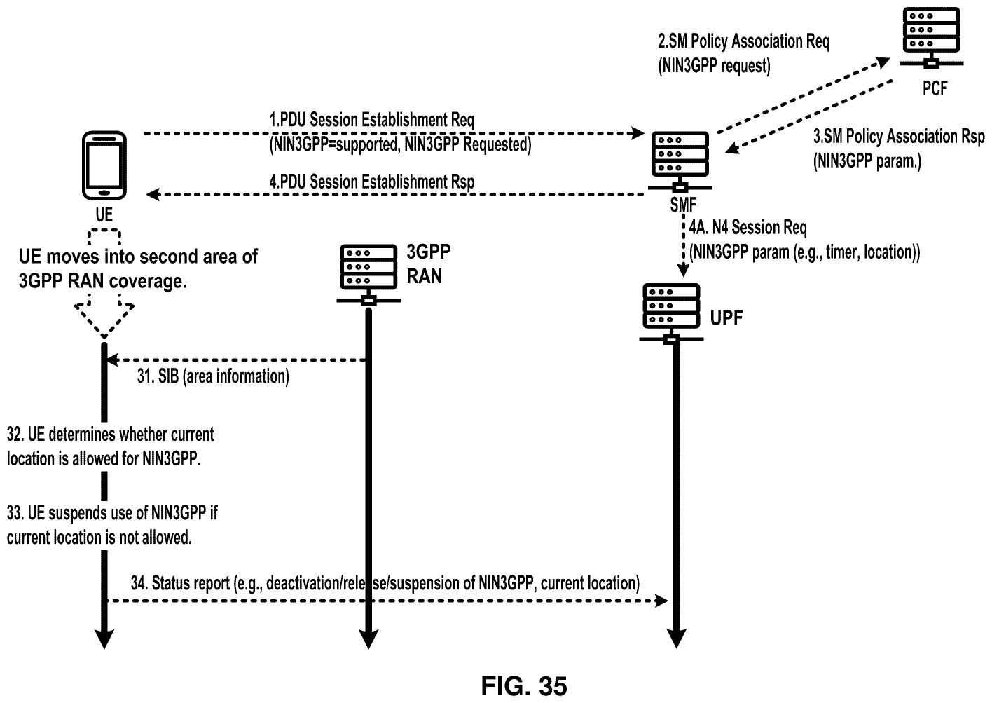

FIG. 35 illustrates an example as per an aspect of an embodiment of the present disclosure. For brevity, based on the other part of the present disclosure, redundant details will be omitted.

In an example, the UE may receive from the SMF (or an AMF), the PDU session establishment response message 4 comprising the one or more NIN3GPP parameters (e.g., as shown in FIG. 30).

In an example, the UE may determine current location of the UE. For example, based on SIB received from a current cell of the UE, the UE may determine the current location (e.g., a cell, a tracking area, a network) and/or the like.

In an example, the UE may determine whether the current location is within the one or more first locations for which use of the NIN3GPP access is allowed. For example, if the current location is indicated by the one or more first locations, the UE may resume using the NIN3GPP access of the PDU session and/or the UE may continue using the NIN3GPP access, and/or the like.

In an example, the UE may determine whether the current location is within one or more second locations for which use of the NIN3GPP access is not allowed. For example, if the current location is indicated by the one or more second locations, the UE may stop using the NIN3GPP access of the PDU session, the UE may suspend using the NIN3GPP access, the UE may release the PDU session, the UE may release the NIN3GPP access, and/or the like. In response to suspending (releasing) the NIN3GPP access, the UE may send a status report (the report) to UPF (or to AMF, SMF).

The status report may indicate at least one of that the NIN3GPP access is suspended, that the PDU session is suspended, that the NIN3GPP access is suspended, that the NIN3GPP access is released, the current location of the UE, and/or the like.

The example embodiment of FIG. 35 may help the UE to determine in timely manner whether the UE can use the NIN3GPP access or not.

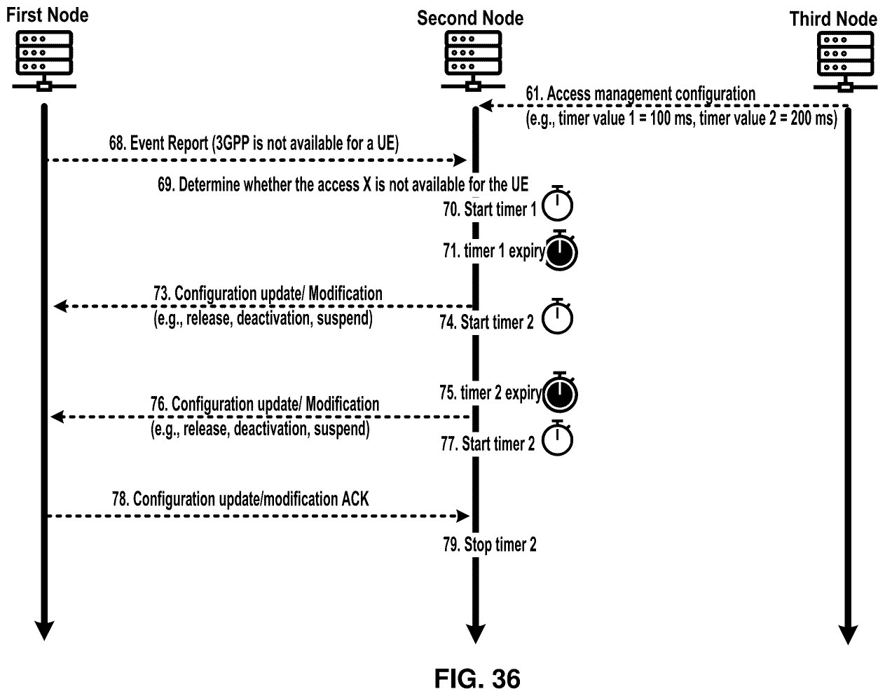

FIG. 36 illustrates an example as per an aspect of an embodiment of the present disclosure. For brevity, based on the other part of the present disclosure, redundant details will be omitted.

In an example, a third node (e.g., a PCF, a SMF) may send an access management configuration to a second node (e.g., SMF, UPF, UE, AMF, NG-RAN). The access management configuration may be a policy information for NIN3GPP access. The policy informatization for NIN3GPP access may be one or more parameters for NIN3GPP access (e.g., a PDU session of the first PDU session type, a MA PDU session of the first MA PDU session type, a PDU session of the first ATSSS type, a PDU session comprising a Non3GPP access without N3IWF, and/or the like).

In an example, the policy information may comprise one or more values for one or more time periods. The one or more values may comprise a first value for a first time period and/or a second value for a second time period. For example, the first time period may be associated in determining whether an access (e.g., 3GPP access and/or NIN3GPP access) is available or not. For example, the second time period may be associated with controlling when a message (e.g., NAS message, the first message) associated with the NIN3GPP access needs to (or can) be re-transmitted or not.

In an example, the second node may determine whether the first time period needs to be started. For example, when the second node receives from a first node (e.g., a UE, a UPF, a SMF, a NG-RAN), an indication indicating that the access (e.g., the 3GPP access and/or the NIN3GPP access) is not available, the second node may start the first time period. The second node may receive the indication via the 3GPP access and/or the NIN3GPP access. For example, when the second node receives from the first node, an indication indicating that the access (e.g., the 3GPP access and/or the NIN3GPP access) is available, the second node may stop the first time period. For example, the second node may receive the indication via the 3GPP access and/or the NIN3GPP access.

In an example, the first time period may expire. In response to expiry of the first time period, the second node may send a modification message (e.g., the report, the status report, the configuration message) to the first node. For example, the modification message may be delivered via the 3GPP access and/or the NIN3GPP access. For example, the modification message may be delivered via a user plane.

In an example, the modification message may indicate at least one of that the PDU session is released, the NIN3GPP access of the PDU session is released, that the PDU session is suspended, that the NIN3GPP access of the PDU session is suspended, that the NIN3GPP access of the PDU session is released, and/or the like. For example, when the NIN3GPP access of the PDU session is suspended, the first node and/or the second node does not send/receive a data packet via the NIN3GPP access.

In an example, the second node may start the second time period, in response to sending the modification message. In an example, the second node may receive an acknowledgement from the first node. In response to receiving the acknowledgement, the second node may stop the second time period. In an example, the second time period may expire. In response to expiry of the second time period, the second node may re-transmit the modification message.

The example embodiment of FIG. 36 may help for the second node to quickly send a command to the first node, while checking reception of the command, using additional time period. The example embodiment may help the first node and the second node to reliably exchange messages.

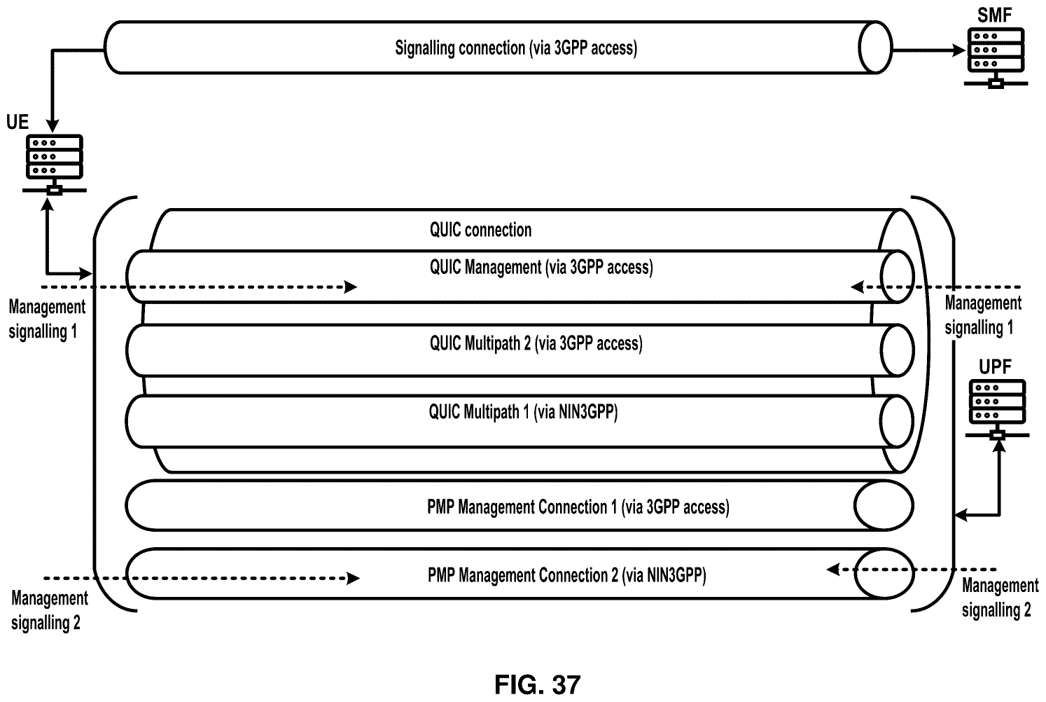

FIG. 37 illustrates an example as per an aspect of an embodiment of the present disclosure. For brevity, based on the other part of the present disclosure, redundant details will be omitted.

In an example, a UE and a UPF may establish a PDU session of the first ATSSS type. The PDU session may comprise a first resource of a 3GPP access and/or a second resource of a NIN3GPP access. The UE and the UPF may establish one or more QUIC connections and/or one or more PMP management connections. The one or more QUIC connections may transport one or more QUIC datagrams, one or more QUIC frames, one or more control message controlling the one or more QUIC connections, and/or the like. The one or more PMP (performance management protocol, or NIN3GPP management protocol, a user plane protocol conveying configuration information of the NIN3GPP access, and/or the like) management connections may transport a report associated with the NIN3GPP access (e.g., report of availability of the NIN3GPP access and/or the 3GPP access) and/or a configuration associated with the NIN3GPP access (e.g., suspend, resume of NIN3GPP access and/or the PDU session) and/or the like.

In an example, a QUIC connection of the one or more QUIC connections may comprise one or more first QUIC bearers (links, connection, sub-flow, and/or the like). For example, The QUIC connection may be associated with a first connection for delivery of a message for QUIC management over the 3GPP access and/or for MPQUIC functionality. The QUIC connection may be associated with second connection (e.g., first path) for QUIC multipath over the NIN3GPP access. The QUIC connection may be associated with a third connection (e.g., second path) for QUIC multipath over the 3GPP access, and/or the like. For example, the QUIC connection may not be associated with a fourth connection for delivery of a message for QUIC management over the N3GPP access. The message for QUIC management of the QUIC connection may transport one or more messages for the QUIC connection. The QUIC connection may use resources of the NIN3GPP and/or resources of the 3GPP. For the second connection, a second MPQUIC Proxy address information (IP address and port number) for N3GPP access may be associated. For the third connection, a third MPQUIC Proxy address information (IP address and port number) for 3GPP access may be associated. A first MPQUIC link-specific multipath addresses/prefixes may be associated for the first connection and/or for the third connection. A second MPQUIC link-specific multipath addresses/prefixes may not be associated for the second connection and/or for N3GPP access.

In an example, a PMP management connection of the one or more PMP management connections may comprise a first PMP management connection via the 3GPP access and/or a second PMP management connection via the N3GPP access. The UE and/or the UPF may comprise an entity handling the PMP management connection. For example, the UE and/or the UPF may exchange one or more status reports via the PMP management connection. The PMP management connection may use resources of the NIN3GPP and/or resources of the 3GPP.

In an example, the UE and the SMF may establish a signalling connection via the 3GPP access and/or via the AMF. The signalling connection may be used to exchange the one or more NIN3GPP parameters of the PDU session and/or the like. For example, the UE and the SMF may not exchange the one or more NIN3GPP parameters via the N3GPP. The signalling management connection may not use resources of the NIN3GPP and/or may use resources of the 3GPP.

The following provides some example aspects of the present disclosure:

Aspect 1: A method comprising: sending, by a wireless device to an access and mobility management function (AMF), a first non-access stratum (NAS) message requesting establishment of a protocol data unit (PDU) session of a multi-access (MA) PDU session type; receiving, by the wireless device from the AMF, a second NAS message indicating establishment of the PDU session, wherein the second NAS message indicates: a rejection of the MA-PDU session type; and a time value indicating a period associated with the rejection; sending, by the wireless device after expiration of the period starting from the receiving the second NAS message, a request to modify the PDU session to the MA-PDU session type.

Aspect 2: A method comprising: receiving, by the wireless device, a second non-access stratum (NAS) messages indicating: an establishment of a protocol data unit (PDU) session; and a rejection of the multi-access (MA)-PDU session type for the PDU session.

Aspect 3: The method of aspect 2, further comprising sending by the wireless device to an access and mobility management function (AMF), a first non-access stratum (NAS) message requesting establishment of the PDU session, indicating the MA PDU session type.

Aspect 4: The method of aspect 2, wherein the second NAS message further comprises a timer value indicating a period associated with the MA PDU session type.

Aspect 5: The method of aspect 4, further comprising starting by the wireless device, a timer with the timer value.

Aspect 6: The method of aspect 2, wherein the wireless device is registered via a first access and is not registered via a second access.

Aspect 7: The method of aspect 3 to 6, wherein the wireless device sends the first NAS message via the first access.

Aspect 8: The method of aspect 4, further comprising not sending by the wireless, a third NAS message requesting the MA PDU session type for the PDU session, while the timer is running.

Aspect 9: The method of aspect 4, further comprising sending by the wireless, the third NAS message requesting modification of the PDU session to the MA PDU session type, after expiry of the timer.

Aspect 10: The method of aspect 2, wherein the MA PDU session type of a plurality of the MA PDU session types does not use a N3IWF.

Aspect 11: The method of aspect 2, wherein in the PDU session is established with a single PDU session type.

Aspect 12: The method of aspect 10, wherein a second MA PDU session type of the plurality of the MA PDU session type uses the N3IWF.

Aspect 13: The method of aspect 2, wherein the second NAS message comprises an attempt indication of whether the wireless device can request the MA PDU session type for the PDU session.

Aspect 14: The method of aspect 13, wherein the wireless device sends the third NAS message, if the attempt indicator indicates that the wireless device can request the MA PDU session type for the PDU session.

Aspect 15: The method of aspect 2, wherein the wireless device receives the second NAS message, via a 3GPP access.

Aspect 16: The method of aspect 2, wherein a code point of a cause field of the second NAS message may indicate the rejection.

Aspect 17: The method of aspect 2, wherein the second NAS message is an accept message indicating PDU session establishment being accepted.

Aspect 18: The method of aspect 2, wherein the wireless device sends a fourth NAS message requesting modification of the PDU session if a code point of a cause field of the second NAS message may indicate the rejection.

Aspect 19: The method of aspect 2, wherein the rejection indicates the PDU session being established over the 3GPP access and not being established over the N3GPP access.

Aspect 20: The method of aspect 4, wherein the wireless device stops the timer, if the wireless device receives a fifth NAS message comprising one or more configuration parameters for the MA PDU session type.

Aspect 21: The method of aspect 20, wherein the one or more configuration parameters comprises an information of the N3GPP access of the PDU session.

Aspect 22: The method of aspect 4, wherein the wireless device sends a sixth NAS message not comprising a parameter associated with the MA PDU session type, based on the timer running.

Aspect 23: The method of aspect 4, wherein the wireless device does not send a seventh NAS message comprising a parameter associated with the MA PDU session type, based on the timer running.

Aspect 24: A method comprising: sending, by a wireless device to an access and mobility management function (AMF) via a 3rd generation partnership project (3GPP) access, a first non-access stratum (NAS) message requesting establishment of a protocol data unit (PDU) session of a first access traffic steering, switching, and splitting (ATSSS) type of a plurality ATSSS type; receiving, by the wireless device from the AMF, a second NAS message indicating the PDU session is established via the 3GPP access, wherein the second NAS message indicates: a rejection of the first ATSSS type; and a time value indicating a period associated with the first ATSSS type; sending, by the wireless device after expiration of the period starting from the receiving the second NAS message, a request to modify the PDU session to the first ATSSS type.

Aspect 25: A method comprising: receiving, by a wireless device from an access and mobility management function (AMF) via a 3GPP access, a second non-access stratum (NAS) message indicating an access traffic steering, switching, and splitting (ATSSS) type, of a plurality of ATSSS types, not being applied to a protocol data unit (PDU) session, wherein the ATSSS type is not associated with N3IWF; determining, by the wireless device, whether a signalling timer associated with the PDU session is running; and sending, by the wireless device to the AMF and based on the determining, a third non-access stratum (NAS) messages requesting the ATSSS type for the PDU session.

Aspect 26: A method comprising: receiving, by a wireless device from an access and mobility management function (AMF) via a 3GPP access, a second non-access stratum (NAS) message indicating the N3GPP access being rejected, wherein the N3GPP access is not associated with N3IWF.

Aspect 27: The method of aspect 26, wherein the second NAS message comprises a value for a time period associated with the N3GPP access.

Aspect 28: A method comprising: sending, by a session management function (SMF) to a wireless device, a message indicating a rejection of a protocol data unit (PDU) session, comprising a N3GPP access not associated with a N3IWF.

Aspect 29: The method of aspect 28, further comprising receiving by the SMF and from a user data management, a notification indicating subscription for the N3GPP access being removed.

Aspect 30: The method of aspect 29, further comprising sending by the SMF to the wireless device, a NAS message indicating removal of the N3GPP access from the PDU session.

Aspect 31: A method comprising: receiving, by a session management function (SMF) from a policy control function, a network slice access control message indicating maximum number of protocol data unit (PDU) sessions for a network slice is reached for a N3GPP access not associated with a N3IWF.

Aspect 32: A method comprising: receiving, by a session management function (SMF) from a policy control function, a network slice access control message indicating: a first maximum number of protocol data unit (PDU) sessions for a network slice is reached for a N3GPP access not associated with a N3IWF. a second maximum number of PDU sessions for the network slice is not reached for a 3GPP access.

Aspect 33: A method comprising: receiving, by a session management function (SMF) from a user plane function, a N4 session establishment response message indicating: a first resource of a N3GPP access of a protocol data unit (PDU) sessions not being available, wherein the N3GPP access is not associated with a N3IWF; and a second resource of a 3GPP access of the PDU session being available.

Aspect 34: A method comprising: receiving, by a wireless device from an access and mobility management function (AMF) via a 3GPP access, a second non-access stratum (NAS) message indicating an access traffic steering, switching, and splitting (ATSSS) type, of a plurality of ATSSS types, being applied to a protocol data unit (PDU) session, wherein the ATSSS type is not associated with N3IWF; receiving, by the wireless device from the AMF, a deregistration request message; and releasing, by the wireless device a resource associated with N3GPP access of the PDU session, based on the deregistration request message and the ATSSS type.

Aspect 35: The method of aspect 25, wherein the deregistration request message further comprises a timer value.

Aspect 36: The method of aspect 26, wherein the wireless devices does not send a request of PDU session of the ATSSS type, until the timer expires.

Aspect 37: A method comprising: receiving, by a wireless device from an access and mobility management function (AMF) via a 3GPP access, a second non-access stratum (NAS) message indicating an access traffic steering, switching, and splitting (ATSSS) type, of a plurality of ATSSS types, being applied to a protocol data unit (PDU) session, wherein the ATSSS type is not associated with N3IWF; receiving, by the wireless device from the AMF, a deregistration request message; and releasing, by the wireless device a resource associated with N3GPP access of the PDU session, based on the deregistration request message and the ATSSS type.

Aspect 38: A method comprising: sending, by a wireless device to a mobility management entity (MME), a first request message for a PDN connection; sending, by the wireless device to an access and mobility management function (AMF), a second request for a PDU session associated with PDN connection; and sending, by the wireless device to the AMF, a third request for the PDU session, comprising an indication indicating upgrade the PDU session for an ATSSS type not being associated with an N3IWF is allowed.

Aspect 39: A method comprising: sending, by the wireless device to an access and mobility management function (AMF), a uplink non-access stratum (NAS) message requesting establishment of a protocol data unit (PDU) session for a single network slice selection assistance information (S-NSSAI), comprising: an indication indicating upgrade of the PDU session for an ATSSS type not being associated with an N3IWF is allowed.

Aspect 40: A method comprising: receiving, by a wireless device from a session function (SMF), an establishment message of a protocol data unit (PDU) session, wherein: the PDU session comprises a N3GPP access not associated with N3IWF; and the establishment message comprises one or more conditions for the N3GPP access.

Aspect 41: The method of aspect 40, wherein the one or more conditions may indicate one or more locations, where the N3GPP access is allowed.

Aspect 42: The method of aspect 40, wherein the one or more conditions may indicate one or more time periods, where the N3GPP access is allowed.

Aspect 43: The method of aspect 40, further comprising: determining, by the wireless device, whether the one or more conditions are met; and sending, by the wireless device, a data packet of the PDU session, via the N3GPP access.

Aspect 44: The method of aspect 40, further comprising: sending, by the wireless device via the N3GPP access, a first status report indicating the 3GPP access is not available.

Aspect 45: The method of aspect 40, further comprising: sending, by the wireless device, a second status report indicating the N3GPP access is suspended.

Aspect 46: A method comprising: receiving, by a session function (SMF) from a wireless device and via a 3GPP access, an establishment message of a protocol data unit (PDU) session, comprising an indication indicating that the wireless supports a first multi-access (MA) PDU session type of a plurality of MA PDU session types; and receiving, by the SMF from a policy control function (PCF), a PDU session policy information, for the PDU session of the first MA PDU session type; and sending, by the SMF to the wireless device and based on the PDU session policy information, before the wireless device being registered for the N3GPP access, a PDU session establishment accept message comprising a resource information of the N3GPP access.

Aspect 47: A method comprising: sending, by a wireless device to a session function (SMF) and via a 3GPP access, an establishment message of a protocol data unit (PDU) session, comprising an indication indicating that the wireless supports a first multi-access (MA) PDU session type of a plurality of MA PDU session types; and receiving, by the wireless device from the SMF and via the 3GPP access, before the wireless device being registered for the N3GPP access, a PDU session establishment accept message comprising: a resource information of the N3GPP access for the MA PDU session type; and one or more policy parameters managing the N3GPP access.

Aspect 48: A method comprising: receiving, by a user plane function from a session function (SMF), an establishment request message of a protocol data unit (PDU) session, wherein: the PDU session comprises a N3GPP access not associated with N3IWF; and a time value for a time period.

Aspect 49: The method of aspect 46, the UPF starts the time period when at least one of the N3GPP access or a 3GPP access of the PDU session is not available.

Aspect 50: The method of aspect 46, the UPF sends a status report message to at least one of the SMF or a wireless device of the PDU session.

Aspect 51: The method of aspect 46, wherein the status report indicates at least one of that the PDU session is suspended or that the PDU session is released.

Aspect 52: A method comprising: receiving, by a wireless device from a session function (SMF), an establishment message of a protocol data unit (PDU) session, wherein: the PDU session comprises a N3GPP access not associated with N3IWF; and the establishment message comprises one or more conditions for the N3GPP access.

Aspect 53: The method of aspect 40, wherein the one or more conditions may indicate one or more locations, where the N3GPP access is allowed.

Aspect 54: The method of aspect 40, further comprising: determining, by the wireless device, whether the one or more conditions are met; and sending, by the wireless device, a data packet of the PDU session, via the N3GPP access.

Aspect 55: A method comprising: sending, by a wireless device from a session function (SMF) to a policy control function, a policy control report trigger message indicating that a N3GPP access is not available for a PDU session, wherein the PDU session comprises the N3GPP access, wherein the N3GPP access is not associated with N3IWF.

Aspect 56: A method comprising: receiving by a second node from a third node, a message comprising: a first value for a first time period for a PDU session, wherein the PDU session comprises a N3GPP access not comprising a N3IWF; and a second value for a second time period for the PDU session; starting, by the second node, the first time period, based on an access of the PDU session is not available.

Aspect 57: The method of aspect 56, further comprising sending by the second node to a first node, a configuration message indicating deactivation of the N3GPP access, based on expiry of the first time period.

Aspect 58: The method of aspect 57, further starting by the second node, the second time period, based on sending the configuration message.

Aspect 59: The method comprising: sending, by a session management function (SMF) to a wireless device and via a 3GPP access, an establishment accept message of a protocol data unit (PDU) session, wherein the PDU session comprises a N3GPP access not comprising a N3IWF; determining, by the SMF, whether to release at least one of the N3GPP access and the PDU session; sending, by the SMF to the wireless device and via the 3GPP access, a release request of the PDU session, wherein the release request indicates: the PDU session, in response to determining to release the PDU session; and the N3GPP access, in response to determining to release the N3GPP access.

Aspect 60: The method comprising: sending, by a wireless device from a session management function (SMF) and via a 3GPP access, an establishment request message of a protocol data unit (PDU) session, wherein the PDU session comprises a N3GPP access not comprising a N3IWF; receiving, by the wireless device from the SMF and via the 3GPP access, a release request of the PDU session; and releasing, by the wireless device: the PDU session, in response to release request message indicating the PDU session; and the N3GPP access, in response to the release request message indicating the N3GPP access.

Aspect 61: The method comprising: receiving, by a wireless device from a session management function (SMF) and via the 3GPP access, a release request of a protocol data unit (PDU) session, wherein the PDU session comprises a N3GPP access not associated with a N3IWF; and releasing, by the wireless device, the N3GPP access from the PDU session.

Aspect 62: The method comprising: receiving, by a wireless device from a session management function (SMF) and via the 3GPP access, a release request of a protocol data unit (PDU) session comprising a N3GPP access not associated with a N3IWF, indicating release of the N3GPP access; and releasing, by the wireless device, the N3GPP access from the PDU session.

What is claimed is:

1. A method comprising:
receiving, by a wireless device, a second non-access stratum (NAS) messages indicating:
an establishment of a protocol data unit (PDU) session; and
a rejection of a multi-access (MA)-PDU session type for the PDU session.

2. The method of claim 1, further comprising sending by the wireless device to an access and mobility management function (AMF), a first non-access stratum (NAS) message requesting establishment of the PDU session, indicating an MA PDU session type.

3. The method of claim 2, wherein the wireless device sends the first NAS message via the first access.

4. The method of claim 2, wherein the second NAS message further comprises a timer value indicating a period associated with the MA PDU session type.

5. The method of claim 4, further comprising starting by the wireless device, a timer with the timer value.

6. The method of claim 5, further comprising not sending by the wireless, a third NAS message requesting the MA PDU session type for the PDU session, while the timer is running.

7. The method of claim 1, wherein the wireless device is registered via a first access and is not registered via a second access.

8. A wireless device comprising one or more processors and memory storing instructions that, when executed by the one or more processors, cause the wireless device to:
receive a second non-access stratum (NAS) messages indicating:
an establishment of a protocol data unit (PDU) session; and
a rejection of a multi-access (MA)-PDU session type for the PDU session.

9. The wireless device of claim 8, wherein the instructions further cause the wireless device to send, to an access and mobility management function (AMF), a first non-access stratum (NAS) message requesting establishment of the PDU session, indicating an MA PDU session type.

10. The wireless device of claim 9, wherein the wireless device sends the first NAS message via the first access.

11. The wireless device of claim 9, wherein the second NAS message further comprises a timer value indicating a period associated with the MA PDU session type.

12. The wireless device of claim 11, wherein the instructions further cause the wireless device to start a timer with the timer value.

13. The wireless device of claim 11, wherein the instructions further cause the wireless device to not send a third NAS message requesting the MA PDU session type for the PDU session while the timer is running.

14. The wireless device of claim 9, wherein the wireless device is registered via a first access and is not registered via a second access.

15. A non-transitory computer-readable medium comprising instructions that, when executed by one or more processors of a wireless device, cause the wireless device to:
receive a second non-access stratum (NAS) messages indicating:
an establishment of a protocol data unit (PDU) session; and
a rejection of a multi-access (MA)-PDU session type for the PDU session.

16. The non-transitory computer-readable medium of claim 15, wherein the instructions further cause the wireless device to send, to an access and mobility management function (AMF), a first non-access stratum (NAS) message requesting establishment of the PDU session, indicating an MA PDU session type.

17. The non-transitory computer-readable medium of claim 16, wherein the wireless device sends the first NAS message via the first access.

18. The non-transitory computer-readable medium of claim 16, wherein the second NAS message further comprises a timer value indicating a period associated with the MA PDU session type.

19. The non-transitory computer-readable medium of claim 15, wherein the instructions further cause the wireless device to start a timer with the timer value.

20. The non-transitory computer-readable medium of claim 15, wherein the instructions further cause the wireless device to not send a third NAS message requesting the MA PDU session type for the PDU session while the timer is running.
